(19) United States
(12) Patent Application Publication
(10) Pub. No.: US 2022/0263086 A1
(43) Pub. Date: Aug. 18, 2022

(54) METHODS AND COMPOSITIONS FOR HIGH-ENERGY BATTERY CATHODES

(71) Applicant: Virginia Tech Intellectual Properties, Inc., Blacksburg, VA (US)

(72) Inventors: Feng LIN, Christianburg, VA (US); Linqin MA, Blacksburg, VA (US); James D, STEINER, Blacksburg, VA (US)

(21) Appl. No.: 17/623,578

(22) PCT Filed: Jun. 28, 2020
(86) PCT No.: PCT/US2020/040035

§ 371 Date: Dec. 28, 2021

Related U.S. Application Data
(60) Provisional application No. 62/868,567, filed on Jun. 28, 2019.
(60) Provisional application No. 62/870,414, filed on Jul. 3, 2019.

(51) Int. Cl. H01M 4/525; H01M 10/0525; H01M 4/04; H01M 4/587; H01M 4/62; H01M 10/44

(52) U.S. Cl. CPC H01M 4/525; H01M 10/0525; H01M 4/0404; H01M 2004/021; H01M 4/625; H01M 4/623; H01M 10/446; H01M 4/587

(57) ABSTRACT

In one aspect, the disclosure relates to electrochemically active materials for use in constructing cathodes in lithium ion batteries. This abstract is intended as a scanning tool for purposes of searching in the particular art and is not intended to be limiting of the present disclosure. In accordance with the purpose(s) of the present disclosure, as embodied and broadly described herein, the disclosure, in one aspect, relates to electrochemically active materials for use as cathodes in lithium-ion batteries, methods of introducing dopants into the electrochemically active materials, and electrochemical cells and batteries comprising the same. Cathodes made using the electrochemically active materials disclosed herein exhibit smoother voltage profiles as well as enhanced specific energy, cycle life, rate capability, self-discharge resistance, and thermal stability compared to conventional cathodes.

### CROSS-REFERENCE TO RELATED APPLICATIONS

This application claims priority to, and the benefit of, U.S. provisional application entitled “METHODS AND COMPOSITIONS FOR HIGH-ENERGY BATTERY CATHODES” having Ser. No. 62/868,567, filed Jun. 28, 2019 and, U.S. provisional application entitled “METHODS AND COMPOSITIONS FOR HIGH-ENERGY BATTERY CATHODES” having Ser. No. 62/870,414, filed Jul. 3, 2019, the contents of both of which are incorporated by reference in their entirety.

### STATEMENT REGARDING FEDERALLY SPONSORED RESEARCH

This invention was made with government support under Grant No. DE-EE0008444 awarded by the US Department of Energy. The government has certain rights in the invention.

### BACKGROUND

The lithium-ion battery market is large and growing, with new opportunities especially emerging in vehicular applications. Improving energy density has been a focus of research in lithium ion batteries; this can be achieved by elevating the cell operating voltage. However, most cathode materials and electrolytic solutions undergo severe interfacial reactions at high voltages.

These interfacial reactions can completely transform the electrochemical interface of cathode particles through surface reconstruction and metal migration, leading to notable capacity fading and impedance buildup. Ni-rich layered oxides (LiNiₓMn_{y}Co_{1-x-y}O₂, NMC) represent a frontier in lithium battery research because of their high energy density and potentially low cost. However, the inferior surface and bulk structural stability have become major roadblocks with respect to the practical implementation of Ni-rich layered oxides (x>0.75). The bulk structural instability involves multiple phase transformations, especially the H2→H3 transformation that results in a large charge-discharge hysteresis at high voltages. The surface structural instability is associated with the strong orbital hybridization (covalency) between transition metal (TM) 3d orbitals and oxygen (O) 2p orbitals. A high degree of lithium deintercalation increases the TM3d-O2p hybridization and disrupts the integrity of the layered structure, leading to surface phase transformations. Surface phase transformations usually lead to the release of surface lattice oxygen that participates in electrolyte oxidation at high voltages. Therefore, limiting oxygen activation has been a long-sought goal for improving the cycle life and energy density of Ni-rich layered oxide cathodes.

Surface coating and bulk elemental substitution are among the most popular methods to improve the structural stability at the surface and in the bulk material, respectively. Technical hurdles include achieving atomically thin and conformal coating layers on primary particles and obtaining controlled distribution of substituting elements in primary particles. Atomic layer deposition (ALD) has been shown to be effective in creating conformal coating layers on NMC secondary particles. However, the large-scale manufacturability of the ALD technique remains a major concern for batteries, despite intensive efforts to commercialize the technique. Substituting elements usually have limited solubility in the NMC lattice. Upon thermal annealing, the oversaturated substituting elements can potentially segregate to the particle surface and form a conformal coating layer. Hypothetically, such a thermodynamically driven process can lead to an optimal substitution concentration in the bulk material with a conformal coating layer on the surface. Ultimately, this strategy is expected to simultaneously stabilize the surface and bulk structures of NMC particles. Mechanistically, some longstanding questions remain regarding the exact role of elemental substitution in stabilizing local chemical environments as well as the dynamic evolution of substituting elements upon electrochemical cycling.

LiNiO₂ (LNO) lithium ion batteries, which are isostructural to commercial LiCoO₂ in lithium ion batteries, has recently attracted renewed research attention in the quest for extremely low-cobalt or completely cobalt-free layered cathodes in order to reduce the reliance on high-cost and toxic cobalt. Owing to the low Ni³⁺/Ni⁴⁺ redox potential, LiNiO₂ can achieve over 200 mAh/g capacity with a low upper voltage at 4.3 V compared to Li⁺/Li. In practice, the available capacity largely varies due to the unfavorable Li off-stoichiometry, i.e., Li/Ni cation mixing to form (LiₓNi₁₋ₓ)₃ₐ(Li_{1-y}Ni_{y})_{3b}(O₂)_{6c}. Upon charging, LiNiO₂ experiences undesired H1→M→H2→H3 phase transformations, where H and M represent hexagonal and monoclinic phases, respectively. A 7% volume contraction during the H2→H3 transformation at 4.15 V versus Li⁺/Li triggers severe stress in battery particles, resulting in crack formation and potentially oxygen release. Furthermore, the highly oxidized Ni cations in charged particles are thermodynamically unstable, particularly when in contact with organic electrolyte. The Ni⁴⁺ is readily reduced to a lower oxidation state accompanying the electrolyte decomposition and gas release. These challenges, associated with the unstable bulk and surface chemistry, have hindered the implementation of LiNiO₂ in practical particles over the past few decades. The solid solutions of LiNiO₂, LiCoO₂, and LiMnO₂, i.e., LiNiₓMn_{y}Co_{1-x-y}O₂ (NMC) have been regarded as an effective strategy to improve structural and thermal stability in lithium ion batteries. Indeed, NMC materials have become the pivotal enabler for electric vehicles and consumer electronics. Even though LiNi_{0.8}Mn_{0.1}Co_{0.1}O₂ is on the verge of reaching initial market penetration, commercial Li ion batteries based on layered oxide cathodes fail to eliminate cobalt, a high-cost, toxic, and geographically unevenly distributed element. Moreover, cobalt mining practices in the Democratic Republic of the Congo have been criticized for human rights violations. Therefore, focus has returned to low-cobalt, high-nickel layered oxides as well as completely cobalt-free layered oxides. Furthermore, LiNiO₂ batteries avoid issues related to manganese dissolution from NMC cathodes, thus overcoming a primary cause of capacity fading.

Several strategies exist to address LiNiO₂ challenges, including, but not limited to, surface coating, bulk doping, and core-shell hierarchical structures. Among these, bulk doping with Al³⁺, Ti⁴⁺, or Mg²⁺ is the most commonly used and effective method. These dopants not only break the Li/vacancy ordering, thus improving electrochemical stability, but also increase the thermal stability of LiNiO₂ cathodes. However, a common phenomenon is that the dopants improve cycle life at the cost of reversible capacity. Mg, sitting at a Li⁺ site, acts as a structural pillar, and Ti, sitting at a Ni³⁺ site, destabilizes the Li⁺ vacancy ordering. To date, homogeneous distribution of dopants in battery particles have been assumed, and research efforts have focused no single dopants wherein the doping mechanism is unknown or little evidence exists to support hypotheses regarding the doping mechanism. Further, when introducing more than one dopant, it is unclear how dopants may redistribute inside battery particles during materials synthesis. Hence, there is a large tuning space to optimize the distribution of dual dopants while simultaneously improving the bulk and surface chemistry of LiNiO₂-based cathodes.

Despite advances in elemental substitution in NMC particles, there is still a scarcity of NMC particle formulations with surface and bulk structural stability due to oxygen activation at high voltages. Furthermore, advances in bulk doping of cobalt-free LiNiO₂-based particles, including advances that have led to improved life cycle, have led to losses in reversible capacity (self-discharge). These and other needs are satisfied by the present disclosure.

### SUMMARY

In accordance with the purpose(s) of the present disclosure, as embodied and broadly described herein, the disclosure, describes electrochemically active materials for use as cathodes in lithium-ion batteries, methods of introducing dopants into the electrochemically active materials, and electrochemical cells and batteries comprising the same. Cathodes made using the electrochemically active materials disclosed herein exhibit smoother voltage profiles as well as enhanced specific energy, cycle life, rate capability, self-discharge resistance, and thermal stability compared to conventional cathodes.

In various aspects, a cathode is provided having an electrochemically active material with a crystalline structure characterized by the formula LiMO₂, wherein M represents a metal ion and wherein the electrochemically active material comprises at least one dopant. In some aspects, M is NiₓMn_{y}Co_{1-x-y} and wherein x>0. In some aspects, M is NiₓMn_{y} where x+y is about 1. In some aspects, the electrochemically active material is substantially free of Co.

Suitable dopants can include Al, Na, Mg, Ti, Zr, Si, Nb, Ca, Sr, Ba, Zn, V, Fe, Cr, Cu, Nd, La, Mn, Co, Ga, Sb, Ce, Mo, Tc, Ru, Rh, Ag, Cd, Ge or a combination thereof. In some aspects, the at least one dopant is Mn, Mg, Ti, and combinations thereof.

In some aspects, the battery is a cobalt-free battery and the electrochemically active material comprises LiNiO₂. In some aspects, the electrochemically active material contains a nickel-manganese-cobalt. In some aspects, the electrochemically active material is NiₓMn_{y}Co_{1-x-y} where 0.3≤x≤0.8, 0.1≤y 0.4, and 0.1≤1-x-y≤0.4.

Processes for preparing the cathodes are provided, including preparing a slurry containing a solvent, the electrochemically active material, a conductive additive, and a binder; casting the slurry on a substrate; and drying the slurry to form the cathode.

In various aspects, electrochemical cells are provided containing the cathode, an anode, and an electrolyte wherein the cathode comprises a cathode material described herein.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1C shows characterization of pristine NMC811-Ti materials. FIG. 1A STEM image of the pristine NMC811-Ti particle, where the dashed line separates the surface reconstruction layer from the bulk layered structure. FIG. 1B The area of the particle that was analyzed by the EELS scanning. FIG. 1C EELS spectra of the transition metal L-edges and the oxygen K-edge, with the TM3d-O2p hybridization labeled. Ti was enriched at the top surface. The vertical dashed lines indicate the shift of the edge energy showing that transition metals at the surface are reduced compared to those in the bulk. In FIG. 1C, the EELS spectra probed deeper from the bottom to the top, as indicated by the arrow in FIG. 1B.

FIGS. 2A-2E show electrochemical performance of cells containing pristine NMC811 and NMC811-Ti materials. FIG. 2A Charge-discharge profiles of NMC811-Ti. FIG. 2B Charge-discharge profiles of NMC811. FIG. 2C Specific discharge capacity as a function of cycle number. The Ti⁴⁺ substitution increased the capacity retention from 69% to 80% over 300 cycles, and from 58% to 70% over 500 cycles. FIG. 2D Middle voltage (the voltage at 50% discharge capacity) as a function of cycle number. FIG. 2E Specific discharge energy as a function of cycle number. The cells were all cycled at 1C between 2.5-4.5 V vs. Li⁺/Li for 500 cycles.

FIGS. 3A-3B shows stability of the Ti⁴⁺ chemical environment in NMC811-Ti materials. FIG. 3A Ti L-edge soft XAS spectra as a function of the state of charge, where the arrow indicates the broadening of the L₃-e_{g} peak. FIG. 3B STEM-EDS mapping of the NMC811-Ti material after 300 cycles at 1C between 2.5-4.5 V versus Li⁺/Li.

FIGS. 4A-4B shows stability of the surface chemistry of NMC811 and NMC811-Ti materials as quantified by soft XAS in total electron yield (TEY) mode. FIG. 4A The integrated area for the TM3d-O2p hybridization as a function of the state of charge for two cycles. FIG. 4B The Ni L_{3-high}/Ni L_{3-low} ratio as a function of the state of charge for two cycles. The cells were cycled at C/10 between 2.5-4.6 V versus Li⁺/Li. The “C” and “DC” represent “charged” and “discharged”, respectively.

FIG. 5 shows synchrotron powder XRD patterns of LNO and Mg/Ti-LNO materials (λ=0.976 Å).

FIGS. 6A-6H shows characterization of pristine Mg/Ti-LNO material. FIG. 6A Ni/Ti L-edge and O K-edge soft XAS spectra, the * represents carbonate species; FIG. 6B neutron diffraction and Rietveld refinement; FIGS. 6C-6D STEM images of the primary particle; FIG. 6E EELS spectra scanning pathway from the surface to subsurface with the increment of 0.8 nm; FIG. 6F Ti L-edge EELS spectra recorded with the scanning pathway (from bottom purple to top dark red spectra); FIG. 6G normalized peak area of Ti L-edge EELS as the function of scanning depth; FIG. 6H STEM-EDS mapping of the Ni, Mg, and Ti in the composition scale (left) and (middle and right) concentration scale on the selected particle.

FIG. 7 shows SEM images of LNO and Mg/Ti-LNO materials.

FIGS. 8A-8F shows electrochemical performance of half cells containing a Mg/Ti-LNO cathode at 22° C. within 2.5-4.4 V. FIG. 8A the voltage profiles of the LNO and Mg/Ti-LNO at C/10 (20 mA/g), the insert shows the discharge capacity as a function of cycle number; FIG. 8B the voltage profiles in the first 50 cycles at C/10; FIG. 8C the dQ/dV curves derived from the voltage profiles at C/10; FIG. 8D discharge voltage profiles at the symmetrical constant currents of C/10, C/5, C/2, 1C and 2C; FIG. 8E long-term cycling performance FIG. 8F specific energy retention at different C-rates.

FIG. 9 shows second cycle GITT curves of cells containing LNO and Mg/Ti-LNO cathodes operated at C/20, charged for 1 hour, and rested for 10 hours.

FIG. 10 shows charged/discharge profiles of a cell containing an LNO cathode in the initial 50 cycles at C/10 (20 mA/g) within 2.5-4.4 V at 22° C.

FIG. 11 shows dQ/dV curves derived from a cell containing an LNO cathode in the initial 50 cycles at C/10 (20 mA/g) within 2.5-4.4 V at 22° C.

FIGS. 12A-12B shows cyclic voltammetry (CV) curves of cells containing LNO (FIG. 12A) and Mg/Ti-LNO (FIG. 12B) of the initial 5 CV cycles at a scan rate of 0.1 mV/s. The arrow in FIG. 12A indicates the degradation of the oxidation and reduction process which are related to the phase transformation from H2→H3. However, almost no change was observed in FIG. 12B in the same region (4.0-4.5 V), indicating good structure reversibility.

FIG. 13 shows rate capability of a cell containing an LNO cathode; discharge voltage profiles at the symmetrical currents of C/10, C/5, C/2, 1C, and 2C within 2.5-4.4 V at 22° C.

FIGS. 14A-14B shows cycling stability of cells containing FIG. 14A LNO and FIG. 14B Mg/Ti-LNO at C/10 within 2.5-4.4 V at 60° C.

FIG. 15 shows charge/discharge profiles of a cell containing a graphite anode at C/10 (300 mA/g) within 0-2.0 V at 22° C.

FIGS. 16A-16B shows electrochemical performance of the full cell containing Mg/Ti-LNO cathode and graphite anode. FIG. 16A shows the charge/discharge profiles of a full cell at C/10 (20 mA/g) in 1.0-4.4 V and hold at 4.4 V for 1 hour and FIG. 16B shows cycling performance of a full cell at C/2 in 1.0-4.4 V and held at 4.4 V for 1 hour. The capacity ratio of the cathode to anode was approximately 1 to 1.2. The mass loading of cathode was 6 mg/cm². The specific capacity and specific energy were calculated based on the cathode mass loading.

FIGS. 17A-17F shows X-ray fluorescence microscopy (with colored lines representing Ni concentration) on the lithium metals countered with FIG. 17A Mg/Ti-LNO and FIG. 17B LNO cathodes operated at C/3 after 50 cycles within 2.5-4.4 V at 22° C.; Nyquist plots of the half cells containing the FIG. 17C Mg/Ti-LNO and FIG. 17D LNO cathodes at the fresh state, 1 cycle, 5 cycles, 10 cycles, 20 cycles, and 50 cycles at the discharged states. FIG. 17E voltage evolutions of the two cells charged to 4.4 V and rested for 14 hours; FIG. 17F differential scanning calorimetry (DSC) analysis of the two wet cathodes (with electrolyte) at 4.4 V charged state with the scan rate of 10°/min.

FIG. 18 shows a histogram of the Ni concentration on the lithium anode facing the cathode side, collected by XFM. The lithium anodes were collected from cells containing LNO and Mg/Ti-LNO cathodes cycled at C/3 for 50 times. The Ni concentration was in the range of 0-25 nmol/cm² and 0-5 nmol/cm² of the lithium anodes facing the Mg/Ti—LiNiO₂ and LiNiO₂ cathodes, respectively. The average Ni deposition concentration of the lithium anodes in the cells containing the Mg/Ti—LiNiO₂ and LiNiO₂ cathode was 1.37 nmol/cm² and 10.45 nmol/cm², respectively.

FIGS. 19A-19F shows charge compensation mechanism and Ni local environment evolution. Ex-situ Ni K-edge XANES of the Mg/Ti-LNO cathode upon FIG. 19A charging and FIG. 19B discharging and after long cycling; FIG. 19C ex-situ Ni K-edge EXAFS of the Mg/Ti-LNO cathode at various states; Wavelet transforms for the K3-weighted Ni K-edge EXAFS of the Mg/Ti-LNO cathode at the FIG. 19D pristine state, FIG. 19E charged to 4.4 V, and FIG. 19F discharged to 2.5 V after 100 cycles.

FIG. 20 shows XRD patterns of Mg/Ti-LNO cathodes at the pristine state, charge to 3.9 V, charge to 4.4 V, discharge to 2.4 V (after 1 cycle), and discharge to 2.5 V after 100 cycles. Peaks labeled by asterisks are associated with the Al current collector. The bottom panel is an expanded view of a portion of the top panel.

FIG. 21 shows Ni L-edge XAS in the TEY mode of the Mg/Ti-LNO cathode in the pristine state and the discharged state after 50 cycles.

FIGS. 22A-22D shows kinetics performance of half cells containing Mg/Ti-LNO cathodes. FIG. 22A cyclic voltammogram at the continuously increasing scan rates from 0.1 to 1.0 mV/s; FIG. 22B the current intensity of the redox peaks located with 3.5-3.7 V (marked with # in a) as the function of the scan rates, O and R represents the oxidation (delithiation) and reduction (lithiation) process, respectively; FIG. 22C GITT curves of the second cycle and its derived OCV curve of the cell at C/20 charged for 1 hour and following with 10 hours rest; FIG. 22D the apparent chemical diffusion coefficient as the function of voltage derived from the GITT curves.

FIGS. 23A-23B shows kinetics performance of half cells containing an LNO cathode. FIG. 23A cyclic voltammogram at the continuously increasing scan rates from 0.1 to 1.0 mV/s; FIG. 23B the current intensity of the redox peaks located with 3.5-3.7 V as the function of the scan rates, O and R represents the oxidation (delithiation) and reduction (lithiation) process, respectively.

FIG. 24A shows XRD patterns of NMC811 and NMC811-Ti. FIG. 24B shows a Ti L-edge soft XAS spectrum for pristine NMC811-Ti.

FIG. 25 shows a comparison of the rate capability performance between NMC811 and NMC811-Ti. Cells were cycled between 2.5 and 4.5 V versus Li⁺/Li.

FIG. 26 shows cycling performance of NMC811 and NMC811-Ti with different Ti concentrations and/or synthesized by different methods.

FIG. 27A shows an example of XAS peak fitting for Ti L-edge. FIG. 27B shows full width at half maximum (FWHM) of different peaks as functions of delithiation. FIG. 27C shows peak area of different peaks as functions of delithiation. The P1, P2, P3, and P4 represent L₃-t_{2g}, L₃-e_{g}, L₂-t_{2g}, and L₂-e_{g} peaks, respectively.

FIGS. 28A-28D shows theoretical modeling X-ray absorption near edge structure (XANES) and comparison with experiments for Ti-substituted Li₁₋ₓTMO₂. FIG. 28A The full width at half maxima (FWHM) and FIG. 28B peak area of L₃-e_{g} peak as functions Ti—O bond length for two typical lithium concentrations, obtained from the time-dependent density functional theory (TDDFT) based (XANES) calculation. The fitting results of FIG. 28C FWHM and FIG. 28D peak area as a function of lithium concentrations x utilizing the trend of XANES vs bond length (namely, FIGS. 28A-28B) and the Vegard's law for lattice changed with lithium concentrations x.

FIG. 29 shows Ti L-edge soft XAS spectra as a function of the state of charge, where the arrow indicates the broadening of the L₃-e_{g} peak. The data presented here were from the second cycle.

FIGS. 30A-30D shows soft XAS TEY of FIG. 30A the first cycle Co L-edge, FIG. 30B the second cycle Co L-edge, FIG. 30C the first cycle Mn L-edge, and FIG. 30D) the second cycle Mn L-edge. Mn was slightly reduced in the fully discharged state (the topmost spectra in FIG. 30C-30D), which is expected for NMC undergoing high-voltage charging.

FIG. 31A shows an example of O K-edge soft XAS, where the TM3d-O2p hybridization peak is labeled and quantified using the area. FIG. 31B shows an example of Ni L-edge soft XAS, where the L_{3-high}/L_{3-low} ratio is used to understand the Ni oxidation state.

FIG. 32 shows the integrated area for the TM3d-O2p hybridization (probed by the FY mode) as a function of the states of charge for two cycles.

FIG. 33 shows the L_{3-high}/L_{3-low} ratio as a function of the state of charge probed by the FY mode. The cells were cycled at C/10 between 2.5-4.6 V vs. Li⁺/Li. The “C” and “DC” represent “charged” and “discharged”, respectively.

FIG. 34A Ni K-edge EXAFS of NMC811 and NMC811-Ti in the pristine state, FIG. 34B Ni K-edge EXAFS of NMC811 and NMC811-Ti after 300 cycles. The first peak represents Ni—O and the second one represents Ni—Ni.

FIG. 35A shows Ni K-edge hard XAS of NMC811 in the pristine state, after 1 cycle, and after 300 cycles. FIG. 35B shows Ni K-edge hard XAS of NMC811-Ti in the pristine state, after 1 cycle, and after 300 cycles.

FIGS. 36A-36B shows a direct comparison of Ni K-edge hard XAS in FIG. 36A the pristine state and FIG. 36B after 30 cycles.

FIGS. 37A-37D shows a direct comparison of Co K-edge hard XAS in FIG. 37A the pristine state and FIG. 37B after 300 cycles and a direct comparison of Mn K-edge hard XAS in FIG. 37C the pristine state and FIG. 37D after 300 cycles.

FIGS. 38A-38E Characterization of the Mg/Mn—LiNiO₂ cathode material. (FIG. 38A) Hard XAS spectra of Ni and Mn K-edge, with reference spectra provided; (FIG. 38B) soft XAS of Ni L₃-edge and O K-edge in the FY (fluorescence yield) and TEY (total electron yield) modes, where * represents the NiO-like species,²⁸ which is caused by the cation mixing; (FIG. 38C) neutron diffraction pattern with the Rietveld refinement; (FIG. 38D) atomic structure of the pristine material, with spheres representing oxygen, nickel and manganese (small amount of lithium), and lithium (small amount of magnesium and nickel), respectively; (FIG. 38E) transmission electron microscopy (TEM) image.

FIGS. 39A-39F Electrochemical performance of the no-cobalt Mg/Mn—LiNiO₂ cathode within 2.5-4.4 V. (FIG. 39A) The second charge/discharge profiles of the two cathodes cycled at C/10; (FIG. 39B) cyclic voltammetry curves at 0.1 mV/s; (FIG. 39C) charge/discharge profiles at C/10 in the first 50 cycles; (FIG. 39D) dQ/dV curves derived from the voltage profiles at C/10; (FIG. 39E) rate capability; (FIG. 39F) long-term cycling performance at C/2 with the formation cycle at C/10; the active mass loading was around 5 mg/cm², 1C equals 200 mA h/g with 1 hour charge or discharge. The cells were all tested at 22° C.

FIGS. 40A-40C Long-term cycling performance of the no-cobalt Mg/Mn—LiNiO₂ cathode at (FIG. 40A) C/3, (FIG. 40B) 1C, and (FIG. 40C) 2C within 2.5-4.4 V, the formation cycle was at C/10 for the first cycle, the active mass loading was ˜9 mg/cm². The cells were all tested at 22° C.

FIG. 41 Self-discharge resistance of the cells containing no-cobalt LiNiO₂ and Mg/Mn—LiNiO₂ cathode. The cells were cycled at C/10 for the first cycle, then, charged to 4.4 V, held at 4.4 V for one hour, and rest for 20 hours. The first-cycle performance is shown in the inset.

FIGS. 42A-42F Cationic charge compensation mechanism and Ni local environment analysis. (FIG. 42A) X-ray absorption near edge structure (XANES) spectra of the nickel element at various states in the first cycle; (FIG. 42B) second derivative of the XANES spectra in (FIG. 42A); (FIG. 42C) extended X-ray absorption fine structure (EXAFS) of the Ni element at various states in the first cycle; (FIG. 42D) XANES of the manganese element at various states in the first cycle; XANES of nickel (FIG. 42E) and manganese (FIG. 42F) element after 100 cycles in the discharged state (2.5 V).

FIGS. 43A-43C Nickel L₃-edge soft XAS in the (FIG. 43A) FY and (FIG. 43B) TEY modes for the Mg/Mn—LiNiO₂ cathodes at the states of pristine, charged to 3.8V, charged to 4.4 V, and discharged to 2.5 V in the first cycle; (FIG. 43C) the L₃-edge has two peaks, and the intensity ratio between the right peak and the left peak is plotted as a function of the charged states, where LiNiO₂ and LiNi_{1/3}Mn_{1/3}Co_{1/3}O₂ (NMC333) are used as the references.

FIGS. 44A-44D X-ray fluorescence microscopy on the lithium metals countered with the Mg/Mn—LiNiO₂ cathode after electrochemical cycling at C/3 within 2.5-4.4 V. (FIG. 44A) Histograms of the Ni concentration (based on the pixel-by-pixel quantification) on the lithium metal anodes after 1, 100, and 200 cycles; (FIG. 44B-FIG. 44D) Ni distribution on the lithium metals after 1, 100, and 200 cycles, where the colors represent Ni concentration (g/cm²).

FIG. 45 Comparison of nickel L-edge soft XAS in the TEY mode for the Mg/Mn—LiNiO2 cathodes at the states of pristine, discharged to 2.5 V in the first cycle, and discharged to 2.5 V after 60 cycles.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a dopant,” “a metal salt or hydrate,” or “an aqueous base,” includes, but is not limited to, combinations of two or more such dopants, metal salts or hydrates, or aqueous bases, and the like.

As used herein, “electrochemical cell” refers to a device that is able to generate electrical energy from chemical reactions or that can use electrical energy to cause chemical reactions. Meanwhile, a “battery” is composed of one or more electrochemical cells that are connected via series and/or parallel connections. In some aspects, when a battery consists of a single electrochemical cell, the terms are used interchangeably.

As used herein, “battery capacity” or “capacity” refers to the amount of energy a battery can hold. Battery capacity can be measured by discharging a battery at a specific current until the “end of discharge voltage” (EODV). The EODV is a specific voltage at which battery discharge is terminated and may vary by battery type, intended operating conditions, and the like. Capacity of a given battery is typically rated at “1C,” which means that a battery that is fully charged should provide current at its full rating (such as, for example, a rating of 1 Ah) for one hour. Meanwhile, “capacity retention” is expressed as a percentage and refers to the amount of battery capacity retained after a given number of cycles (such as, for example, 50 or 100 cycles). Capacity retention may vary based on battery operating temperature and other factors, with actual capacity retention being lower when a battery is operated at a higher temperature. In one aspect, EODV was set at from about 2.0 V to about 2.7 V for the batteries disclosed herein, for testing purposes. In a further aspect, these EODV values are applicable against a reference electrode such as, for example, a graphite or lithium metal anode.

As used herein, a “C-rate” relates to charge and discharge rate of a battery. C-rates are typically represented as multiples or fractions of 1C (the one hour discharge rate). Thus, a C-rate of C/2 (also represented as 0.5C) is a two-hour discharge rate and a C-rate of 2C is a 30-minute discharge rate. An ideal battery with a rating of 1 Ah would deliver 500 mA of current for two hours at a C-rate of C/2 and an ideal battery with a rating of 1 Ah would deliver 2 A of current for 30 minutes at a C-rate of 2C, although in practice, discharging batteries above 1C can cause stress and decreased battery performance and may not work for all batteries. In one aspect, the same C-rates can be used to describe battery charging as well as discharge.

“Mass loading” or “mass load” refers to amount of electrode material per unit surface area of a current collector and is typically expressed in units of mg/cm². A smaller mass loading number (e.g., 5 mg/cm²) is sometimes called a thin electrode, while a higher mass loading number (e.g., 25 mg/cm²) may be referred to as a thick electrode, although these designations can vary somewhat based on density and porosity of the electrode material.

As used herein, “differential capacity” (dQ/dV) refers to capacity going into or out of a cathode (dQ) over a small voltage increment (dV). Differential capacity can be derived by several means including using a dedicated instrument, collecting current and voltage data over time, and the like. Differential capacity measurements can, in some aspects, allow comparisons between different cathodes, batteries, or other devices, and can typically be compared to cyclic voltammetry (CV) data for confirmation.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a dopant refers to an amount that is sufficient to achieve the desired improvement in the property modulated by the formulation component, e.g. achieving the desired level of modulus. The specific level in terms of wt % in a composition required as an effective amount will depend upon a variety of factors including the particular dopant cation or cations, the starting metal salt or hydrate for the dopant cation or cations, method of synthesis of electrochemically active material, and end use of the battery incorporating the cathode made using the electrochemically active material.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Electrochemically Active Material

In one aspect, disclosed herein is an electrochemically active material. In a further aspect, the electrochemically active material has a crystalline structure and is characterized by the formula LiMO₂, wherein M represents one or more metal ions. In a further aspect, M represents nickel (Ni), manganese (Mn), cobalt (Co), or a combination thereof.

In a further aspect, M can be represented by the formula NiₓMn_{y}Co_{1-x-y}. Further in this aspect, x>0. When y=1-x-y=0, x=1 and a battery incorporating the electrochemically active material can be described as a LiNiO₂ battery (LNO). In one aspect, an LNO battery is substantially free of cobalt and can further be described as a cobalt-free battery. When y>0 and 1-x-y>0, a battery incorporating the electrochemically active material can be described as a NMC (nickel-manganese-cobalt) battery.

In one aspect, a battery incorporating the electrochemically active material is an NMC battery and 0.3≤x≤0.8, 0.1≤y 0.4, and 0.1≤1-x-y≤0.4. Example batteries according to this aspect can include x=0.8, y=0.1, and 1-x-y=0.1 (NMC811); x=0.6, y=0.2, and 1-x-y=0.2 (NMC622); x=0.5, y=0.3, and 1-x-y=0.2 (NMC532); and x=0.33, y=0.33, and 1-x-y=0.33 (NMC333). In one aspect, the battery is an NMC811 battery. In another aspect, a battery incorporating the electrochemically active material is an LNO battery.

Dopant Identity and Concentration

In a further aspect, the electrochemically active material includes at least one dopant. In a still further aspect, the at least one dopant is selected from Al, Na, Mg, Ti, Zr, Si, Nb, Ca, Sr, Ba, Zn, V, Fe, Cr, Cu, Nd, La, Mn, Co, Ga, Sb, or a combination thereof. Further in this aspect, the at least one dopant is Mg, Ti, or Mg and Ti. In still another aspect, the at least one dopant occupies M lattice sites in the crystalline structure of the electrochemically active material.

In one aspect, the at least one dopant is present in a concentration of from about 1 mol % to about 6 mol % relative to M lattice sites in the crystalline structure of the electrochemically active material, or is about 1 mol %, 1.5 mol %, 2 mol %, 2.5 mol %, 3 mol %, 3.5 mol %, 4 mol %, 4.5 mol %, 5 mol %, 5.5 mol %, or 6 mol %.

In one aspect, a battery incorporating the electrochemically active material is a NMC811 battery and the dopant is Ti with a concentration of about 3 mol %. In an alternative aspect, a battery incorporating the electrochemically active material is an LNO battery and the dopant is Mg and Ti with a combined concentration of about 4 mol %.

In one aspect, in NMC cathode materials with a single dopant, targeted Ti⁴⁺ substitution in TMO₆ coordination increases TM-O bond length and reduces covalency between transition metal and oxygen in nickel-rich layered oxides. Further in this aspect, the reversibility of the Ti⁴⁺ chemical environment leads to superior oxygen reversibility at the cathode-electrolyte interphase and in bulk particles, resulting in improved capacity, energy, and voltage.

In a further aspect, in LNO cathode materials, the Ti concentration can be enriched at the particle surface and can form ionic bonds with oxygen anions, inhibiting surface oxygen loss. In another aspect, bulk Mg doping in LNO cathode materials may stabilize bulk crystal structure and reduce undesired phase transformations. In some aspects, both of these phenomena occur simultaneously, thus offering both bulk and surface stability, which would in turn lead to favorable electrochemical properties. In one aspect, dual dopants Ti and Mg can, through these and other mechanisms, help minimize Ni dissolution, improve thermal stability, and increase self-discharge resistance of LNO material. In another aspect, dual dopants may reduce volume changes and/or phase transformations during charging and/or discharging, thus reducing stress on batteries constructed from this material as well as reducing oxygen release. In still another aspect, dual dopants may reduce some of the thermodynamic instability related to highly oxidized Ni cations when in contact with organic electrolyte. In any of the above aspects, inclusion of the dopants described herein can lead to a longer battery life with better performance during each charge/discharge cycle. In still another aspect, dual Mg and Ti dopants improve the stability of the cathode-electrolyte interface, which may also contribute to improved cycling performance.

Process for Preparing Electrochemically Active Materials

In another aspect, disclosed herein is a process for preparing electrochemically active materials. In one aspect, the process includes the following steps:
a. admixing solutions of one or more water-soluble M salts or hydrates and one or more water-soluble dopant salts or hydrates with an aqueous base, forming a precipitate;
b. collecting and drying the precipitate;
c. admixing the precipitate with LiOH, LiOH.H₂O, Li₂CO₃, or LiHCO₃ to form a first mixture;
d. calcining the first mixture under air flow at a temperature of from about 650° C. to about 900° C. for a period of from about 2 hours to about 12 hours.

In one aspect, in step (a), the M salt or hydrate is selected from: NiSO₄ (anhydrous), NiSO₄.6H₂O, NiSO₄.7H₂O, NiCl₂ (anhydrous), NiCl₂.6H₂O, Ni(NO₃)₂.6H₂O, MnSO₄.H₂O, MnSO₄.4H₂O, MnCl₂ (anhydrous), MnCl₂.4H₂O, CoCl₂ (anhydrous), CoCl₂.6H₂O, CoSO₄ (anhydrous), CoSO₄.7H₂O, Co(NO₃)₂.6H₂O, or a combination thereof.

In a further aspect, in step (a), the dopant salt or hydrate is selected from: MgCl₂.6H₂O, MgCl₂ (anhydrous), MgSO₄ (anhydrous), MgSO₄.7H₂O, TiOSO₄, TiCl₄ (anhydrous), or a combination thereof.

In a still further aspect, the aqueous base is selected from NaOH, KOH, NH₃.H₂O, or a combination thereof. Further in this aspect, the aqueous base can be aqueous NaOH/NH₃ with a molar ratio of from about 0.5 to about 2, or with a ratio of about 0.5, about 0.75, about 1, about 1.2, about 1.25, about 1.5, about 1.75, or about 2. In one aspect, the aqueous base has a NaOH/NH₃ molar ratio of 1.2. In an alternative aspect, the aqueous base can be aqueous NaOH with no NH₃ present, or can be NH₃ with no NaOH present.

In one aspect, for LNO batteries, the M salt is NiSO₄.6H₂O. In an alternative aspect, for NMC batteries, the M salt is a combination of NiSO₄.6H₂O, MnSO₄.4H₂O, and CoSO₄.7H₂O with the appropriate stoichiometries for the NMC battery type desired (e.g., NMC811, NMC333, etc.).

In another aspect, in step (b), the precipitate is collected by any method known in the art including decantation, filtration, or the like. Further in this aspect, the precipitate is washed with deionized water and dried. Drying can be conducted by any method known in the art including, but not limited to, lyophilization, rotary evaporation, or drying in a vacuum oven. In one aspect, the precipitate is dried in a vacuum oven at a temperature of from about 95° C. to about 115° C., or at temperature of about 95° C., 100° C., 105° C., 110° C., or 115° C. In one aspect, the precipitate can be dried in a vacuum oven overnight at 105° C.

In still another aspect, the precipitate is admixed with LiOH, LiOH.H₂O, Li₂CO₃, or LiHCO₃ by any method known in the art such that the precipitate and LiOH, LiOH.H₂O, Li₂CO₃, or LiHCO₃ are thoroughly mixed.

In one aspect, the calcining of the first mixture under air flow is at a temperature of from about 650° C. to about 900° C. for a period of about 2.0 hours, about 2.1 hours, about 2.2 hours, about 2.3 hours, about 2.4 hours, about 2.5 hours, about 2.6 hours, about 2.7 hours, about 2.8 hours, about 2.9 hours, about 3.0 hours, about 3.1 hours, about 3.2 hours, about 3.3 hours, about 3.4 hours, about 3.5 hours, about 3.6 hours, about 3.7 hours, about 3.8 hours, about 3.9 hours, about 4.0 hours, about 4.1 hours, about 4.2 hours, about 4.3 hours, about 4.4 hours, about 4.5 hours, about 4.6 hours, about 4.7 hours, about 4.8 hours, about 4.9 hours, about 5.0 hours, about 5.1 hours, about 5.2 hours, about 5.3 hours, about 5.4 hours, about 5.5 hours, about 5.6 hours, about 5.7 hours, about 5.8 hours, about 5.9 hours, about 6.0 hours, about 6.1 hours, about 6.2 hours, about 6.3 hours, about 6.4 hours, about 6.5 hours, about 6.6 hours, about 6.7 hours, about 6.8 hours, about 6.9 hours, about 7.0 hours, about 7.1 hours, about 7.2 hours, about 7.3 hours, about 7.4 hours, about 7.5 hours, about 7.6 hours, about 7.7 hours, about 7.8 hours, about 7.9 hours, about 8.0 hours, about 8.1 hours, about 8.2 hours, about 8.3 hours, about 8.4 hours, about 8.5 hours, about 8.6 hours, about 8.7 hours, about 8.8 hours, about 8.9 hours, about 9.0 hours, about 9.1 hours, about 9.2 hours, about 9.3 hours, about 9.4 hours, about 9.5 hours, about 9.6 hours, about 9.7 hours, about 9.8 hours, about 9.9 hours, about 10.0 hours, about 10.1 hours, about 10.2 hours, about 10.3 hours, about 10.4 hours, about 10.5 hours, about 10.6 hours, about 10.7 hours, about 10.8 hours, about 10.9 hours, about 11.0 hours, about 11.1 hours, about 11.2 hours, about 11.3 hours, about 11.4 hours, about 11.5 hours, about 11.6 hours, about 11.7 hours, about 11.8 hours, about 11.9 hours, about 12 hours, or a combination of any of the foregoing values, or a range encompassing any of the foregoing values.

In one aspect, the calcining of the first mixture under air flow is for a period of from about 2 hours to about 12 hours at a temperature of about 650° C., about 660° C., about 670° C., about 680° C., about 690° C., about 700° C., about 710° C., about 720° C., about 730° C., about 740° C., about 750° C., about 760° C., about 770° C., about 780° C., about 790° C., about 800° C., about 810° C., about 820° C., about 830° C., about 840° C., about 850° C., about 860° C., about 870° C., about 880° C., about 890° C., about 900° C., or a combination of any of the foregoing values, or a range encompassing any of the foregoing values.

In yet another aspect, the first mixture is calcined under air flow at a temperature of from about 650° C. to about 750° C., or at about 650° C., about 660° C., about 670° C., about 675° C., about 680° C., about 690° C., about 700° C., about 710° C., about 720° C., about 730° C., about 740° C., about 750° C., about 800° C., about 850° C., or about 900° C. Further in this aspect, the first mixture is calcined for a period of from about 2 to about 12 hours, or for about 2 hours, about 3 hours, about 4 hours, about 5 hours, about 6 hours, about 7 hours, about 8 hours, about 9 hours, about 10 hours, about 11 hours, or about 12 hours. Still further in this aspect, the rate of air flow is from about 1.5 L/min to about 2.5 L/min, or is about 1.5 L/min, about 1.6 L/min, about 1.7 L/min, about 1.8 L/min, about 1.9 L/min, about 2.0 L/min, about 2.1 L/min, about 2.2 L/min, about 2.3 L/min, about 2.4 L/min, or about 2.5 L/min. In one aspect, the first mixture is calcined under air flow with a speed of about 2.0 L/min at a temperature of about 675° C. for about 6 hours.

In one aspect, the structure and properties of the electrochemically active material can be investigated by any technique known in the art for studying crystal structure, surface structure, or the like. In one aspect, scanning electron microscopy (SEM) can be used to study surface topography and/or composition of the electrochemically active material. In another aspect, scanning transmission electron microscopy (STEM) can be used in conjunction with electron energy loss spectroscopy (EELS) to chemically and/or elementally map a sample at atomic resolution. In some aspects, EELS can also be used to measure local thickness and electronic structure of a sample. X-ray absorption spectroscopy (XAS) can be used to determine local geometric and electronic structure of a sample. In some aspects, soft XAS methods, including total electron yield (TEY) and fluorescence yield (FY), make use of X-rays having somewhat lower energies and longer wavelengths, can yield more information on the surfaces of particles as well as oxidation states of atoms in a crystal lattice, while hard XAS methods can be subsurface sensitive and/or bulk sensitive and make use of X-rays with high photon energies (5-10 keV). In one aspect, extended X-ray absorption fine structure (EXAFS) can help determine the chemical state of species that occur in low abundance. In some aspects, X-ray diffraction (XRD) can be used alone or in conjunction with STEM to verify a pure layered phase and/or space group. Neutron diffraction (ND) can be used to determine atomic structure of a material but provides different information from XRD and is thus a complementary technique; in some aspects, ND is particularly suitable for bulk analysis of samples as neutrons have high penetration depth. Rietveld refinement can be used on ND and/or XRD data to gain further structural information. In some aspects, energy dispersive X-ray spectroscopy (EDS) can be further used to determine chemical composition of a sample as well as the relative abundance of component elements. In some aspects, any or all of these techniques can be used in combination to gain critical information about the structure of the electrochemically active material disclosed herein. Representative procedures and instrument settings for these and other procedures for characterizing structure are provided in the Examples.

Without wishing to be bound by theory, different dopants in the M lattice site will have different stabilization energies. In one aspect, it is believed that Mg ions are more stable in the lattice than Ti ions. Further in this aspect, during the high temperature calcination with air flow, different dopants will have different affinities with the O₂ in the air, and the dopant with a stronger affinity for oxygen would migrate towards the surface of the particle as it interacts with the O₂.

In another aspect, electrochemical properties of the electrochemically active material can be investigated by any technique known in the art. In one aspect, cyclic voltammetry (CV) can be used to estimate the Li⁺ diffusion coefficient for the electrochemically active material disclosed herein. Exemplary procedures for calculating the diffusion coefficient are provided in the Examples. In another aspect, the galvanostatic intermittent titration technique (GITT) can provide further information on Li⁺ diffusion coefficient. Exemplary procedures for performing galvanostatic intermittent titrations are provided in the Examples. In some aspects, CV and GITT can be used to investigate kinetic performance of cathode materials as well.

In still another aspect, thermal stability of a cathode material in the charged state can be analyzed using differential scanning calorimetry (DSC) analysis. In one aspect, a dual-doped Mg/Ti-LNO cathode has an exothermic peak in a typical DSC thermogram of about 10° C. higher than an undoped LNO cathode (219.9° C. versus 210° C., respectively in one aspect).

Batteries Incorporating the Electrochemically Active Material

In one aspect, disclosed herein are batteries incorporating the electrochemically active material. In another aspect, the batteries disclosed herein can have larger capacities, longer cycle times, and better ability to retain energy density over multiple charge cycles than batteries currently on the market.

In a further aspect, the batteries include a cathode as disclosed herein, an anode, and an electrolyte.

In another aspect, disclosed herein is a process for preparing a cathode from the electrochemically active material. The process includes at least the following steps:
a. preparing a slurry containing a solvent, the electrochemically active material, a conductive additive, and a binder;
b. casting the slurry on a substrate; and
c. drying the cathode.

In one aspect, the solvent can be N-methyl-2-pyrrolidone (NMP). In another aspect, the solvent can be water. In another aspect, the conductive additive can be acetylene carbon or another form of carbon black, graphite, graphene, or another conductive carbon. In one aspect, as long as the conductive additive provides electrical conductivity, it can be of any grade or particle size.

In one aspect, the binder can be a thermoplastic polymer particle with an average particle size of 1 μm or less. In another aspect, the polymer can be a fluoropolymer, a styrene-butadiene rubber, ethylene vinyl acetate, an acrylic polymer or copolymer, a polyurethane, a styrenic polymer, a polyamide, a polyester, a polyvinyl chloride, a polycarbonate, a polyolefin, polyvinylpyrrolidone, polymethylmethacrylate, polyacrylic acid, polyacrylonitrile, polypyrrole, styrene-acrylonitrile, polyacrylamide, polyvinyldichloride, and combinations thereof. In some aspects, useful binders include polymers based on acrylic acid, vinyl acetic acid, 2-methyacrylic acid, 2-pentenoic acid, 2,3-dimethyl acrylic acid, 3,3-dimethyl acrylic acid, fumaric acid, maleic acid, itaconic acid, or combinations thereof. In one aspect the binder is non-crystalline or has low crystallinity. In another aspect, the average molecular weight of the binder can be from about 50,000 Da to about 1,250,000 Da. In one aspect, the binder is a fluoropolymer such as, for example, a polymer derived from one or more of the following monomers: vinylidene fluoride, tetrafluoroethylene, trifluoroethylene, chlorotrifluoroethylene, hexafluoropropene, vinyl fluoride, hexafluoroisobutylene, perfluorobutylethylene, pentafluoropropene, a fluorinated vinyl ether, a fluorinated dioxole, or a partially- or per-fluorinated cyclic alkene. In still another aspect, the binder can be polytetrafluoroethylene, polyvinylidene fluoride (PVDF), polyvinylidene fluoride-co-hexafluoropropylene (PVDF-HFP) binder, or another PVDF derivative. In another aspect, the binder can be a water-soluble binder such as, for example, carboxymethyl cellulose, alginate, or another water-soluble binder.

In another aspect, the slurry containing the cathode material is dried by heating to a temperature of from about 100° C. to about 140° C. in a vacuum oven. Further in this aspect, the cathode is dried by heating to about 100° C., about 101° C., about 102° C., about 103° C., about 104° C., about 105° C., about 106° C., about 107° C., about 108° C., about 109° C., about 110° C., about 111° C., about 112° C., about 113° C., about 114° C., about 115° C., about 116° C., about 117° C., about 118° C., about 119° C., about 120° C., about 121° C., about 122° C., about 123° C., about 124° C., about 125° C., about 126° C., about 127° C., about 128° C., about 129° C., about 130° C., about 131° C., about 132° C., about 133° C., about 134° C., about 135° C., about 136° C., about 137° C., about 138° C., about 139° C., about 140° C., or a combination of any of the foregoing values, or a range encompassing any of the foregoing values.

In one aspect, mass loading of the cathode is from about 3 to about 75 mg/cm², or is about 5 to 60 mg/cm², or is about 30 to 60 mg/cm², or is about 5 to about 7 mg/cm², or is about 3, 5, 6, 7, 10, 15, 20, 25, 30, 35, 40, 45, 50, 55, 60, 65, 70, or 75 mg/cm², or a combination of any of the foregoing values, or a range encompassing any of the foregoing values.

In still another aspect, the slurry containing the cathode material has a dry weight that is composed of approximately 70 to 90 wt % electrochemically active material as described above, approximately 5 to 20 wt % conductive additive, and approximately 4.5 to 10 wt % binder. Further in this aspect, the dry weight of the slurry can be about 70, about 75, about 80, about 85, or about 90 wt % electrochemically active material. Still further in this aspect, the dry weight of the slurry can be about 5, about 7.5, about 10, about 12.5, about 15, about 17.5, or about 20 wt % conductive additive. Still further in this aspect, the dry weight of the slurry can be about 4.5, about 5, about 6, about 7, about 8, about 9, or about 10 wt % binder. In one aspect, the dry weight of the slurry is 90 wt % electrochemically active material, 5 wt % conductive additive, and 5 wt % binder.

In one aspect, as described above, the slurry containing the electrochemically active material, conductive additive, and binder is cast on a substrate. In a further aspect, the substrate is a metallic foil. In one aspect, the metallic foil is an aluminum foil. In some aspects, the metallic foil is coated with carbon.

In still another aspect, the anode can be constructed from a variety of materials including, but not limited to: graphite, activated carbon, carbon nanotubes, graphene, lithium foil, and combinations thereof. In one aspect, the anode is commercial lithium foil or commercial graphite.

In one aspect, the electrolyte includes a lithium salt, a solvent including but not limited to a nonaqueous carbonate solvent, and an additive. In another aspect, the additive can include vinylene carbonate, prop-1-ene-1,3-sultone, 1,3,2-dioxathiolane-2,2-dioxide, 1,3,2-dioxathiane-2,2-dioxide, 1,5,2,4-dioxadithiane-2,2,4,4-tetraoxide, 1,3-propane sulfone, ethylene sulfite, tris(trimethyl-silyl)phosphate, tris(trimethyl-silyl) phosphite, propargyl methane sulfonate, allylmethanesulfonate, butadiene sulfone, propylene sulfate, succinic anhydride, maleic anhydride, 3-oxabibyblo[3.1.0]hexane-2,4-dione, 1,1′-(methylenedi-4,1-phenylene)bismaleimide, or a combination thereof. In another aspect, the additive can be from 0.5% to about 10% by weight.

In one aspect, the lithium salt is a commercial compound such as, for example, LiPF₆. In a further aspect, the electrolyte is dissolved to a concentration of 1 M in a solvent. In a still further aspect, the solvent is ethylene carbonate-ethyl methyl carbonate cosolvent. In another aspect, the electrolyte includes an additive such as, for example, 2 wt % vinylene carbonate. In one aspect, the electrolyte is 1 M LiPF₆ dissolved in ethylene carbonate-ethyl methyl carbonate cosolvent with 2 wt % vinylene carbonate.

In still another aspect, commercial anode materials and commercial electrolytes can be used as standards to test performance of the cathodes described herein.

Capacity Retention and Charge/Discharge Cycling of Batteries

In one aspect, a battery that includes the cathodes described herein has at least the properties listed in Table 1 below:

TABLE 1
Capacity Retention at Different C-Rates

| | Initial Capacity | Capacity | Number of |
|---|---|---|---|
| C-rate | (mAh/g) | Retention | Cycles |
| C/10 | 180-230 | ≥95% | 50 |
| C/5 | 175-225 | ≥86% | 150 |
| C/2 | 155-205 | ≥90% | 150 |
| 1C | 150-200 | ≥85% | 300 |

In one aspect, a battery incorporating a dual-doped LNO cathode as described herein can have an initial capacity of 175 mAh/g at 1C, or an initial capacity of 180 mAh/g at C/2, or an initial capacity of 200 mAh/g at C/5, or an initial capacity of 208 at C/10.

In another aspect, a battery incorporating a single-doped NMC cathode as described herein also exhibits improved cycling stability in energy density, discharge capacity, and voltage. In one aspect, Ti-doped NMC811 cycled at 1C between 2.5 and 4.5 V shows increased capacity retention over 300 cycles (80% versus 69% for Li⁺/Li) and over 500 cycles (70% versus 58% for Li⁺/Li).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS OF THE DISCLOSURE

The present disclosure will be better understood upon reading the following aspects, which should not be confused with the claims. In some instances, the aspects described below can be further combined with other aspects described elsewhere in this disclosure, including aspects from the examples below.

Aspect 1. A cathode comprising an electrochemically active material having a crystalline structure characterized by the formula LiMO₂, wherein M represents a metal ion and wherein the electrochemically active material comprises at least one dopant.

Aspect 2. The cathode according to any one of Aspects 1-18, wherein M comprises NiₓMn_{y}Co_{1-x-y} and wherein x>0.

Aspect 3. The cathode according to any one of Aspects 1-18, where M comprises NiₓMn_{y} where x+y is about 1.

Aspect 4. The cathode according to any one of Aspects 1-18, wherein the electrochemically active material is substantially free of Co.

Aspect 5. The cathode according to any one of Aspects 1-18, wherein the at least one dopant comprises Al, Na, Mg, Ti, Zr, Si, Nb, Ca, Sr, Ba, Zn, V, Fe, Cr, Cu, Nd, La, Mn, Co, Ga, Sb, Ce, Mo, Tc, Ru, Rh, Ag, Cd, Ge, W, Ca, B, F or a combination thereof.

Aspect 6. The cathode according to any one of Aspects 1-18, wherein the at least one dopant is Mn, Mg, Ti, and combinations thereof.

Aspect 7. The cathode according to any one of Aspects 1-18, wherein the at least one dopant occupies M lattice sites in the crystalline structure.

Aspect 8. The cathode according to any one of Aspects 1-18, wherein the at least one dopant is present in a concentration of from about 1 mol % to about 6 mol %.

Aspect 9. The cathode according to any one of Aspects 1-18, wherein 0.3≤x≤0.8, 0.1≤y≤0.4, and 0.1≤1-x-y≤0.4.

Aspect 10. The cathode according to any one of Aspects 1-18, wherein x=0.8, y=0.1, 1-x-y=0.1, and the at least one dopant is Ti and has a concentration of about 3 mol %.

Aspect 11. The cathode according to any one of Aspects 1-18, wherein x=1 and y=1-x-y=0.

Aspect 12. The cathode according to any one of Aspects 1-18, wherein the battery is a cobalt-free battery and the electrochemically active material comprises LiNiO₂.

Aspect 13. The cathode according to any one of Aspects 1-18, wherein the electrochemically active material comprises a nickel-manganese-cobalt.

Aspect 14. The cathode according to any one of Aspects 1-18, wherein the electrochemically active material comprises NiₓMn_{y}Co_{1-x-y} where 0.3≤x≤0.8, 0.1≤y 0.4, and 0.1≤1-x-y≤0.4.

Aspect 15. The cathode according to any one of Aspects 1-18, wherein the electrochemically active material comprises NiₓMn_{y}Co_{1-x-y} wherein x=0.8, y=0.1, and 1-x-y=0.1; x=0.6, y=0.2, and 1-x-y=0.2; x=0.5, y=0.3, and 1-x-y=0.2; or x=0.33, y=0.33, and 1-x-y=0.33.

Aspect 16. The cathode according to any one of Aspects 1-18, wherein the electrochemically active material comprises LiNiₓMn_{y}Co_{1-x-y}O₂ wherein 0.3≤x≤0.8, 0.1≤y≤0.4, and 0.1 s 1-x-y s 0.4.

Aspect 17. The cathode according to any one of Aspects 1-18, wherein x=0.8, y=0.1, and 1-x-y=0.1; x=0.6, y=0.2, and 1-x-y=0.2; x=0.5, y=0.3, and 1-x-y=0.2; or x=0.33, y=0.33, and 1-x-y=0.33.

Aspect 18 The cathode according to any one of Aspects 1-18, wherein the at least one dopant is Mg, Mn, Ti, or a combination thereof having a combined concentration of about 4 mol % or less.

Aspect 19. A process for preparing a cathode according to any aspect described herein, the process comprising: preparing a slurry containing a solvent, the electrochemically active material, a conductive additive, and a binder; casting the slurry on a substrate; and drying the cathode.

Aspect 20. The process according to any one of Aspects 19-27, wherein the solvent comprises N-methyl-2-pyrrolidone or water.

Aspect 21. The process according to any one of Aspects 19-27, wherein the conductive additive comprises acetylene carbon, carbon black, graphite, graphene, or a combination thereof.

Aspect 22. The process according to any one of Aspects 19-27, wherein the binder comprises polyvinylidene fluoride (PVDF), polyvinylidene fluoride-co-hexafluoropropylene (PVDF-HFP), polytetrafluoroethylene, carboxymethyl cellulose, alginate, or a combination thereof.

Aspect 23. The process according to any one of Aspects 19-27, wherein the slurry has a dry weight comprising 70-95 wt % electrochemically active material, 2.5-20 wt % conductive additive, and 2.5-10 wt % binder.

Aspect 24. The process according to any one of Aspects 19-27, wherein the slurry has a dry weight comprising 90 wt % electrochemically active material, 5 wt % conductive additive, and 5 wt % binder.

Aspect 25. The process according to any one of Aspects 19-27, wherein the substrate is a metallic foil.

Aspect 26. The process according to any one of Aspects 19-27, wherein the metallic foil comprises aluminum.

Aspect 27. The process according to any one of Aspects 19-27, wherein the metallic foil is coated with carbon.

Aspect 28. A process for preparing the electrochemically active material of the cathode of any Aspect described herein, the process comprising: admixing solutions of one or more water-soluble M salts or hydrates and one or more water-soluble dopant salts or hydrates with an aqueous base, forming a precipitate; collecting and drying the precipitate; admixing the precipitate with LiOH, LiOH.H₂O, Li₂CO₃, or LiHCO₃ to form a first mixture; and calcining the first mixture under air flow at a temperature of from about 650° C. to about 950° C. for a period of from about 2 hours to about 12 hours.

Aspect 29. The process according to Aspect 28, wherein the first mixture is calcined at 675° C. for 6 hours.

Aspect 30. An electrochemical cell comprising the cathode according to any Aspect described herein, an anode, and an electrolyte.

Aspect 31. The electrochemical cell according to any one of Aspects 30-42, wherein the anode comprises graphite, activated carbon, carbon nanotubes, graphene, lithium foil, or a combination thereof.

Aspect 32. The electrochemical cell according to any one of Aspects 30-42, wherein the anode comprises graphite.

Aspect 33. The electrochemical cell according to any one of Aspects 30-42, wherein mass loading of the cathode is from about 3 to about 75 mg/cm².

Aspect 34. The electrochemical cell according to any one of Aspects 30-42, wherein mass loading of the cathode is from about 5 to about 7 mg/cm².

Aspect 35. The electrochemical cell according to any one of Aspects 30-42, wherein the electrochemical cell has an initial capacity of from 150 to 200 mAh/g when discharged to the end-of-discharge voltage at a C-rate of C1.

Aspect 36. The electrochemical cell according to any one of Aspects 30-42, wherein the electrochemical cell retains at least 85% capacity after 300 charge/discharge cycles at a C-rate of C1.

Aspect 37. The electrochemical cell according to any one of Aspects 30-42, wherein the electrochemical cell has an initial capacity of from 155 to 205 mAh/g when discharged to the end-of-discharge voltage at a C-rate of C/2.

Aspect 38. The electrochemical cell according to any one of Aspects 30-42, wherein the electrochemical cell retains at least 90% capacity after 150 charge/discharge cycles at a C-rate of C/2.

Aspect 39. The electrochemical cell according to any one of Aspects 30-42, wherein the electrochemical cell has an initial capacity of from 175 to 225 mAh/g when discharged to the end-of-discharge voltage at a C-rate of C/5.

Aspect 40. The electrochemical cell according to any one of Aspects 30-42, wherein the electrochemical cell retains at least 86% capacity after 150 charge/discharge cycles at a C-rate of C/5.

Aspect 41. The electrochemical cell according to any one of Aspects 30-42, wherein the electrochemical cell has an initial capacity of from 180 to 230 mAh/g when discharged to the end-of-discharge voltage at a C-rate of C/10.

Aspect 42. The electrochemical cell according to any one of Aspects 30-42, wherein the electrochemical cell retains at least 95% capacity after 50 charge/discharge cycles at a C-rate of C/10.

Aspect 43. A battery comprising one or more electrochemical cells according to any Aspect described herein.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Synthesis of Electrochemically Active Materials

A. Cobalt-Free Electrochemically Active Material

A cobalt-free electrochemically active material with two dopants was synthesized as follows:

Baseline LiNiO₂ (LNO) and Mg/Ti—LiNiO₂ (Mg/Ti-LNO) were synthesized by a co-precipitation method followed by the high temperature calcination. The transition metal solution (0.1 mol NiSO₄.6H₂O dissolved in 100 mL of aqueous solution), starting solution (40 mL of NaOH and NH₃.H₂O aqueous solution with a molar ratio NaOH/NH₃=1.2, pH value was adjusted to 11), and base solution (100 mL of NaOH and NH₃.H₂O aqueous solution with a molar ratio NaOH/NH₃=1.2) were made and separately stored under N₂ protection. The transition metal solution and base solution were simultaneously pumped into the starting solution at a feed rate of ˜2 mL/min with continuous stirring at 55° C. under N₂ protection. The feed rate of the base solution was frequently tuned to keep the pH at 11±0.2. The precipitate was collected, washed, and filtered with deionized water and dried in a vacuum oven overnight at 105° C. The dried precursor was then mixed with LiOH thoroughly and calcined under air flow (2 L/min) at 675° C. for 6 h to obtain the final LiNiO₂ powder. For the Mg/Ti—LiNiO₂, the transition metal solution (0.096 M NiSO₄.6H₂O, 0.002 M MgSO₄.7H₂O and 0.002 M TiOSO₄ dissolved in 100 mL of aqueous solution), the doping solution (were dissolved in 50 mL of H₂O), starting solution (40 mL of NaOH and NH₃.H₂O aqueous solution with a molar ratio NaOH/NH₃=1.2, pH value was adjusted to 11), and base solution (100 mL of NaOH and NH₃.H₂O aqueous solution with a molar ratio NaOH/NH₃=1.2) were made and separately stored under N₂ protection. The transition metal solution and base solution were simultaneously pumped into the starting solution at a feed rate of ˜2 mL/min with continuous stirring at 55° C. under N₂ protection. The feed rate of the base solution was frequently tuned to keep the pH at 11±0.2. The precipitate was collected, washed, and filtered with deionized water and dried in vacuum oven overnight at 105° C. The dried precursor was then mixed with LiOH thoroughly and calcined under air flow (2 L/min) at 700° C. for 6 h to obtain the final Mg/Ti—LiNiO₂ powder.

B: NMC Electrochemically Active Materials

NMC811-Ti electrochemically active material was synthesized using a modified coprecipitation method (“gradient substitution”). A transition metal solution of 0.8 M NiSO₄.6H₂O (Sigma Aldrich, 99.99%), 0.1 M MnSO₄.H₂O (Sigma Aldrich, 99%) and 0.1 M CoSO₄.7H₂O (Sigma Aldrich, 99%) were dissolved in 100 mL of aqueous solution with a total metal concentration of 1 M. A base solution of 2 M NaOH and 1.67 M NH₃.H₂O was diluted to 100 mL of aqueous solution. Each solution was stored in a Kimble bottle and the base solution was under N₂ protection. A titanium solution was made using a titanium oxysulfate solution (Sigma Aldrich, 15 wt % in dilute sulfuric acid). 0.003 moles of titanium oxysulfate were dissolved in a 50 mL aqueous solution. This titanium solution was stored in its own Kimble bottle. 1 M NaOH and 0.83 M NH₃.H₂O were diluted to 160 mL in DI water and then placed into the reaction vessel. The vessel was heated to 50° C., protected with N₂ gas, and stirred continuously starting at 600 rpm. The pH was adjusted to ˜10.5. The transition metal solution and base solution were pumped into the reaction vessel at approximately 2 mL/min. Once the pumping began, a third pump was used to pump the titanium solution directly into the transition metal solution at 2 mL/min. The temperature and nitrogen protection were maintained throughout the reaction, and the base pumping was tuned to maintain a pH of 10.5±0.1. The stirring rate was gradually increased to maintain a consistent vortex in solution as volume increased. The precipitate was collected using vacuum filtration and washed with 400 mL DI water and then 400 mL of isopropanol. The precipitate was dried in a vacuum oven overnight at 100° C. The precursor and LiOH were mixed thoroughly and calcined under pure oxygen flow at 0.5 L/min. The calcination procedure involved heating at 5° C./min to 460° C. and holding for 1 hour, and then heating at 5° C./min to 725° C. and holding for 6 hours. Finally, it was cooled at 5° C./min to 25° C. under constant oxygen flow to obtain the final powder (i.e., “gradient substitution”). “Bulk substitution” samples were synthesized by having the titanium oxysulfate directly in the transition metal solution. “Surface substitution” samples were synthesized by precipitating Ti(OH)₄ after the (Ni, Mn, Co) hydroxide precipitation was completed. Baseline NMC811 was synthesized following a similar procedure but without the titanium oxysulfate.

### Example 2: Characterization of Materials

A. Cobalt-free Electrochemically Active Materials

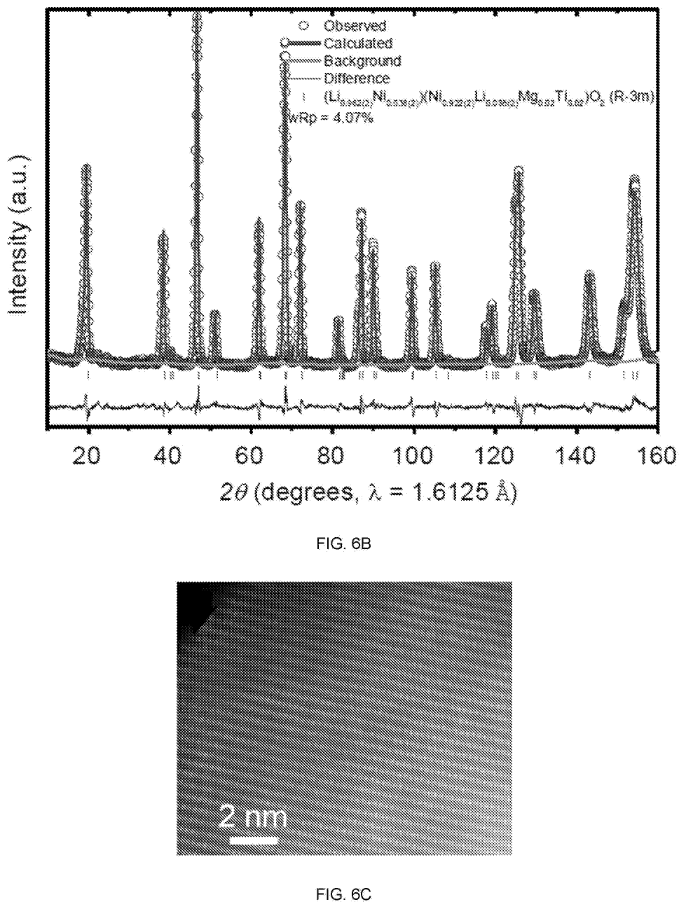

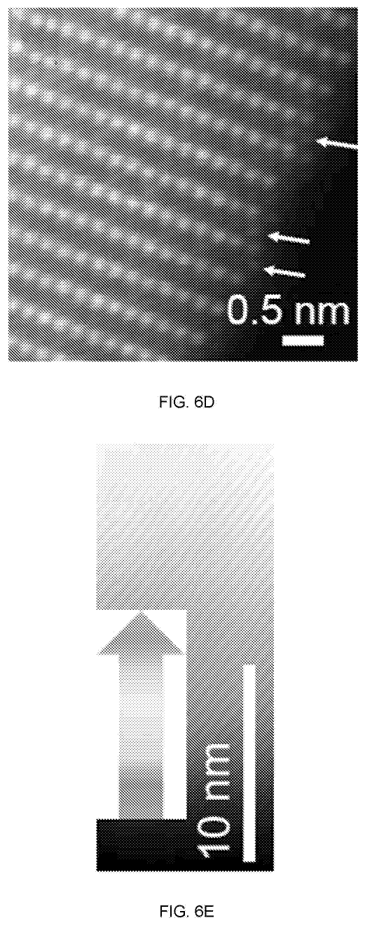

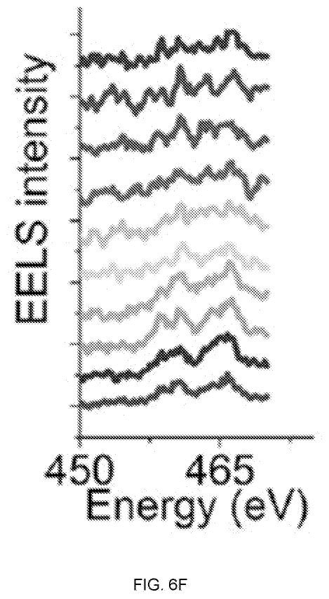

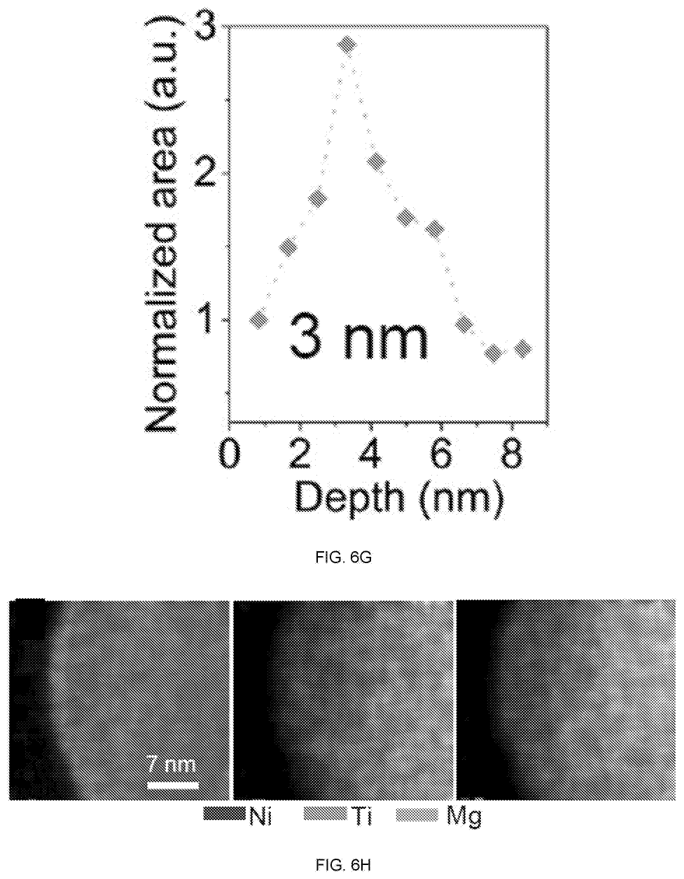

The morphologies of representative materials (LNO alone and LNO doped with Mg and Ti) were investigated. The pure layered phase (space group: R 3̅ m) was verified by synchrotron X-ray diffraction (XRD) and scanning transmission electron microscopy (STEM, FIGS. 6C-6D). Scanning electron microscopy (SEM) (LEO FESEM) was performed using an accelerated voltage of 5 kV. The XRD patterns were collected at the beam line 11-3 at Stanford Synchrotron Radiation Lightsource (SSRL) with an X-ray wavelength of 0.976 Å. The X-ray beam was focused vertically by an Rh-coated Si mirror and horizontally with a bent Si 311 monochromator. The beam size was further reduced to (w×d) 0.150 mm×0.150 mm with Ta slits. Data were collected on a MAR345 imaging plate positioned between 145-150 mm from the sample, with exposure time of 80 seconds per sample. Electrodes from disassembled charged or discharged cells were retrieved inside an Ar-filled glovebox and sealed with Kapton tapes. A LaB₆ sample was placed in the same location as the samples and was used to calibrate the diffraction configuration. 2D MAR345 diffraction images were converted to 1D diffraction patterns based on the calibration parameters obtained from the LaB₆ diffraction pattern. Scanning transmission electron microscopy (STEM) and electron energy loss spectroscopy (EELS) were acquired on a JOEL 2100 S/TEM operated at 200 keV. STEM imaging was performed for the primary particles at the surface region of the second particles.

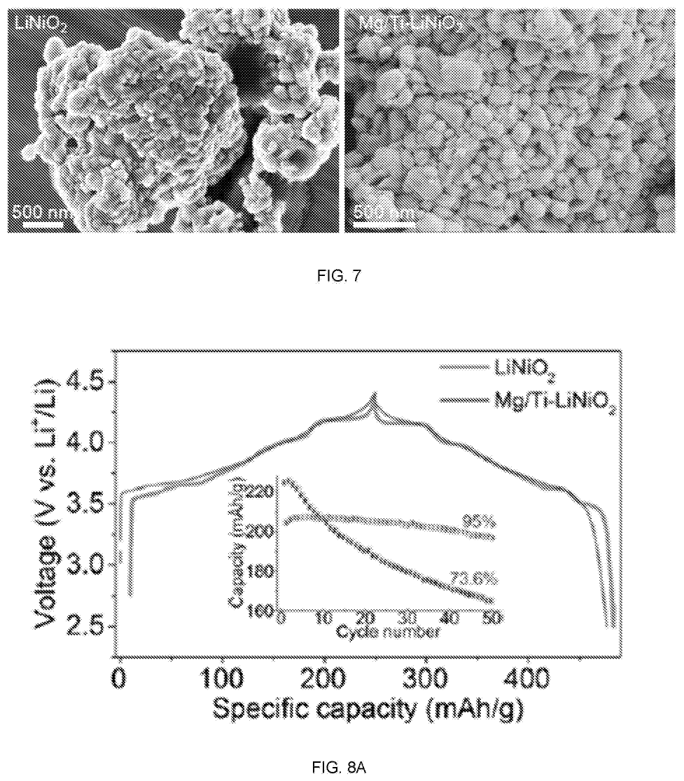

The polycrystalline secondary particles consist of 50-200 nm primary particles (FIG. 7). The Brunauer-Emmett-Teller (BET) specific surface areas of Mg/Ti—LiNiO and LNO were 1.1 m²/g and 0.3 m²/g, respectively. The specific surface area of Mg/Ti-LNO was lower than many commercial nickel-rich layered oxides. This suggests that the dual dopants facilitated the formation of much denser secondary particles, which might mitigate side reactions with the electrolyte. In Ni-rich layered oxides, the Li/Ni cation mixing (anti-site defect) is inevitable, leading to the formation of off-stoichiometric materials. This usually results in Li-deficient phases with slightly reduced Ni cations (Ni oxidation state<Ni³⁺). Indeed, the soft X-ray absorption spectroscopy (XAS) revealed that the Ni oxidation state was slightly lower than Ni³⁺ (FIG. 6A). Additionally, the Ti⁴⁺ dopant was fully accommodated in the layered lattice with no TiO₂ phase, as indicated by the absence of the Ti L₃-e_{g} splitting (FIG. 6A). The presence of carbonate species was evident at the surface (FIG. 6A). Neutron diffraction (ND) and Rietveld refinement were performed to determine that ˜4% Ni occupied the Li sites (FIG. 6B). The Rietveld refinement also suggested that both Mg²⁺ and Ti⁴⁺ occupied the Ni sites. The cation-mixing was unidentifiable in the bulk due to the small amount (FIG. 6C). Yet, a thin layer of Ni sitting at the Li sites was observed at the surface. These results suggested that the cation-mixing prefers lodging at the surface (FIG. 6D). To further probe the Ti distribution, electron energy loss spectroscopy (EELS) scanning from the particle surface to subsurface was performed (FIGS. 6E-6F). The Ti⁴⁺ L-edge signal was mainly detected in the first five spectra, and the normalized Ti⁴⁺ L-edge intensity confirmed that the Ti⁴⁺ dopant was enriched at the top few nanometers of the particles (FIGS. F-6G). The energy dispersive X-ray spectroscopy (EDS) mapping results (FIG. 6H) found that Mg²⁺ was evenly distributed whereas Ti⁴⁺ was enriched at the top surface (˜3 nm), which was consistent with the EELS. The surface-enriched Ti can form strong ionic bonding with the oxygen anion, thus reducing the TM3d-O2p hybridization and inhibiting the surface oxygen loss.

Soft XAS measurements were performed on the 31-pole wiggler beamline 10-1 at Stanford Synchrotron Radiation Lightsource (SSRL) using a ring current of 350 mA and a 1000 l·mm⁻¹ spherical grating monochromator with 20 μm entrance and exit slits, providing ˜10¹¹ ph·s−1 at 0.2 eV resolution in a 1 mm² beam spot. Data were acquired under ultrahigh vacuum (10⁻⁹ Torr) in a single load at room temperature using total electron yield (TEY), where the sample drain current was collected, and in the fluorescence yield (FY), where a silicon diode (IRD AXUV-100) was used to collect the FY positioned near the sample surface. All spectra were normalized by the current from freshly evaporated gold on a fine grid positioned upstream of the main chamber. XAS samples were mounted on an aluminum sample holder with double-sided carbon tape in an Ar-filled glove box, and transferred to the load-lock chamber in a double-sealed container, using a glove bag purged with argon for the transfer. Hard XAS measurements (Ni K-edge XAS) were performed in the transmission mode using a Si (220) monochromator at the APS Beamline 20-D. The absorption energy was calibrated by using the first inflection points in the spectra of Ni metal foil reference for Ni element. Based on the probing depth of soft XAS and hard XAS, soft XAS TEY mode is defined as being surface sensitive, XAS FY mode as being subsurface sensitive and hard XAS as being bulk sensitive for battery particles.

The coin cells containing the LNO and Mg/Ti-LNO were charged to 4.4 V at C/3. After that, the cathodes were collected in the glove box for future analysis. The charged cathodes dropped with the electrolyte was sealed in a stainless-steel pan under air and transferred to DSC equipment. The thermal properties of the charged electrodes of LNO and Mg/Ti-LNO were measured using a DSC-Q20 equipment at a scan rate of 10° C./min in the range of 40-300° C. under N₂/air flow.

B. NMC Electrochemically Active Materials

Other electrochemically active materials were characterized as described above and/or by the following methods.

A PANalytical Empyrean X-ray diffractometer with a Cu K_{α} (λ=1.54 Å) X-ray source and Bragg-Brentano HD divergent beam optic with an energy resolution of about 450 eV was used to collect powder XRD. The incident beam path included a 0.02 rad Soller slit, 10 mm beam mask, fixed antiscatter slit (½°) and fixed divergence slit (⅛°). Dry samples were loaded individually onto 32 mm low-background Si wafer samples holders with 0.2 mm wells (Panalytical) and rotated in place during the analysis. Diffracted intensities were collected from 10 to 80° 2θ in approximately 0.0018° increments using a GaliPIX^{3D} area detector system operating in line mode (501 active channels). The exposure time was approximately 28 sec/point. A 0.02 rad Soller slit was used in the diffracted beam path. The 31-pole wiggler beamline 10-1 at Stanford Synchrotron Radiation Lightsource (SSRL) using a ring current of 350 mA and a 1000 l·mm⁻¹ spherical grating monochromator with 20 μm entrance and exit slits, providing ˜10¹¹ ph·s⁻¹ at 0.2 eV resolution in a 1 mm² beam spot was used to collect soft XAS data. Total electron yield (TEY) was acquired using a single load at room temperature in an ultrahigh vacuum (10⁻⁹ Torr), where the sample drain current was collected, and fluorescence yield (FY), where a silicon diode (IRD AXUV-100) was used to collect the FY positioned near the sample surface. Scanning transmission electron microscopy (STEM), electron energy loss spectroscopy (EELS) and energy dispersive X-ray spectroscopy (EDS) were acquired on a JEOL 2100 S/TEM operated at 200 keV. Hard XAS measurements (Ni, Mn and Co K-edge XANES and EXAFS) were performed on the electrodes in the transmission mode at the beamline 20-BM-B of the Advanced Photon Source (APS) at Argonne National Laboratory. The incident beam was monochromatized by using a Si (111) fixed-exit and a double-crystal monochromator. Energy calibration of each spectrum was made by aligning the first derivative maximum of a reference Ni, Mn, Co XANES spectra collected simultaneously from the metal foils in the reference channel.

C. Theoretical Calculation Method

The time-dependent density functional theory (TDDFT) based X-ray absorption near edge structure (XANES) calculations, as implemented in Finite Difference Method Near Edge Structure (FDMNES) package [O. Bunau and Y. Joly, Self-consistent aspects of x-ray absorption calculation, J. Phys.: Condens. Matter 21, 345501 (2009)], have been performed for Ti-substituted Li₁₋ₓMO₂. Within the TDDFT method, the partly localized edges (L23 edges of transition metal Ti) can be described quite correctly beyond the most common density functional theory (DFT).

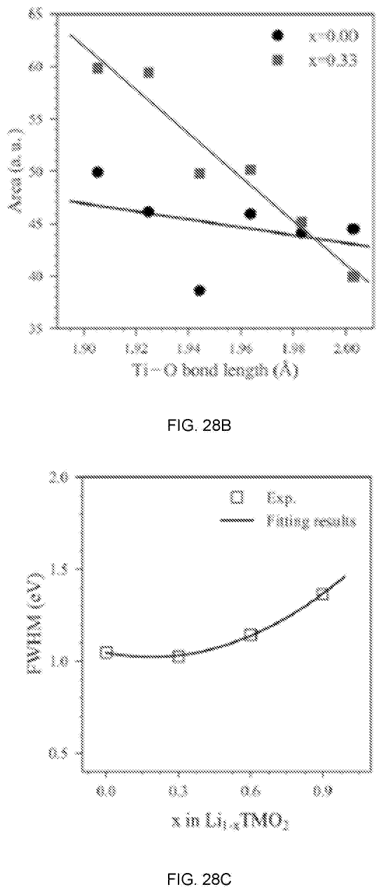

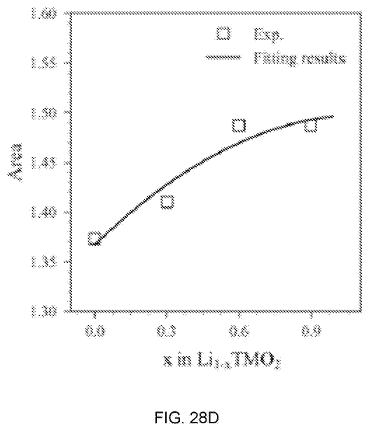

Firstly, in order to provide the quantitative experimental quantity for theoretical modeling, we perform the peak fitting for the experimental XAS spectra of Ti L-edge with different lithium concentration. In such way, we are able to set up an experimental database of FWHM, area, position of Ti L-edge peaks. Typical fitting results are shown in FIGS. 27A-27C for example. One can clearly see the trend of broadening character of Ti L-edge during the delithiation process. Secondly, the XANES calculation of Ti-substituted Li₁₋ₓMO₂ has been done with TDDFT based Finite Difference Method using a cluster model. The XANES calculations were performed on clusters containing 66 atoms and with the convolution widths of 1.2 eV for L2 and L3 edge, respectively. A theoretical database of XANES as a function of Ti—O bond length and lithium concentration has been thus obtained. FIGS. 28A-28B shows typical XANES results for two different Li concentration as a function of Ti—O bond length.

Thirdly, first principles total energy calculations based on DFT has been done for Ti-substituted Li₁₋ₓMO₂ to obtain the trend of lattice constant changed with Ti substituting and Li concentration. The Vegard's law of lattice changed is thus verified with changes of Li concentration.

Finally, the theoretical model of XANES as a function of Ti—O bond length and lithium concentration has been built and fitted to experimental data, utilizing the obtained trends of XANES vs bond length (FIGS. 28A-28B) and the Vegard's law for lattice changed with lithium concentrations x. The fitting formula of Li₁₋ₓMO₂ can be expressed as,

$$FWHM = ( {w}_{00} + {w}_{01} x ) - ( {w}_{10} + {w}_{11} x ) b ( x ) , \\ Area = ( {α}_{00} + {α}_{01} x ) - ( {α}_{10} + {α}_{11} x ) b ( x )$$

where b(x)=b₀−b₁x, is the bong length of Ti—O, b₀ and b₁ are coefficient parameters. The best fitted parameters are listed below: w₀₀=6.80, w₀₁=11.05, w₁₀=2.79, w₁₁=5.65; α₀₀=7.00, α₀₁=−1.86, α₁₀=2.73, α₁₁=−0.86; and b₀=2.06, b₁=0.12. The comparison of fitting results from theoretical model and experiments are shown in FIGS. 28C-28D.

### Example 3: Construction of Batteries

Representative composite cathodes for both LNO and NMC electrochemically active materials were prepared by spreading the slurry (N-Methyl-2-pyrrolidone as the solvent) with active materials (90 wt %), acetylene carbon (5 wt %) and PVDF (5 wt %) as the binder and casting them on carbon-coated aluminum foils. The electrodes were then dried overnight at 120° C. in a vacuum oven and transferred into an Ar-filled glove box. The active mass loading ˜1.2 mAh/cm² (7 mg/cm²). CR2032 coin cells were assembled in an Ar-filled glovebox (O₂<0.5 ppm, H₂O<0.5 ppm) using the composite cathode, lithium foil as the anode, Whatman glass fiber (1827-047 934-AH) as the separator and 1M LiPF₆ dissolved in ethylene carbonate (EC) and ethyl methyl carbonate (EMC) (3:7 ratio) of EC/EMC) with 2 wt % vinylene carbonate (VC) as the electrolyte. All cells were cycled with an electrochemical workstation (Wuhan Land Company) at 22° C. and 60° C. in an environmental chamber. Electrochemical testing was performed using a LAND battery testing system and the specific energy was calculated using the LANDdt software. 1C was defined as fully charging a cathode in 1 h, corresponding to a specific current density of 200 mA/g. The same rate was used for discharging the cathodes.

Composite cathodes for other battery materials were synthesized in a similar manner.

### Example 4: Characterization and Testing of Ti-Doped NMC Batteries

A. Layered Structure of NMC811-Ti

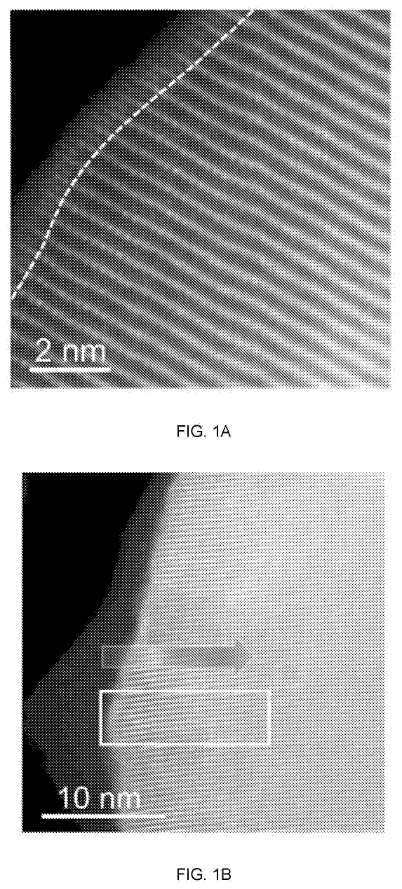

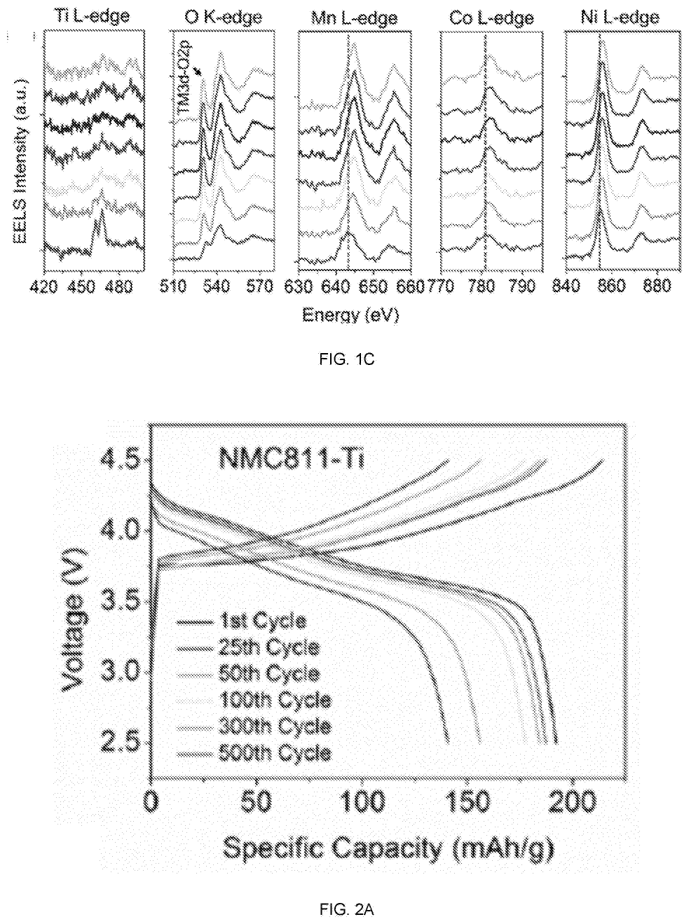

Pristine NMC811-Ti material had an R3̅m layered structure and a similar X-ray diffraction (XRD) pattern to baseline NMC811 (FIG. 24A). The I₀₀₃/I₁₀₄ ratio increased from 1.35 in NMC811 to 1.74 in NMC811-Ti, implying that the Ti⁴⁺ substitution limited the initial Li/TM cation mixing. Subsequently, scanning transmission electron microscopy-electron energy loss spectroscopy (STEM-EELS) analysis was employed to probe the Ti⁴⁺ distribution as well as the surface electronic properties of NMC811-Ti. The particles had a layered structure in the bulk with a slight surface reconstruction layer that was expected in nickel-rich cathode materials (FIG. 1A). Furthermore, the high-resolution Ti L-edge XAS demonstrated that Ti⁴⁺ was fully incorporated in the NMC811 lattice, free of any TiO₂ phases (FIG. 24B). The EELS scanning shows that Ti⁴⁺ was present throughout the primary particle and enriched at the top 1-2 nm surface (FIGS. 1B-1C), i.e., hierarchical substitution. Meanwhile, the (Ni, Mn, Co) L-edge and O K-edge spectra showed that the surface was slightly reduced. The surface reduction is attributable to the surface reconstruction and the necessity of charge compensation caused by the tetravalent Ti⁴*. Such a reduced surface may potentially inhibit the electrolyte oxidation at the cathode surface during cycling.

B. Improved Cycling Stability of NMC811-Ti

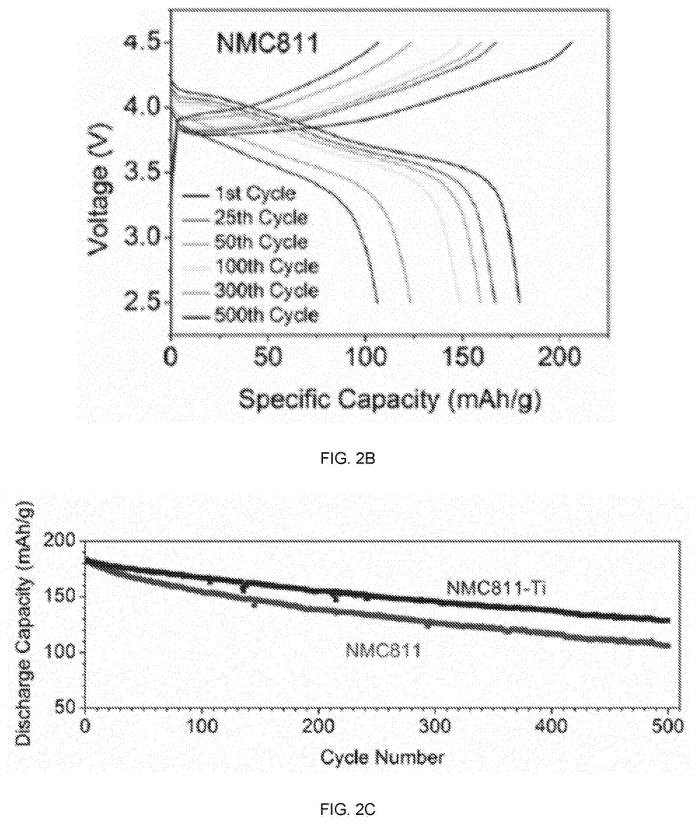

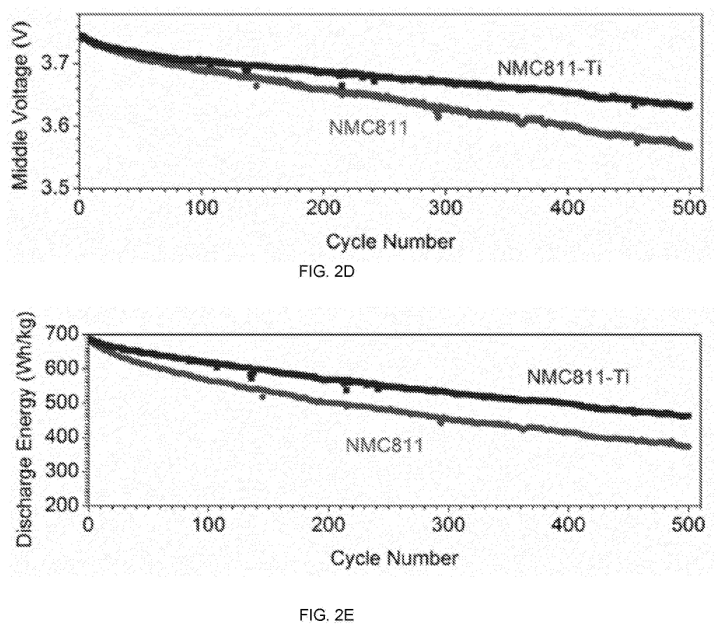

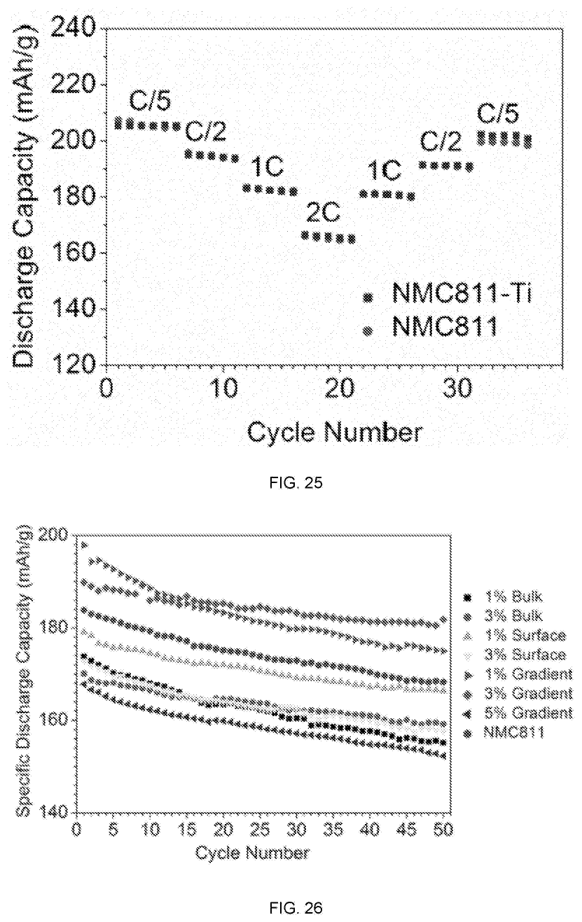

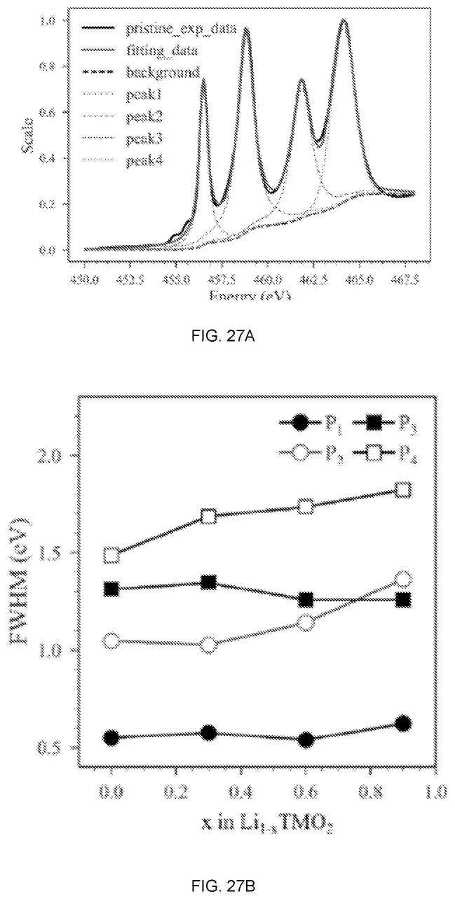

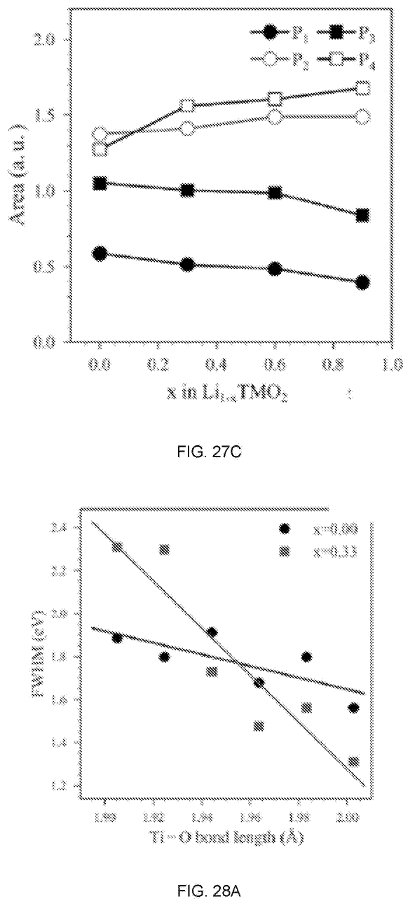

Compared to the baseline NMC811, the NMC811-Ti material exhibited improved cycling stability in energy density, discharge capacity, and voltage, which is attributable to the mitigated cell polarization in the NMC811-Ti (FIGS. 2A-2B). When cycled at 1C between 2.5-4.5 V versus Li⁺/Li, the Ti⁴⁺ substitution increased the capacity retention from 69% to 80% over 300 cycles, and from 58% to 70% over 500 cycles (FIG. 2C). Such good capacity retentions have been rarely reported for Ni-rich layered oxides such as NMC811 cycled to high voltages (e.g., 4.5 V vs. Li⁺/Li) for 500 cycles. The rate of voltage drop decreased from 0.35 mV/cycle to 0.22 mV/cycle after the Ti⁴⁺ substitution (FIG. 2D). The Ti⁴⁺ substitution also increased the energy retention from 54% to 67% over 500 cycles (FIG. 2E). The rate capability did not seem to be altered much by the Ti⁴⁺ substitution (FIG. 25). Finally, the battery performance of the NMC811-Ti was superior to those of Ti⁴⁺-substituted NMC811 materials synthesized with different Ti⁴⁺ concentrations or using different methods (FIG. 26).

C. Reversibility of Ti⁴⁺ Local Chemical Environment

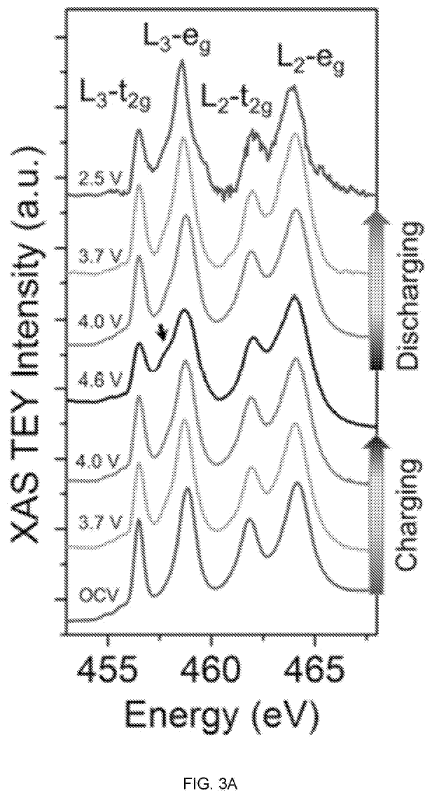

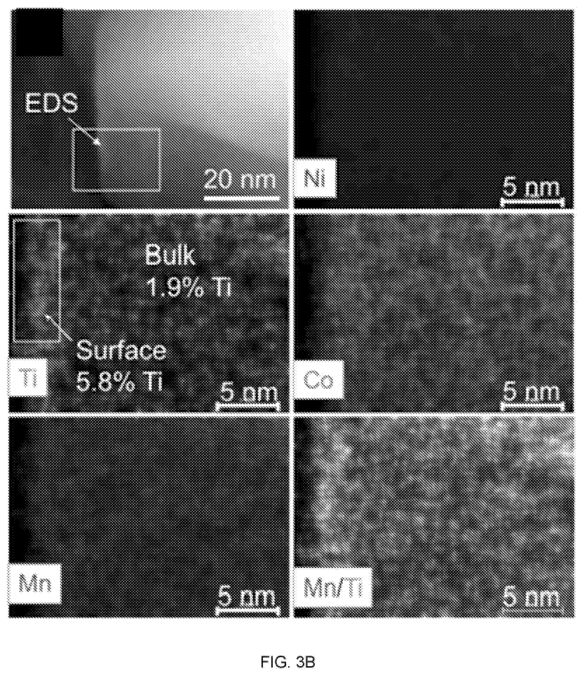

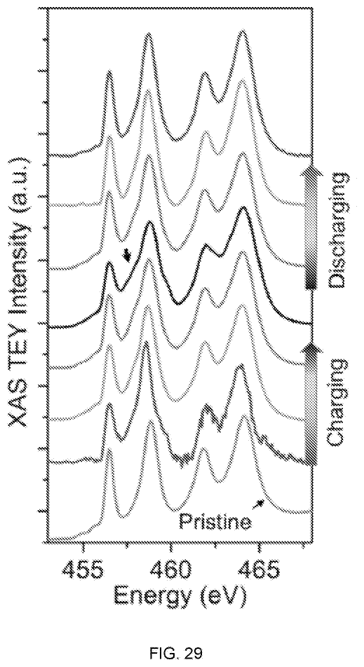

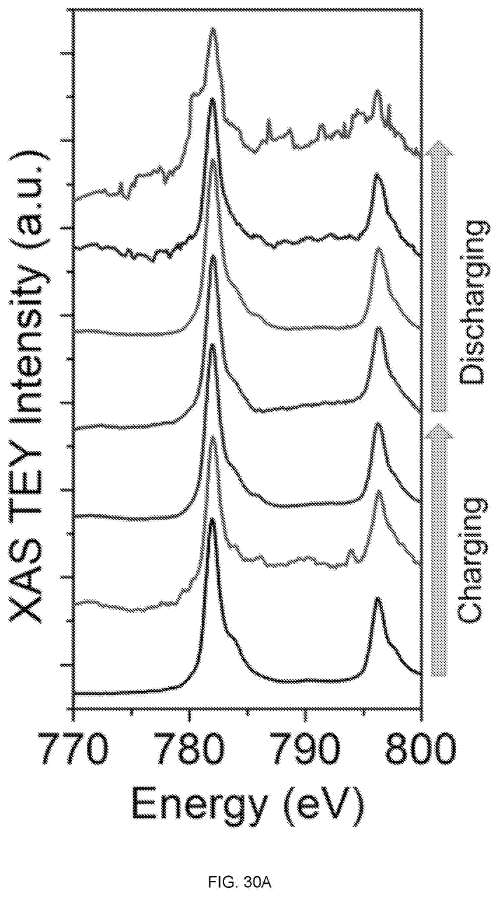

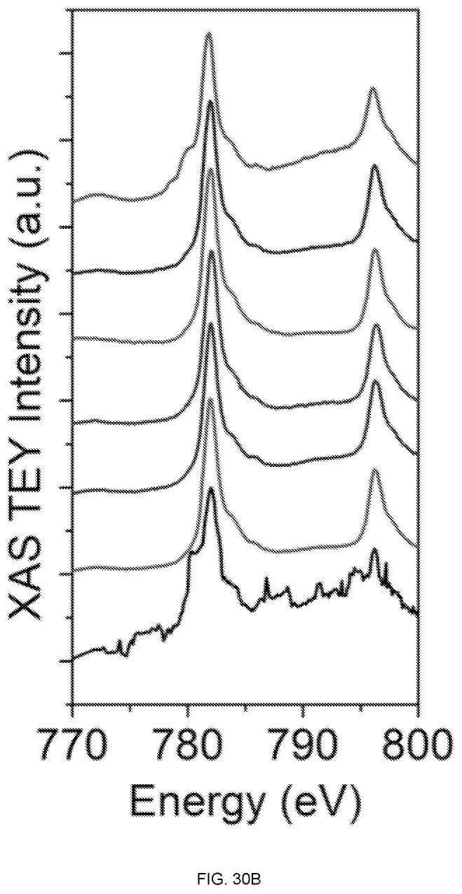

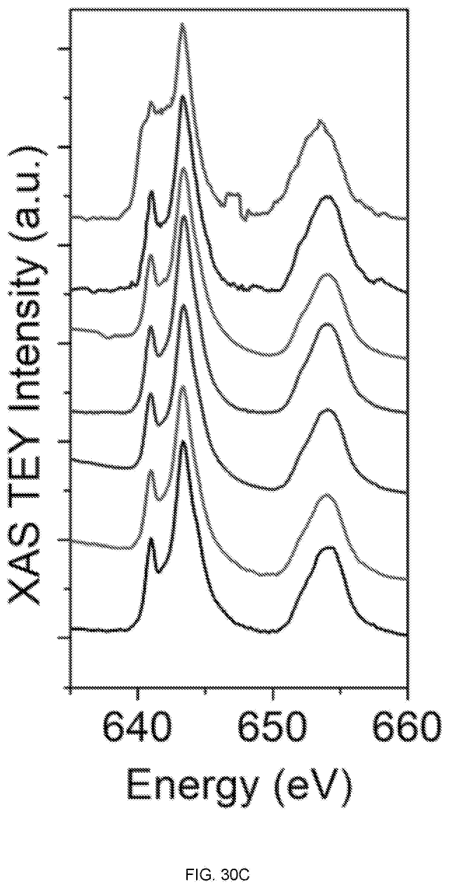

Soft XAS Ti L-edge was used to monitor the reversibility of the Ti⁴⁺ local chemical environment (FIG. 3A). Ti L₃-e_{g} and L₂-e_{g} peaks got gradually broadened upon charging and reversibly sharpened upon discharging (FIG. 3a and FIGS. 27A-27C). The finite difference method near edge structure (FDMNES) calculation showed that the broadening was attributed to the reduced Ti—O bond length (FIGS. 28A-28D). The Ti⁴⁺ local environment was fully reversible after multiple cycles (FIG. 29). STEM-EDS mapping of the NMC811-Ti showed that the hierarchical Ti⁴⁺ distribution remained intact after prolonged cycles (FIG. 3B). Ti was still enriched at the surface (˜6 at %) after 300 cycles at 1C between 2.5-4.5 V versus Li⁺/Li. Therefore, one can conclude that the Ti⁴⁺ chemical environment was highly reversible and might be capable of accommodating the strain by changing the Ti—O bond length.

D. Evolution of Surface Chemistry as a Function of the State of Charge and Cycle Number

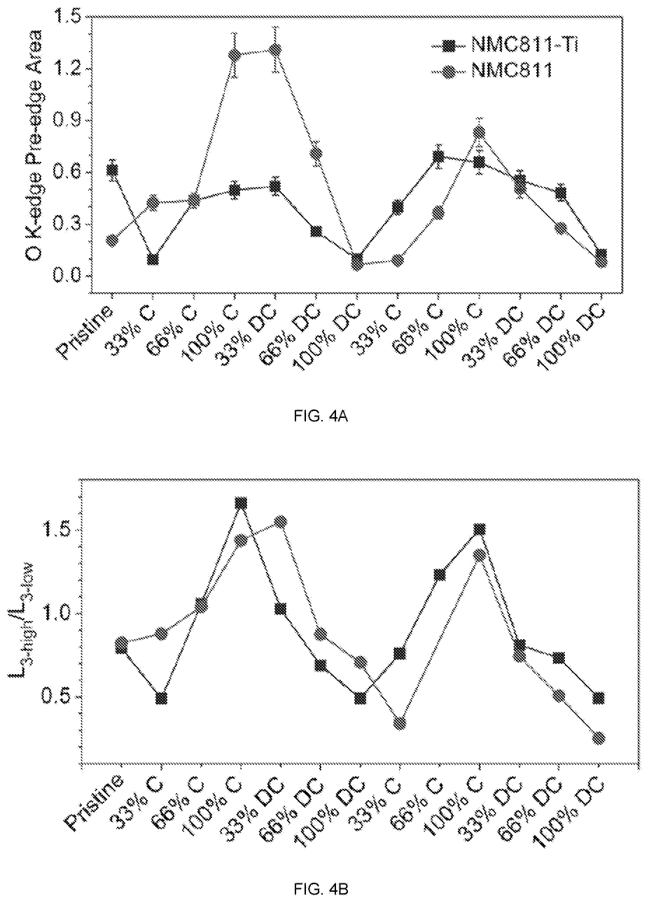

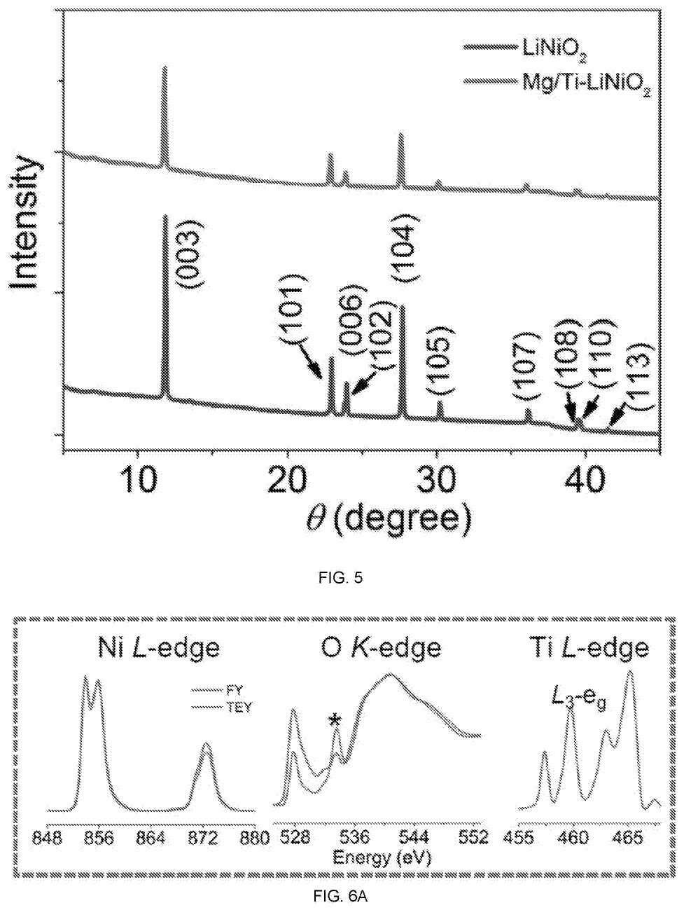

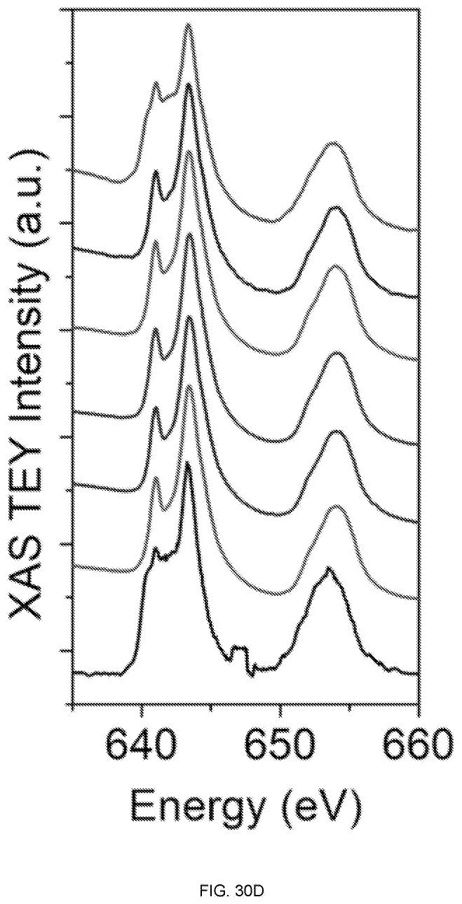

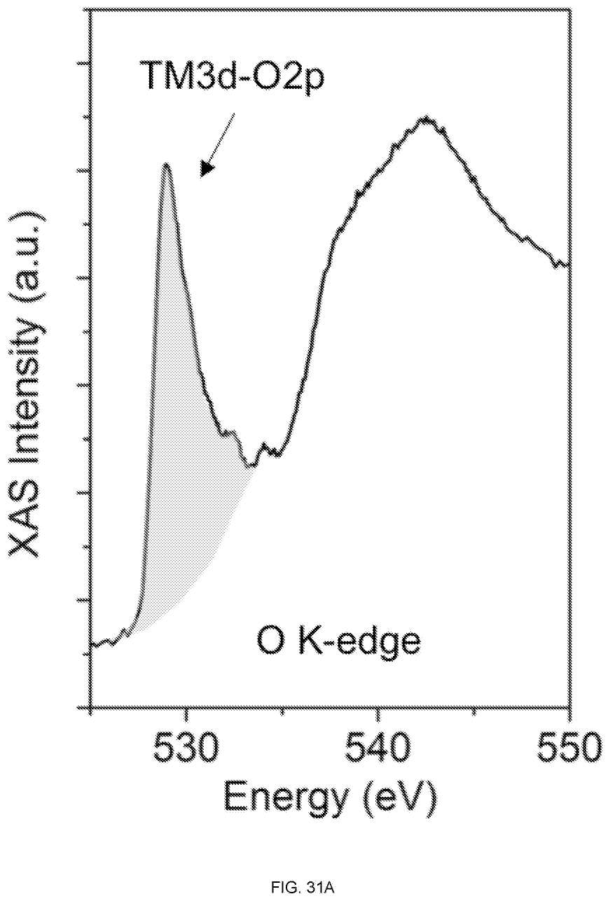

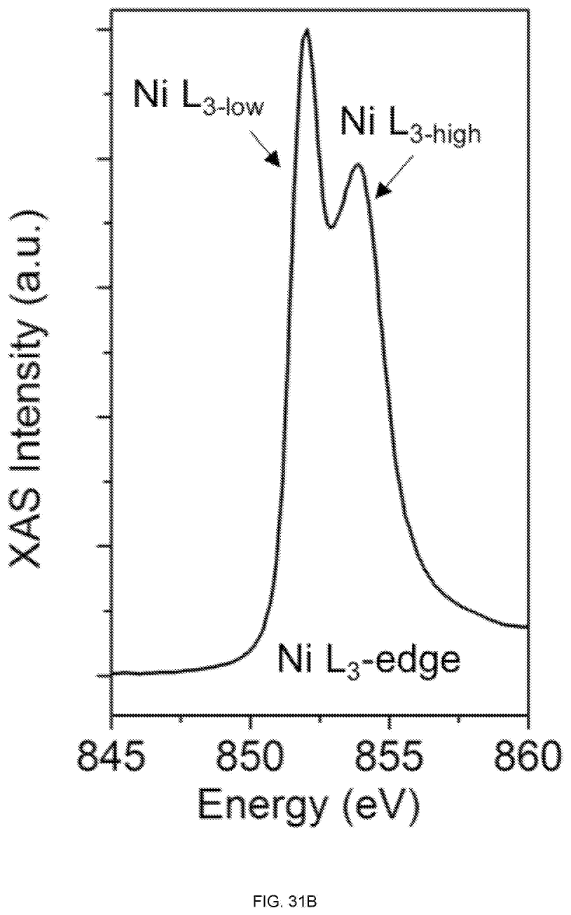

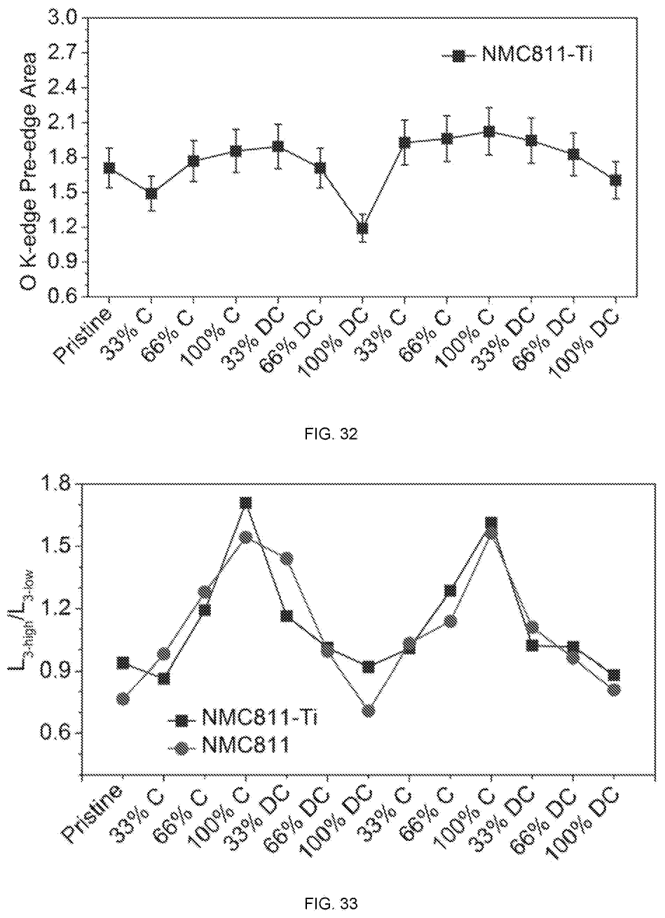

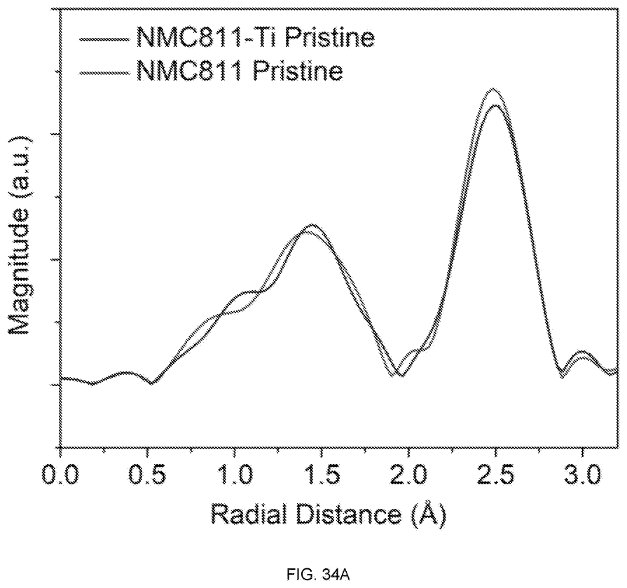

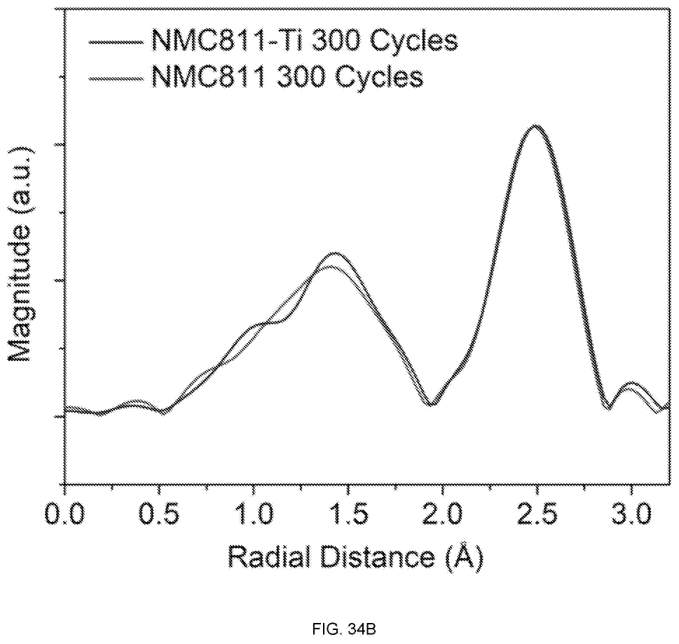

The evolution of surface chemistry was analyzed as a function of the state of charge and cycle number. It was expected that surface Ti⁴⁺ enrichment could decrease the transition metal-oxygen covalency, thus improving the oxygen stability at the surface. The surface chemistry of layered oxide cathode materials is dominated by the surface reconstruction (i.e., transition metal reduction, oxygen loss). For Ni-rich layered oxides, nickel cations play the dominant role in the surface reconstruction. Mn and Co cations exhibited relatively high reversibility at the surface of NMC811-Ti (FIGS. 30A-30D). The resilience against surface reconstruction can be characterized by the reversibility of TM3d-O2p hybridization and quantified by the pre-edge intensity of the O K-edge soft XAS in the TEY mode (FIG. 31A). The quantification of the TM3d-O2p hybridization clearly showed that the NMC811-Ti had deactivated oxygen sites and improved reversibility relative to the NMC811 (FIG. 4A). In addition, the subsurface oxygen environment, probed by the fluorescence yield (FY) mode, was also highly reversible in the NMC811-Ti material (FIG. 32). The reversibility of surface nickel cations was further compared. In general, the Ni oxidation state in NMC811-Ti was more reversible than that in the NMC811 (FIG. 4B and FIG. 31B). The subsurface nickel oxidation state was reversible in both NMC811-Ti and NMC811 (FIG. 33). Therefore, our spectroscopic study concluded that the Ti⁴⁺ substitution can stabilize the TM3d-O2p chemical environment at the surface.

E. Impact of Ti⁴⁺ Substitution on Bulk Chemical Environment

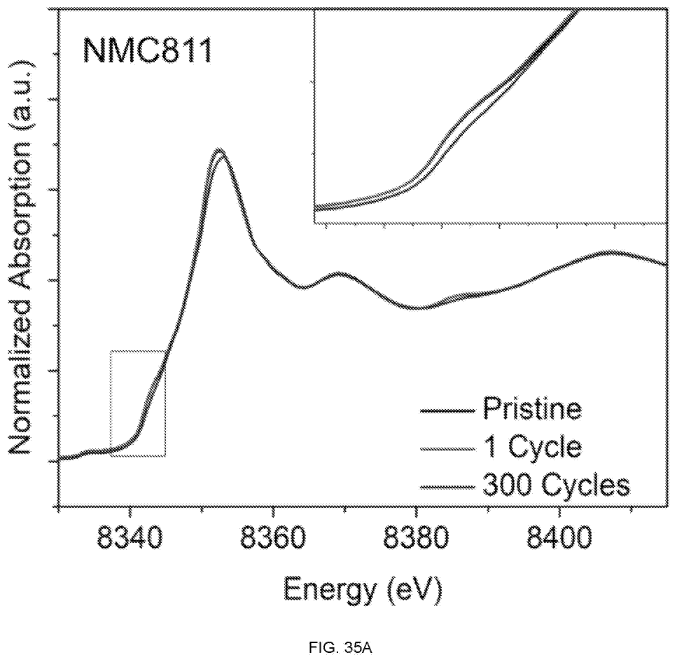

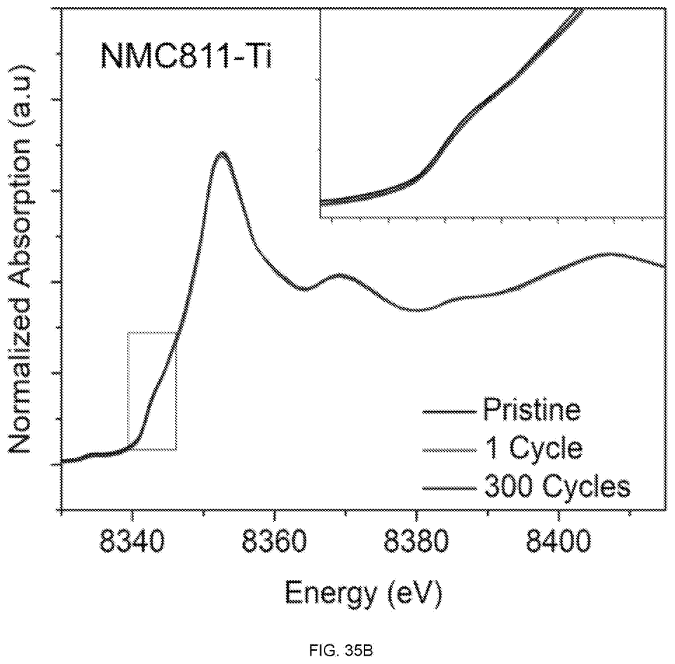

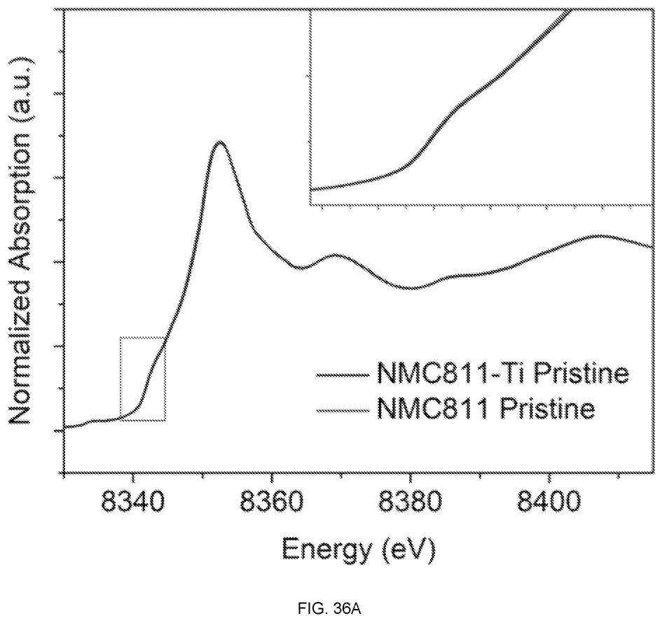

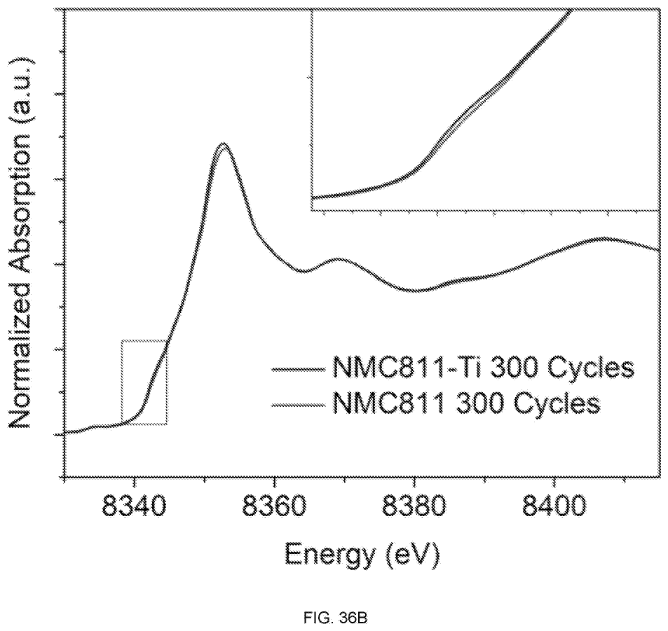

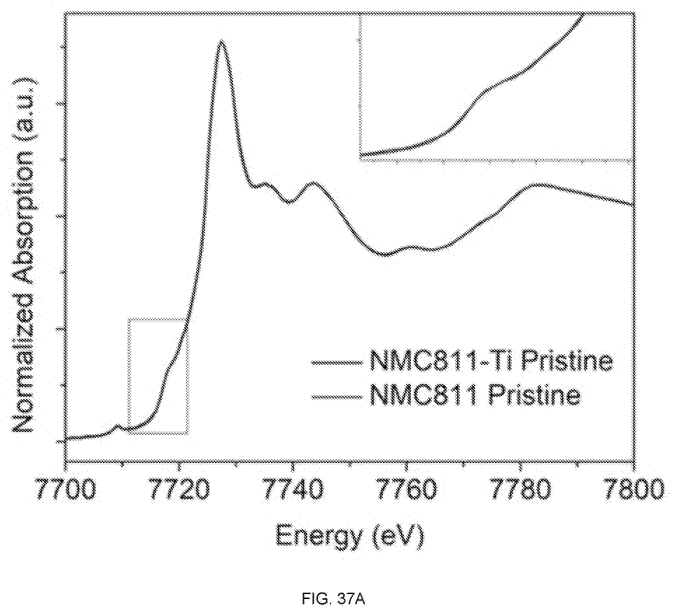

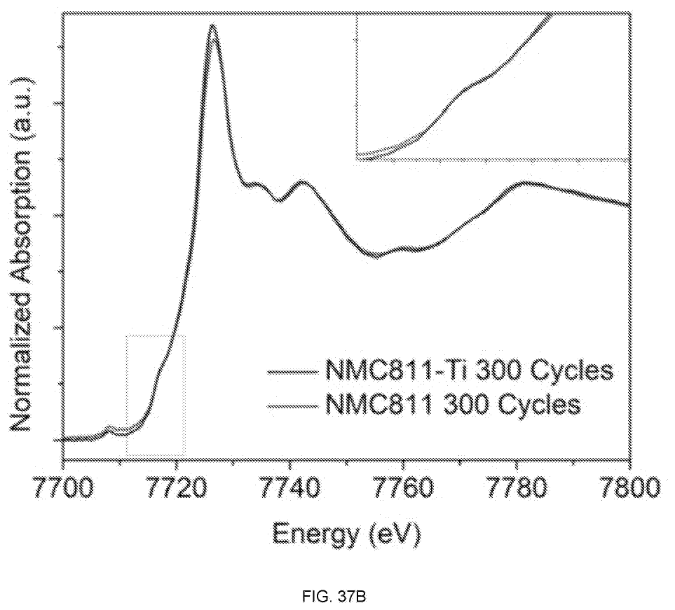

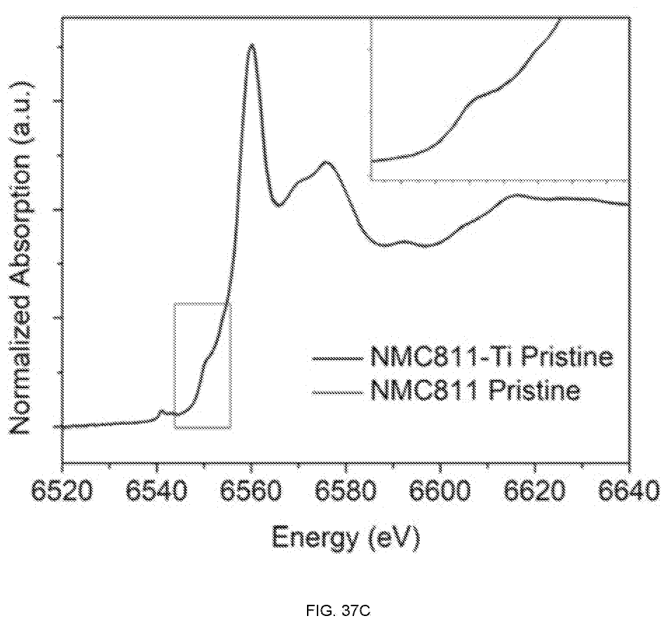

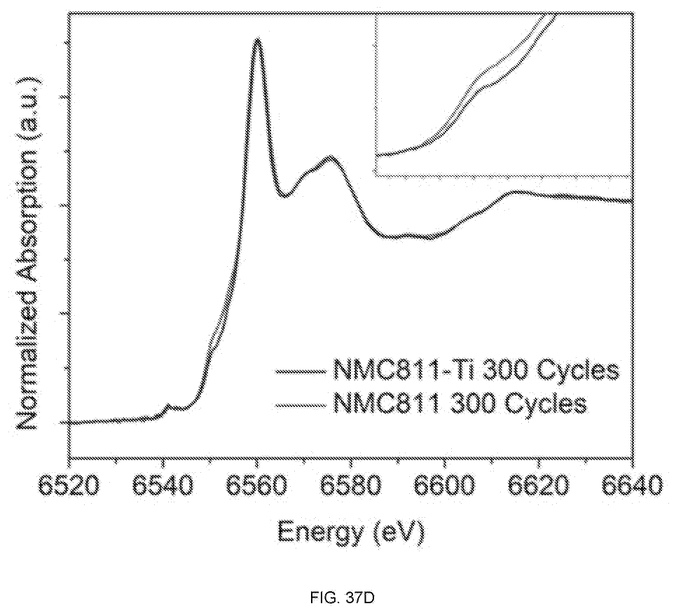

Finally, the impact of Ti⁴⁺ substitution on the bulk chemical environment using hard XAS was studied. The Ti⁴⁺ substitution slightly increased the Ni—O bond length, indicating the decreased Ni—O covalency (FIG. 34A). Importantly, such a desirable impact of Ti⁴⁺ substitution remained effective even after 300 cycles (FIG. 34B). It is important to note that the substitution effect mainly remained at the surface and the shift is expected to be minor in the EXAFS. The bulk nickel oxidation state remained unchanged after 300 cycles in both NMC811 and NMC811-Ti (FIGS. 35A-35B). Meanwhile, there was no difference in the bulk nickel oxidation state between NMC811 and NMC811-Ti in the pristine state and after 300 cycles (FIGS. 36A-36B). Furthermore, the changes in (Mn, Co) K-edge XAS were similar in NMC811 and NMC811-Ti (FIGS. 37A-37D). Therefore, the bulk characterization demonstrated that in the bulk the Ti⁴⁺ substitution modified the local bond length and did not alter TM oxidation states. It should be noted the stability of the NMC811-Ti could be further enhanced if methods were taken to mitigate other fading mechanisms, such as chemomechanical breakdown.

### Example 5: Testing of LNO Batteries

A. Battery Performance at 2.5-4.4V

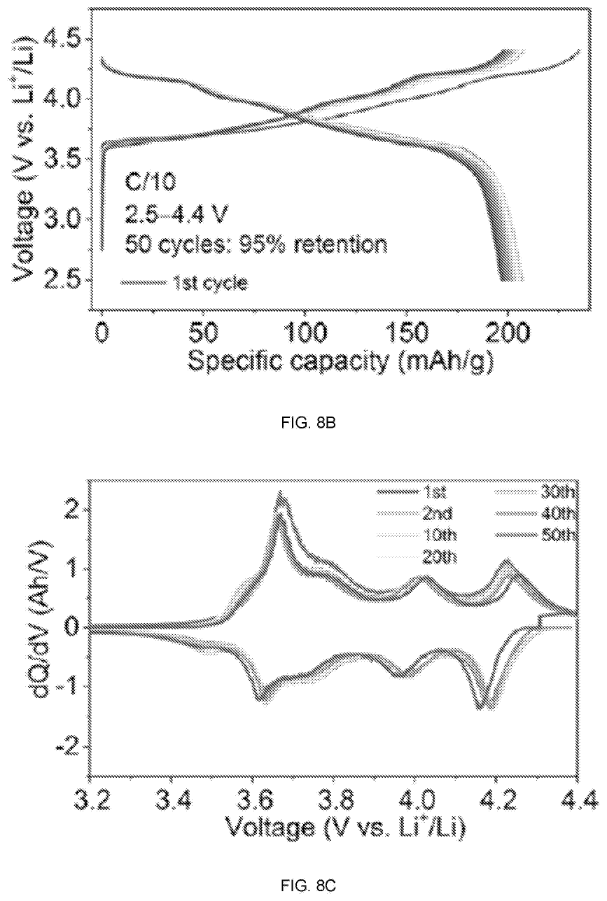

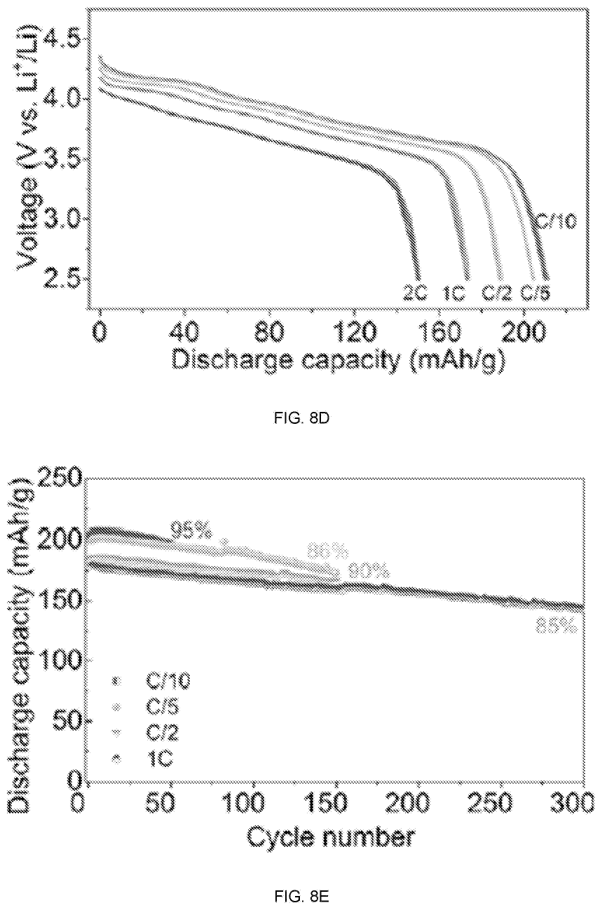

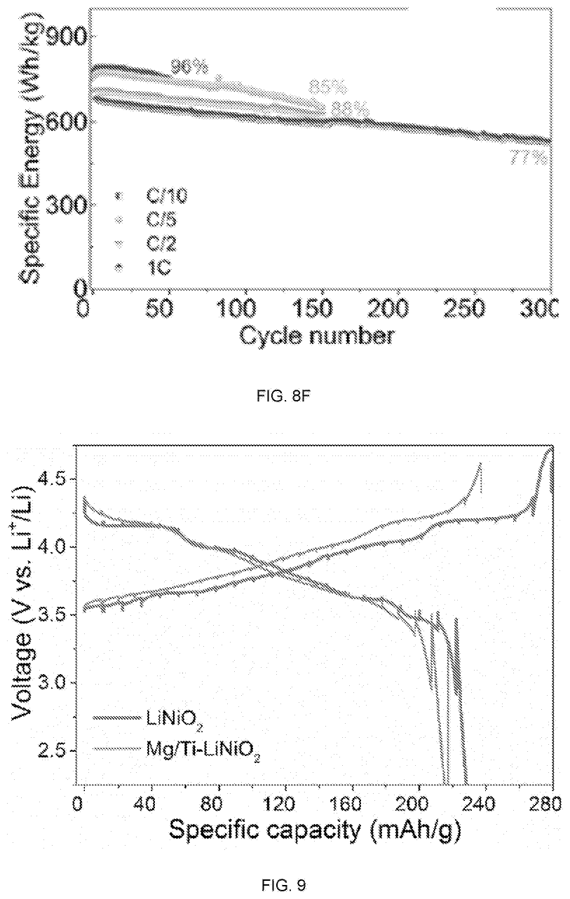

Battery performance of the Mg/Ti—LiNiO₂ cathode in half and full cells was evaluated at 2.5-4.4 V vs. Li⁺/Li and 22° C. Such a high upper cutoff voltage allowed us to investigate the advantages of the dual dopants in limiting phase transformations and mitigating the cathode-electrolyte interfacial reactions under aggressive conditions. Compared with LiNiO₂, the Mg/Ti—LiNiO₂ showed much smoother charge/discharge profiles (FIG. 8A), indicating the minimized phase transformations and Li/vacancy ordering.

B. Galvanostatic Intermittent Titration Technique (GITT)

The following mathematical relationship was used to analyze GITT measurements:

$$\tilde{D} = \frac{4}{πτ} {( \frac{{m}_{B} {V}_{M}}{{M}_{B} S} )}^{2} {( \frac{Δ {E}_{S}}{Δ {E}_{τ}} )}^{2}$$

where T is the pulse duration (in this case it was 1 hour); m_{B} and M_{B} are the active mass and molar mass of the active material, either LiNiO₂ or Mg/Ti—LiNiO₂; V_{M} is the molar volume (for LiNiO₂ and Mg/Ti—LiNiO₂, 21.55 cm³/mol was used); S is the active surface area of the electrode; AEs and ΔE_{T} can be obtained from the GITT curves; V_{M}=density/N_{A}; and S=(mass loading)×(specific surface area).

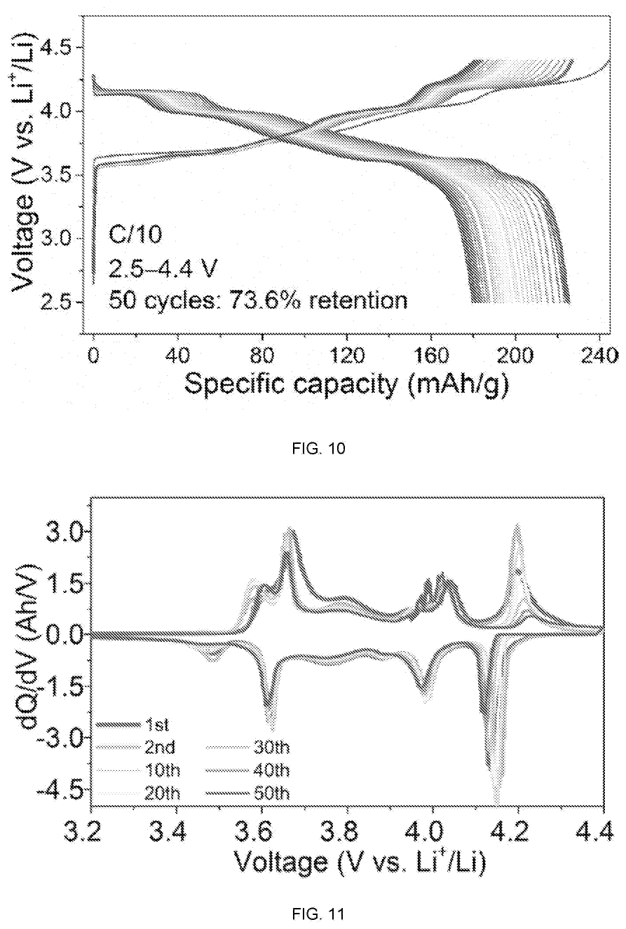

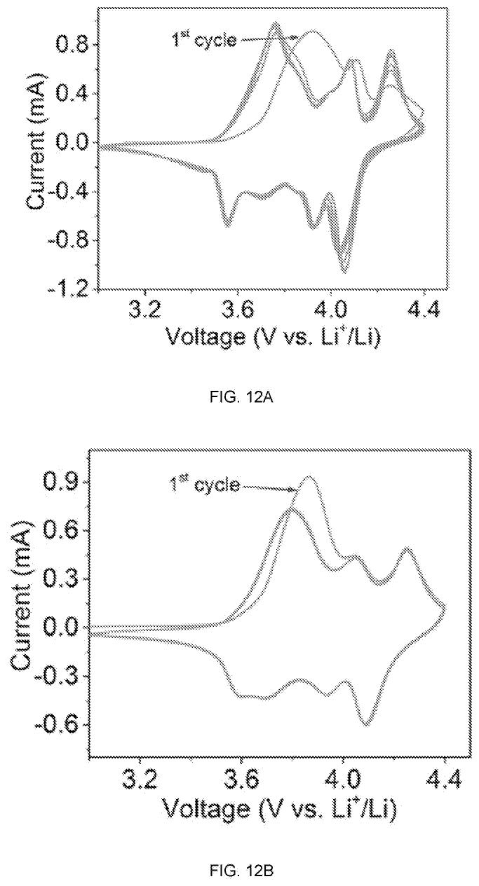

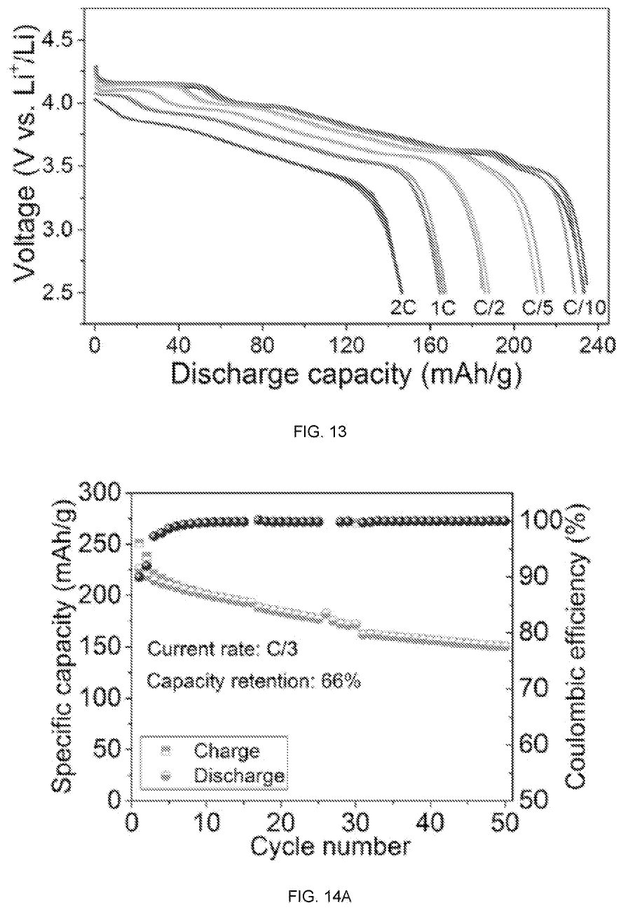

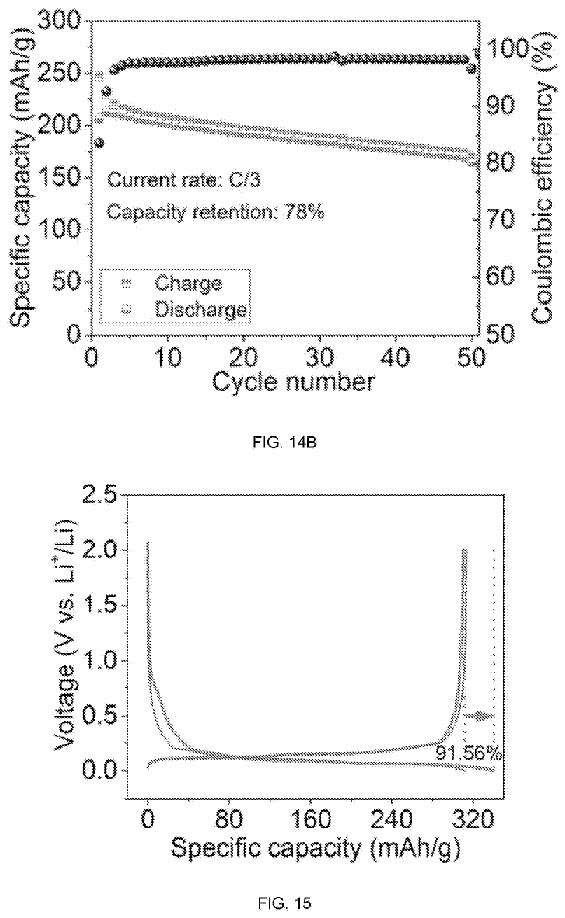

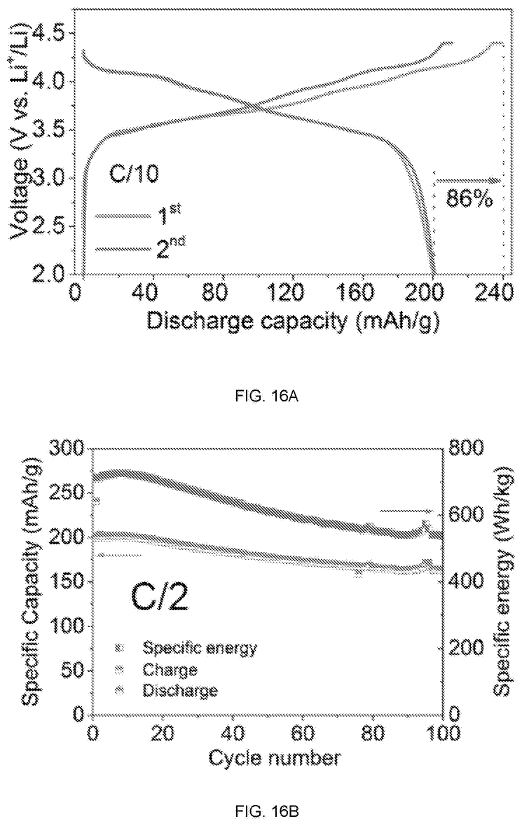

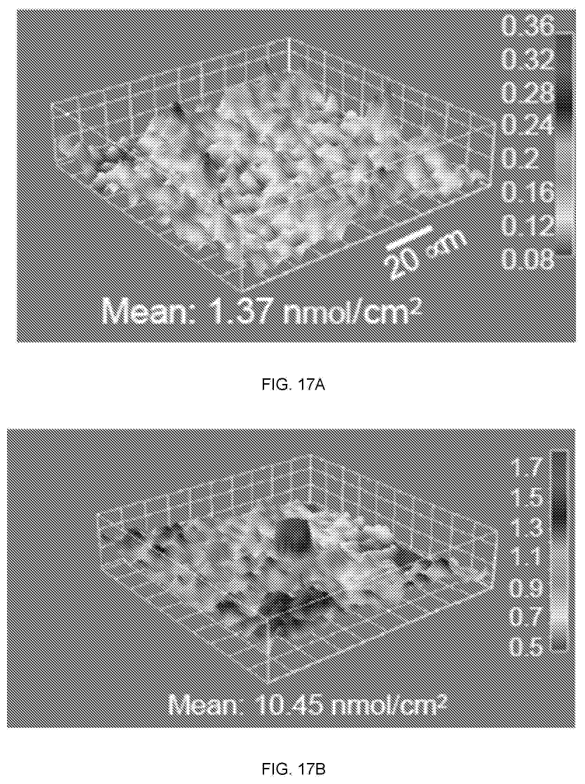

The galvanostatic intermittent titration (GITT) measurements showed that the open circuit voltages (OCVs) upon discharging were close in these materials, but the Mg/Ti-LNO cathode had a higher charging OCV (FIG. 9), suggesting that the dual dopants slightly enlarged the polarization. At C/10, the Mg/Ti-LNO cathode delivered a 208 mAh/g discharge capacity with an initial Coulombic efficiency of 86.8%, which was slightly lower than the baseline LNO (225 mAh/g, FIG. 10). However, the charge/discharge profiles of Mg/Ti-LNO after 50 cycles overlapped well with the second cycle (i.e., minimal increase of cell polarization), delivering a 95% capacity retention that was remarkably higher than the baseline LNO (73.6%, FIG. 8A and FIG. 10). The dQ/dV vs. voltage was calculated based on the charge/discharge profiles of the two cathodes (FIG. 8C and FIG. 11). Consistent with the charge/discharge profiles, the Mg/Ti-LNO displayed smoother curves and fewer peaks than the LNO. After 50 cycles, negligible changes (neither the intensity nor the peak position) were observed in the dQ/dV vs. voltage curve of the Mg/Ti-LNO (FIG. 8C). However, the rapid fading around 3.6 V and 4.1 V was observed in the LNO (FIG. 11), which were associated with the H1→M and H2→H3 phase transformations, respectively. The cyclic voltammetry (CV) results for these cathodes were consistent with the dQ/dV evolution (FIGS. 12A-12B). In addition, the rate capability of the Mg/Ti-LNO cathode was much better than that of the LiNiO₂ (the 2 C capacity maintained 76% of the C/10 capacity in the Mg/Ti-LNO cathode, FIG. 8D and FIG. 13). At C/5, C/2 and 1C, the initial discharge capacity was 200, 180 and 175 mAh/g, respectively (FIG. 8E). The capacity retention after 150 cycles at C/5 and C/2 was 86% and 90%, respectively. Furthermore, 85% capacity retention was achieved at 1C for 300 cycles. The material-level specific energy was ˜800 Wh/kg at C/10 and C/5, and ˜700 Wh/kg at C/2 and 1C (FIG. 8F), which were higher than many reported Ni-rich NMC cathodes. The energy retention was 96%, 88%, 85%, and 77% at C/10, C/5, C/2 and 1C after their corresponding numbers of cycles, respectively (FIG. 8F). The performance at elevated temperatures is an important metrics for practical batteries. Here half cells containing the LNO and Mg/Ti-LNO cathodes were tested at 60° C. The capacity retentions at C/3 were 67% and 78% after 50 cycles for the LiNiO₂ and Mg/Ti-LNO cathodes, respectively (FIGS. 14A-14B). The electrochemical performance of the Co-free Mg/Ti-LNO surpassed many reported LiNiO₂-based materials. Finally, full cells were assembled using graphite as the anode (FIG. 15 and FIGS. 16A-16B). The full cells delivered a 200 mAh/g discharge capacity at C/2 with an 82% capacity retention after 100 cycles at 22° C.

C. Synchrotron X-Ray Fluorescence Microscopy (XFM) and Electrochemical Impedance Spectroscopy (EIS)

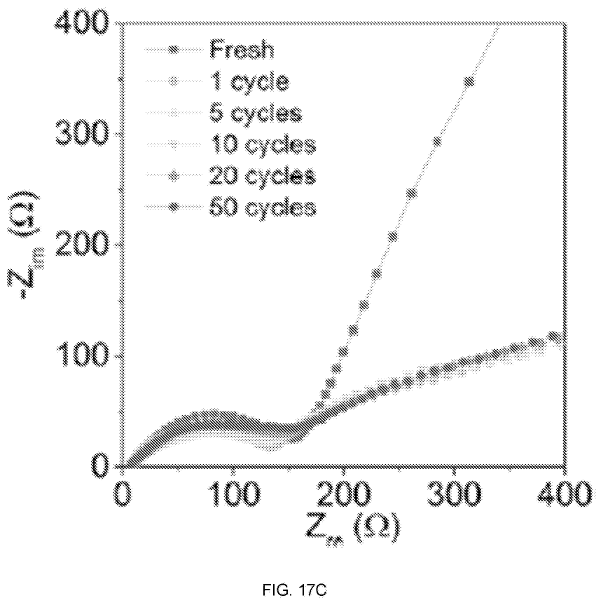

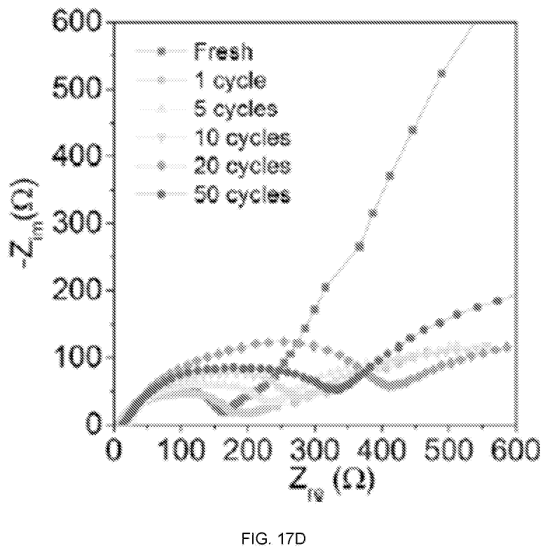

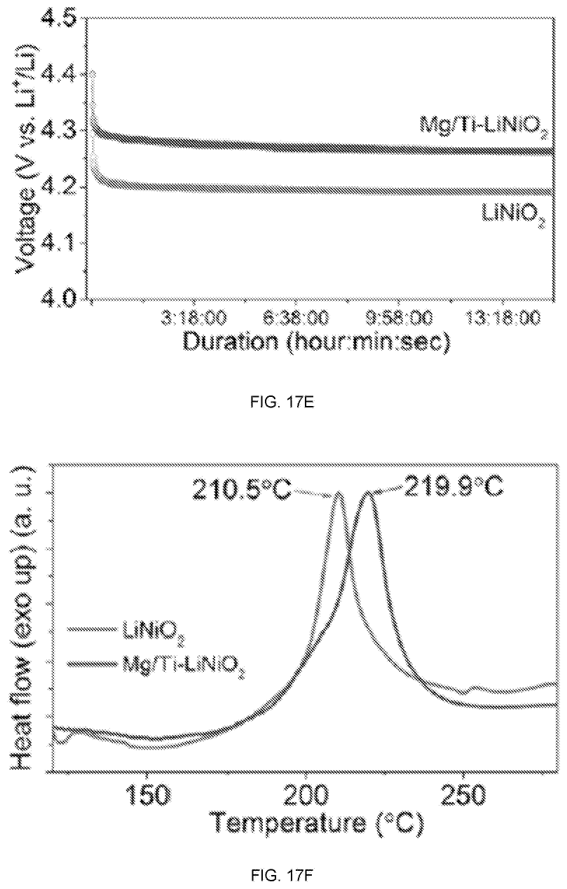

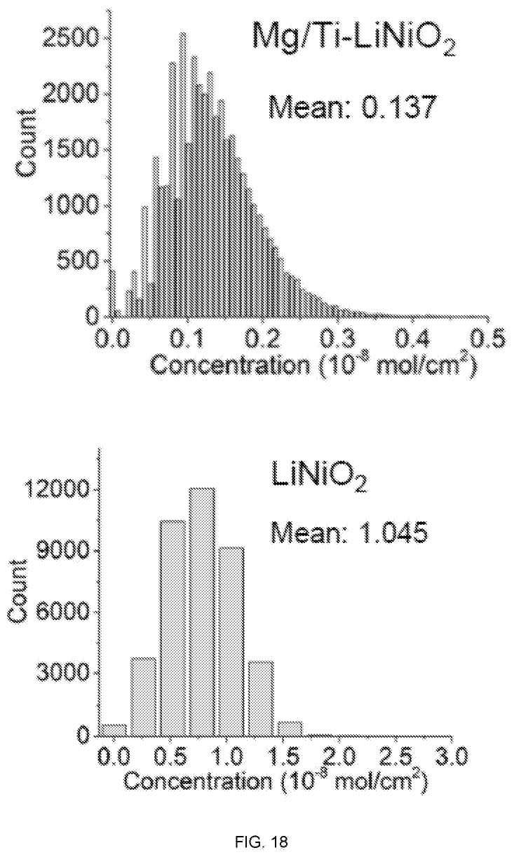

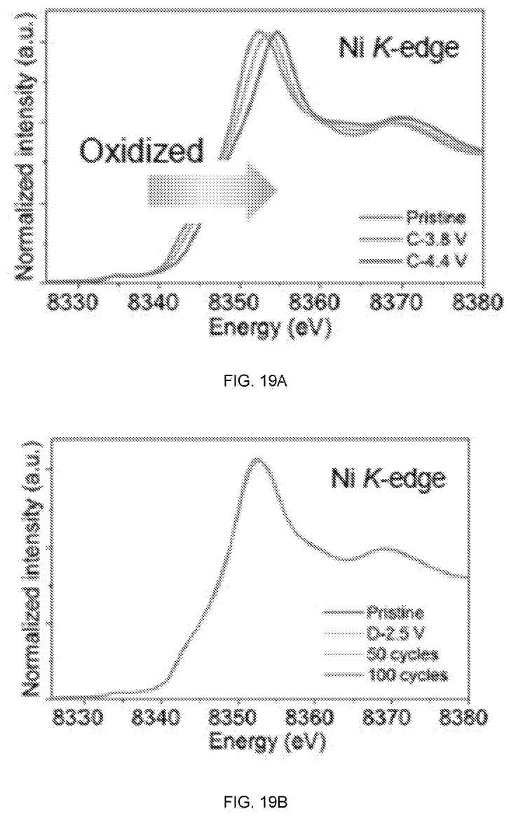

The dual dopants also enhanced the surface stability, minimized the Ni dissolution, and improved the thermal stability, and increase the self-discharge resistance of the Co-free LiNiO₂-derived material. Synchrotron X-ray fluorescence microscopy (XFM), a highly sensitive technique for quantitative (sub ppm) and spatially resolved analysis of trace elements, was performed on the lithium anode after 50 cycles at C/3 (FIGS. 17A-17B and FIG. 18). Overall, the lithium anode collected from the Mg/Ti-LNO cell showed nearly 10 times lower Ni concentration than that collected from the LNO cell. In addition, the Ni distribution was also more uniform in the former sample. The electrochemical impedance spectroscopy (EIS) of the cells at various states was also measured (FIGS. 17C-17D). The interfacial resistance (high frequency, semicircle on the left) was ˜150Ω in both cells in the pristine state. For the Mg/Ti-LNO cell, the resistance remained relatively stable during cycling. However, the resistance gradually increased up to 20 cycles and decreased slightly after 50 cycles in the LNO cell. The similar phenomenon was also observed for the resistance originated from the charge transfer process (low frequency, semicircle on the right). Results are presented in Table 2 below:

TABLE 2
Summary of the Fitted Parameters for the
Nyquist Plots in FIGS. 17c-d

| | Mg/Ti-LNO | | | LNO | | |
|---|---|---|---|---|---|---|
| Sample | Rₑ | Rᵢ | R_{ct} | Rₑ | Rᵢ | R_{ct} |
| Fresh | 10.4 | 145.2 | 7499 | 13.01 | 153.2 | NA |
| 1 cycle | 3.7 | 123.9 | 336.7 | 4.7 | 182.8 | 127.9 |
| 5 cycles | 4.0 | 133.4 | 329.7 | 16.9 | 208.5 | 410 |
| 10 cycles | 5.9 | 139.2 | 335.8 | 11.51 | 265.3 | 371.8 |
| 20 cycles | 7.8 | 147.8 | 338.9 | 13.3 | 417.8 | 312.6 |
| 50 cycles | 6.7 | 140.5 | 477.7 | 13.3 | 303.4 | 918.4 |

Where Rₑ, Rᵢ, and R_{ct} represent the ohm resistance and the resistance from the interface and charge transfer, respectively. The fitting was performed using ZView software based on the equivalent circuit.

These results indicated that the Mg/Ti dual dopants improved the stability of the cathode-electrolyte interface, which might be one of the key factors responsible for the improved cycling performance. The self-discharge resistance and thermal stability were also improved with the Mg/Ti dual dopants. The cells were charged to 4.4 V and rested for 14 hours to reach the equilibrium state (FIG. 17E). During the initial resting, the voltage decreased dramatically to 4.3 and 4.2 V for the Mg/Ti-LNO and LNO cathodes, respectively. Overall, the Mg/Ti-LNO exhibited stronger self-discharge resistance. The exothermic peak in the differential scanning calorimetry (DSC) analysis represents the thermal stability of a cathode in the charged state (in this case, charged to 4.4 V). The Mg/Ti-LNO cathode showed higher thermal stability with an exothermic temperature of 219.9° C. as opposed to 210° C. in the LNO cathode (FIG. 17F).

D. Charge Compensation Mechanism and Local and Global Structural Stability

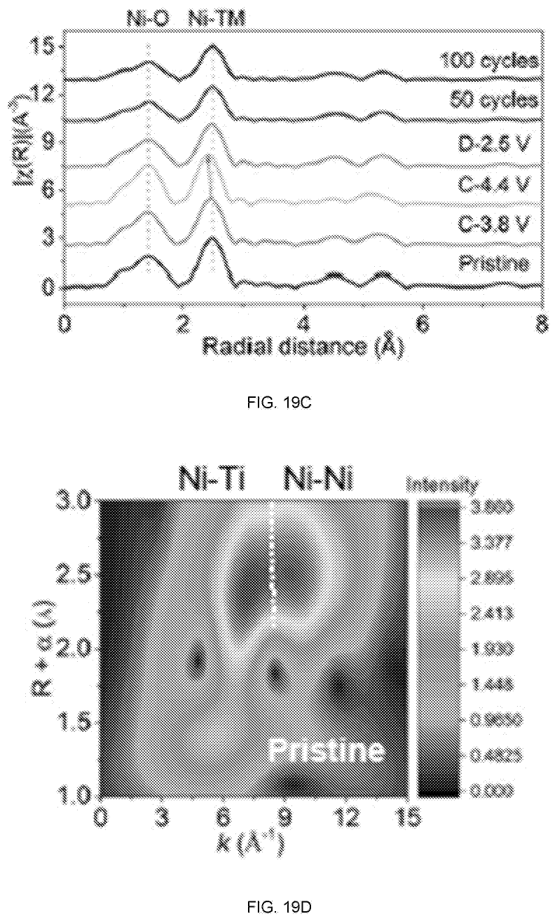

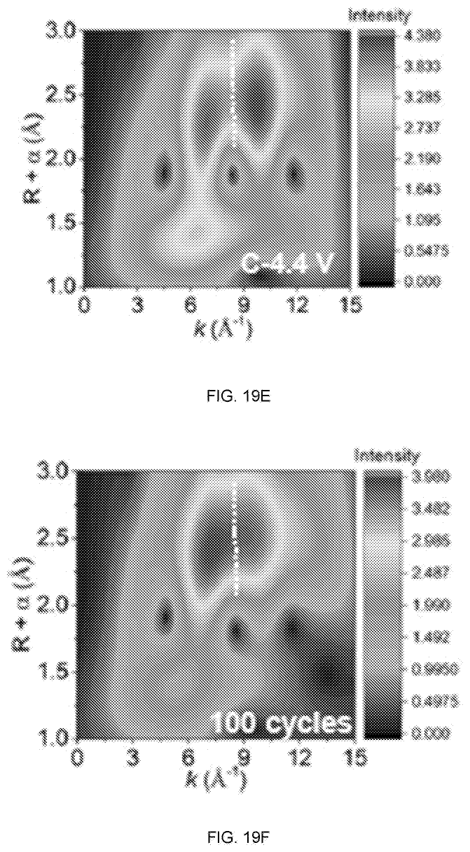

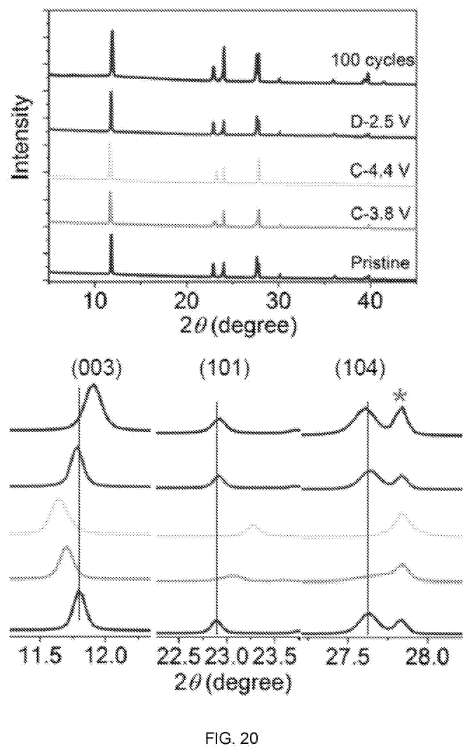

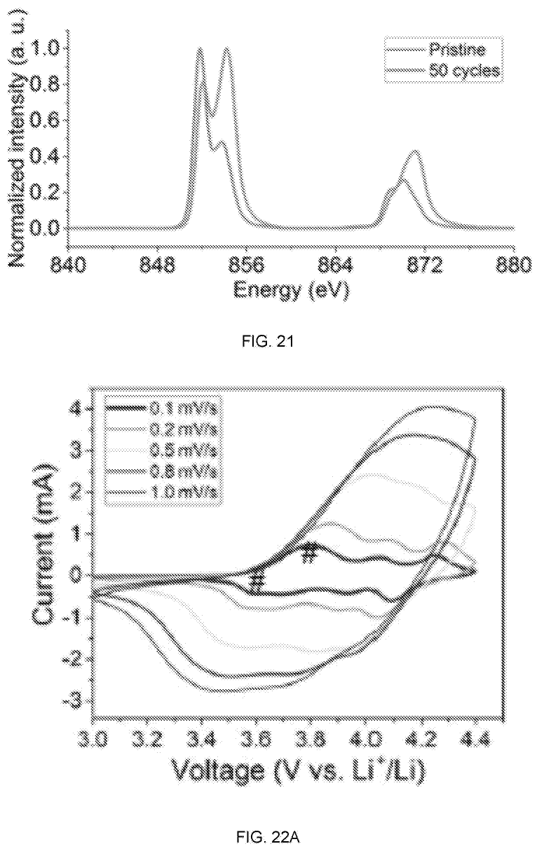

The charge compensation mechanism, and local and global structural stability of the Mg/Ti-LNO cathode were studied using a suite of advanced synchrotron X-ray and electron diagnostics, including synchrotron XRD, hard and soft XAS, extended X-ray absorption fine structure (EXAFS), wavelet transform analysis, and electron microscopy. Upon charging, the Ni K-edge shifted to higher energy, indicating the oxidization of Ni³⁺ to partially Ni⁴⁺ (FIG. 19A). Upon discharging (FIG. 19B), the edge shifted back to the original state. After 50 and 100 cycles, there was negligible change of the Ni oxidation state, indicating the good reversibility of the Ni³⁺/Ni⁴⁺ redox couple. The EXAFS analysis showed two Ni local environments, i.e., Ni—O at 1.7 Å and Ni-TM at 2.5 Å(FIG. 19C). Upon charging, the Ni-TM distance reduced slightly while the Ni—O bonding underwent negligible change. In the discharged state after 1, 50, 100 cycles, the Ni—O and Ni-TM distances did not change, implying the structural stability of the local environment. The EXAFS wavelet transform analysis, a powerful method for distinguishing the backscattering atoms, was performed to analyze the Ni local environment (FIGS. 19D-19F). In the pristine state (FIG. 19D), the bonding at 2.5 A (“R+α”) split into two in the k space, which were associated with the Ni—Ni (right) and Ni—Ti (left). The wavelet transform analysis further supported our conclusion that the Ti dopant occupies the Ni site in the R3̅m lattice. The splitting became wider in the charged state (4.4 V, FIG. 19E) and recovered to the original state after 100 cycles (FIG. 19F), demonstrating the stability and reversibility of the local chemical environment. Meanwhile, XRD was conducted to elucidate the global structural stability (FIG. 20). Upon charging, the (003) peak shifted to the lower angle while the (104) peak moved to the higher angle, suggesting the expansion of the Li—O and the contraction of Ni—O and Ni-TM. Upon discharging, these peaks went through the opposite shifting and recovered to its original state. After 100 cycles at C/3, the layered structure maintained well in spite of the slightly off-set of the (003) peak. The peak shift was associated with the minor capacity loss due to the lithium irreversibility (i.e., Li loss from the lattice). Indeed, the soft XAS results illustrated that the surface Li loss was accompanied by the surface Ni reduction after long cycles (FIG. 21). Although the Mg/Ti dual dopants did not completely eliminate the surface degradation, they significantly enhanced local structural stability, alleviated the Ni dissolution, and improved the thermal stability of the LNO material.

E. Kinetic Performance of Cathode

The following mathematical relationship was used to perform diffusion coefficient analysis:

$${I}_{P} = 0.4463 {n}^{3 / 2} {F}^{3 / 2} {C}_{L i} S {R}^{- 1 / 2} {T}^{- 1 / 2} {\tilde{D}}_{L i}^{1 / 2} {v}^{1 / 2}$$

where n is molar quantity; F, R and C_{Na} are Faraday constant, gas constant and molar volume density of Li; S is active surface area of the electrode; T is temperature; and v is scan rate. The 3.75/3.5 V redox couple was chosen to calculate the diffusion coefficient. On the scale, the slope of the straight line represents 0.4463 n^{3/2}F^{3/2}C_{Li}SR^{-1/2}T^{-1/2}\tilde{D}_{Li}^{1/2}. According to the value of slope the apparent Li⁺ diffusion coefficient can be estimated.

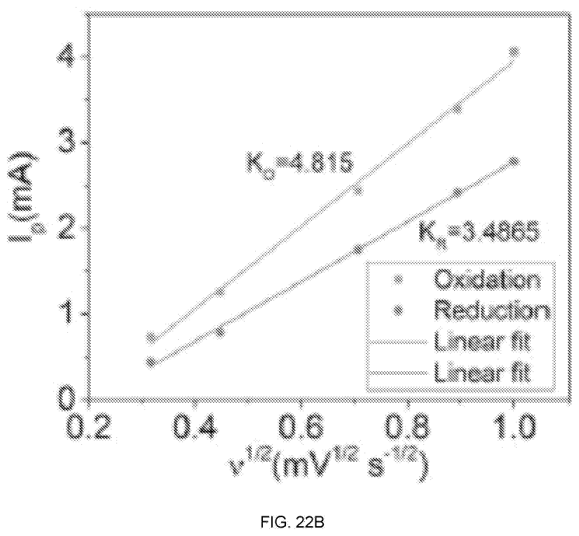

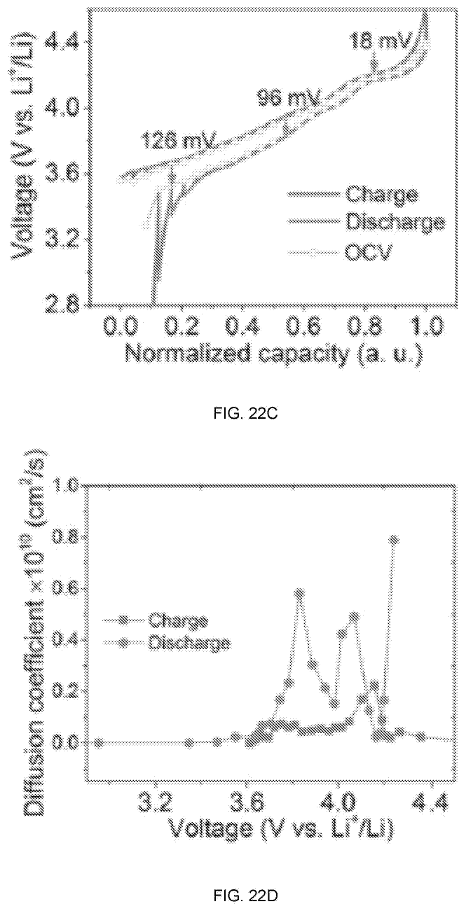

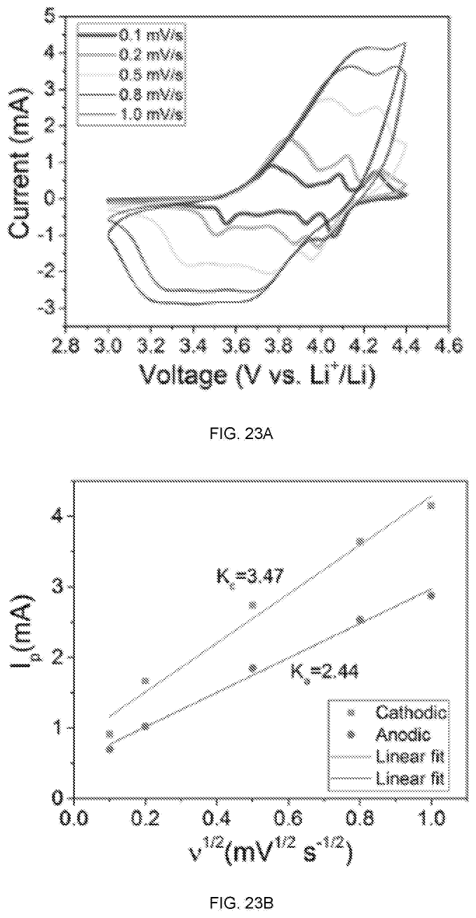

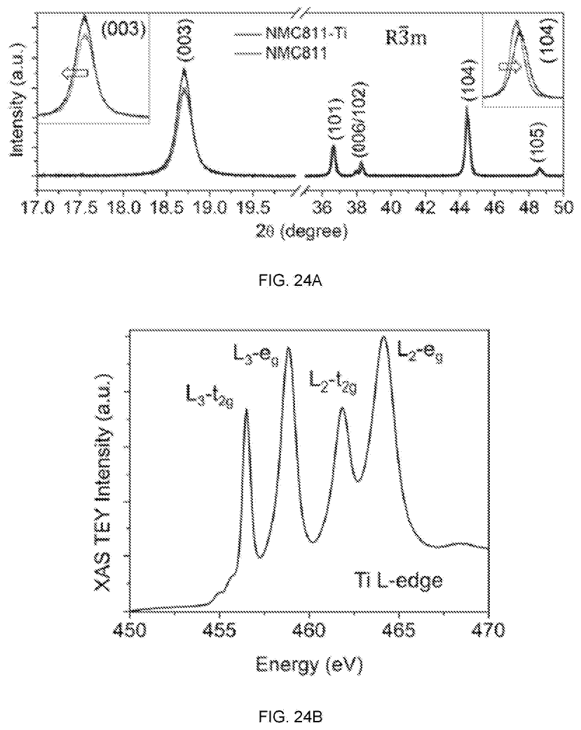

The kinetic performance of the Co-free cathode was investigated by cyclic voltammetry (CV) at different scanning rates and GITT. At 0.1 mV/s, there were three typical redox couples within 3.5-4.3 V (FIG. 22A). The anodic and cathodic currents gradually increased as the scan rate increased. Meanwhile, the redox peaks began to merge at high scan rates. The cathodic peaks moved to lower voltages while the anodic peaks moved to higher voltages, due to the larger polarization at high rates. The redox couple at 3.5/3.75 V was utilized to calculate the Li⁺ apparent chemical diffusion coefficient during charging and discharging using the equation: Iₚ=0.4463 n^{3/2}F^{3/2}C_{Li}SR^{-1/2}T^{-1/2}\tilde{D}_{Li}^{1/2}v^{1/2}. The linear relationship between the current and the square root of scan rate (FIG. 22B) implies that the diffusion-controlled process during the electrochemical process. From the linear fitting, a Li⁺ diffusion coefficient on the order of 10⁻¹¹ cm²/s was obtained. In addition, the OCV were obtained from the GITT curves (FIG. 22C and FIG. 9). The hysteresis decreased as the voltage increased (i.e., increased degree of delithiation), indicating that the reaction kinetics got improved as more lithium vacancies were created during charging. Specifically, the polarization at 3.6 V was 126 mV, which was larger than those at 4.0 and 4.2 V. The equation

$$\tilde{D} = \frac{4}{πτ} {( \frac{{m}_{B} {V}_{M}}{{M}_{B} S} )}^{2} {( \frac{Δ {E}_{S}}{Δ {E}_{τ}} )}^{2}$$

was used to calculate the Li⁺ diffusion coefficient at various states of charge (FIG. 22D). In general, the discharging kinetics was better than the charging kinetics. The D_{Li} was in the order of 10⁻¹⁰ to 10⁻¹¹ cm²/s, which agreed with the CV results. The Li⁺ diffusion within 4.3-3.7 V during discharging was better than other states, except two sudden drops at 4.0 and 4.2 V. These two drops were associated with the M→H2 and H2→H3 phase transformations, respectively. The same method to determine the Li⁺ diffusion coefficient was applied on the LiNiO₂ (FIGS. 23A-23B). The Mg/Ti dual dopants did not alter much the Li⁺ diffusion coefficient. Therefore, the improved battery performance after the Mg/Ti dual doping mostly originated from the stability upon long-term cycling rather than the initial Li⁺ diffusion characteristics.

### Example 6. Electrochemical Impacts of Mg/Mn Dual Dopants on the LiNiO₂ Cathode in Li Metal Batteries

By utilizing the doping chemistry, we evaluate the battery performance and structural/chemical reversibility of a new no-cobalt cathode material (Mg/Mn—LiNiO₂). The unique dual dopants drive Mg and Mn to occupy the Li site and Ni site, respectively. The Mg/Mn—LiNiO₂ cathode delivers smooth voltage profiles, enhanced structural stability, elevated self-discharge resistance, and inhibited nickel dissolution. As a result, the Mg/Mn—LiNiO₂ cathode enables improved cycling stability in lithium metal batteries with the conventional carbonate electrolyte: 80% capacity retention after 350 cycles at C/3, and 67% capacity retention after 500 cycles at 2 C (22° C.). We then take the Mg/Mn—LiNiO₂ as the platform to investigate the local structural and chemical reversibility, where we identify that the irreversibility takes place starting from the very first cycle. The highly reactive surface induces the surface oxygen loss, metal reduction reaching the subsurface, and metal dissolution. Our data demonstrate that the dual dopants can, to some degree, mitigate the irreversibility and improve the cycling stability of LiNiO₂.

Experimental Details

Material synthesis: The metal hydroxide precursor of no-cobalt Mg/Mn—LiNiO₂ cathode material was synthesized through a co-precipitation method, using the precursors of MgSO₄.7H₂O (Sigma-Aldrich, 98%), MnSO₄.4H₂O (Sigma-Aldrich, 99%), and NiSO₄.6H₂O (Sigma-Aldrich, 99%). The synthesis protocol was the same as the study we reported previously.¹¹ The Mg/Mn—LiNiO₂ were synthesized through a co-precipitation method followed by the high temperature calcination. We first prepared the transition metal solution (0.096 mol NiSO₄-6H₂O, 0.002 mol MgSO₄ and 0.002 mol MnSO₄ dissolved in 100 mL of aqueous solution), the starting solution (40 mL of NaOH and NH₃.H₂O aqueous solution with a molar ratio NaOH/NH₃=1.2, pH value was adjusted to 11.0), and the base solution (100 mL of NaOH and NH₃.H₂O aqueous solution with a molar ratio NaOH/NH₃=1.2). The transition metal solution and base solution were simultaneously pumped into the starting solution at a feed rate of ˜2 mL/min with continuous stirring at 55° C. under N₂ protection. The feed rate of the base solution was frequently tuned to keep the pH at 11.0±0.2. The precipitate was collected, washed, and filtered with deionized water and dried in a vacuum oven overnight at 105° C. We then thoroughly mixed the dried precursor with LiOH and calcined it under oxygen flow (1 L/min) at 460° C. for 2 h and then at 700° C. for 6 h to obtain the final Mg/Mn—LiNiO₂ powder.

Electrochemical characterization: The active material of 90% (no-cobalt Mg/Mn—LiNiO₂), carbon black of 5%, and 5% PVdF (Polyvinylidene fluoride) dissolved in NMP were thoroughly mixed to form a slurry. The slurry was cast on to carbon-coated Al foils by a doctor blade. The electrode was then punched into disks (diameter=10 mm) and dried in a vacuum oven at 120° C. overnight and transferred into an Ar filled glove box. The CR2032 coin cells were assembled using the Co-free Mg/Mn—LiNiO₂ as the cathode, lithium metal as the anode, 1.0 M LiPF₆ dissolved in EC and EMC (3:7 in weight plus 2% VC as the additive) as the electrolyte, and the Whatman glass fiber as the separator. The coin cells were evaluated on a Wuhan LANHE battery testing system. The cyclic voltammetry was performed on a Princeton Applied Research VersaSTAT 4.

Characterization: Soft X-ray absorption spectroscopy (XAS) measurements were performed on the 31-pole wiggler beamline 10-1 at Stanford Synchrotron Radiation Lightsource (SSRL). Hard XAS results were performed at the Advanced Photon Source (APS) Beamline 20-ID, Argonne National Laboratory. Neutron diffraction (ND) was conducted using the ECHIDNA high-resolution powder diffractometer (Australian Nuclear Science and Technology Organization). X-ray fluorescence mapping (XFM) were performed at the microprobe hard X-ray 2-ID-D beamline at the APS. The details of the neutron diffraction, hard XAS, soft XAS, and XFM characterizations can be found in our previous report.¹¹

### RESULTS AND DISCUSSION

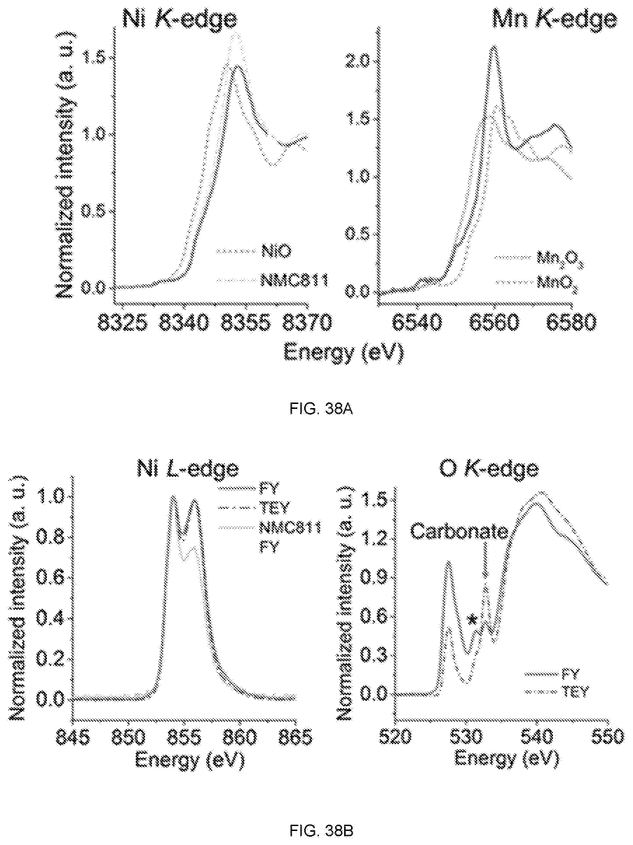

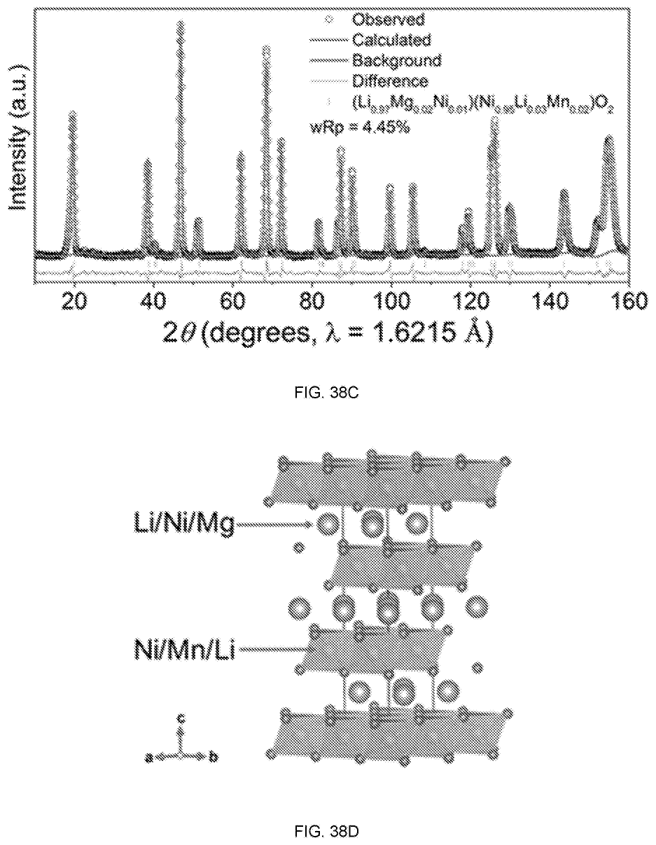

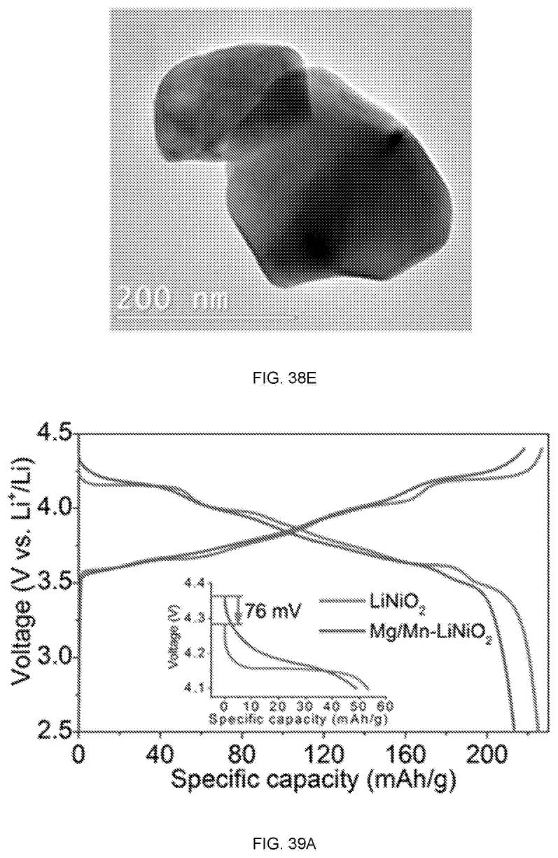

Due to the slow kinetics of Ti diffusion in the LiNiO₂ or LiCoO₂ materials during high-temperature calcination, even a small amount of Ti dopant (1-3 at. %) can trigger the Ti-enrichment at the primary particle surfaces.^{11, 18, 21} In contrast, it is reasonable to believe that Mg homogeneously distributed in the primary particles according to our previous study.¹¹ The Mn dopant distribution still needs more investigation. However, it should be noted that Mn and Ni are usually homogeneous throughout LiNiₓCo_{y}Mn_{1-x-y}O₂ particles in the co-precipitation-based synthesis. To study the dual-doping chemistry and understand their roles in the LiNiO₂ based materials, we further investigated the Mg/Mn—LiNiO₂ material in this study. This new composition will allow us to investigate the differences between Mn and Ti dopants, although both of them can have 4+ oxidation state. The ICP-MS (inductively coupled plasma mass spectrometry) showed the relative concentration of Mg, Mn, and Ni was 2.05, 2.09, and 95.8%, respectively. To pinpoint the site occupancies, we performed electronic and structural characterization. Similar to the Mg/Ti—LiNiO₂,¹¹ the Ni oxidation state was close to Ni³⁺, suggested by hard (FIG. 38A) and soft (FIG. 38B) X-ray absorption spectroscopy (XAS). According to the charge neutralization rule, Mg²⁺ sitting at Ni³⁺ sites would generate Mn⁴⁺ occupying Ni³⁺ site. However, comparing with the Mn³⁺ and Mn⁴⁺ references, we found that the oxidation state of Mn in the Mg/Mn—LiNiO₂ was in the range of +3 to +4 (FIG. 38A). This unusual presence of reduced Mn motivated us to further investigate the site occupancies using neutron diffraction. Combining with the Rietveld refinement of the neutron diffraction, we determined the occupancies of Mg, Mn, and Ni (FIG. 38C and Table 3), indicating that the Mg sits at the Li site while the Mn sits at the Ni site (FIG. 38D). Meanwhile, there is only 1% Ni occupying the Li site in the Mg/Mn—LiNiO₂ material. Therefore, Mg occupying the Li site led to the Mn reduction and inhibited extent of the Ni occupying Li site, which makes the Mg/Mn—LiNiO₂ distinct from the previously reported Mg/Ti—LiNiO₂.¹¹ We also studied the surface chemistry of the pristine material. The same Ni oxidation state revealed by the FY and TEY modes should indicate the same TM3d-O2p hybridization features in the O K-edge. However, the presence of surface carbonate species in the Mg/Mn—LiNiO₂ fresh powder (FIG. 38B) complicates the O K-edge and makes the TM3d-O2p hybridization analysis challenging in the present case.²⁸ The peak at ˜532 eV in the FY (fluorescence yield) mode was similar to the intrinsic characteristic of NiO,²⁸ which may be a result of Ni occupying the Li site. The final agglomeration was composed of primary particles ranging from 50 nm to 200 nm (FIG. 38E), similar to the Mg/Ti—LiNiO₂ material. The nanoparticles may facilitate undesired reactions because of the larger contact surface area with the electrolyte, which will allow us to study the accelerated degradation behavior of this material within a reasonable time frame.

TABLE 3
Structural parameters of the Mg/Mn-LiNiO₂ cathode material
determined by the Rietveld refinement of neutron diffraction data.
R3̅m, a (Å) = 2.87649(3), c (Å) = 14.2012(3),
V (Å³) = 101.761(3), _{W}R_{P} = 4.45%

| Atom | Position | Wyck. site | Occp. | | 100*U_{iSo} (Å²) | |
|---|---|---|---|---|---|---|
| Li | 0, 0, 0.5 | 3a | 0.970 | (2) | 1.5 | (1) |
| Ni | 0, 0, 0.5 | 3a | 0.010 | (2) | 1.5 | (1) |
| Mg | 0, 0, 0.5 | 3a | 0.02 | | 1.5 | (1) |
| Ni | 0, 0, 0 | 3b | 0.950 | (2) | 0.31 | (2) |
| Li | 0, 0, 0 | 3b | 0.030 | (2) | 0.31 | (2) |

| | | | | | |
|---|---|---|---|---|---|
| Mn | 0, 0, 0 | 3b | 0.02 | 0.31 | (2) |
| O | 0.25867(7) | 6c | 1 | 0.80 | (3) |

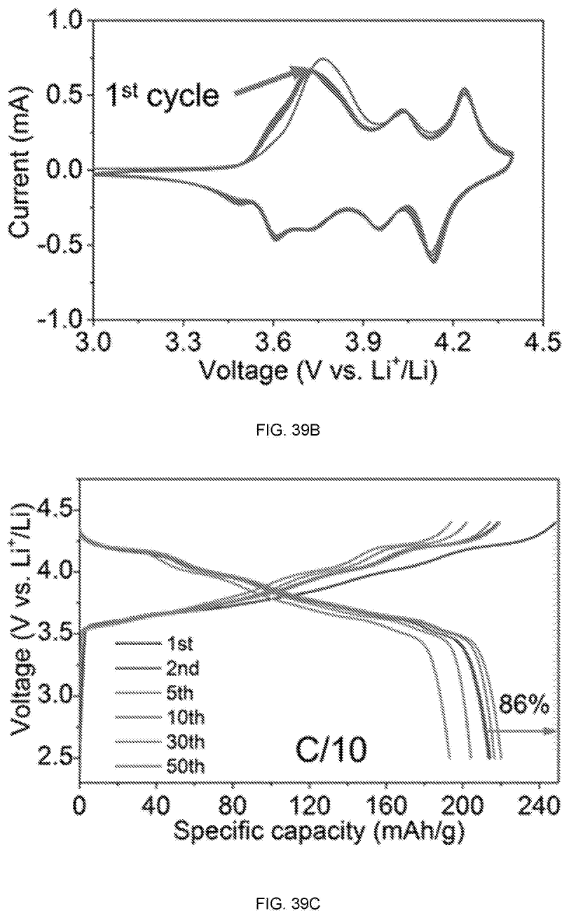

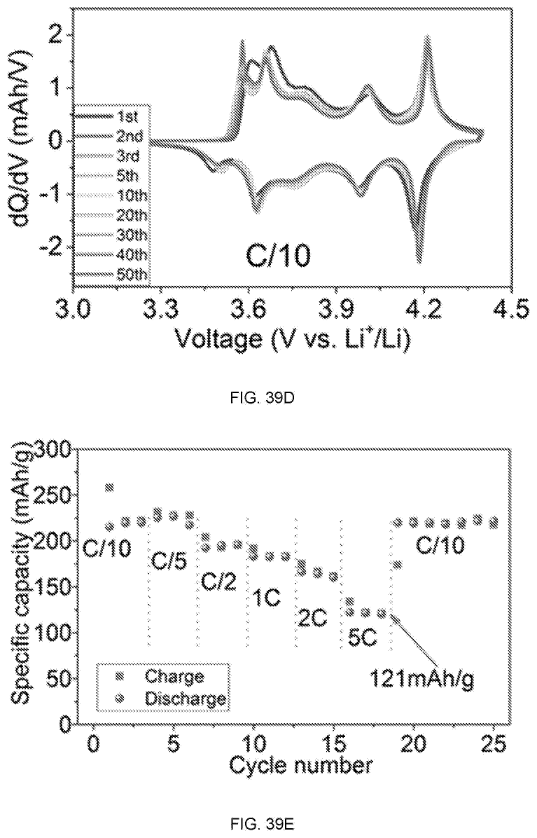

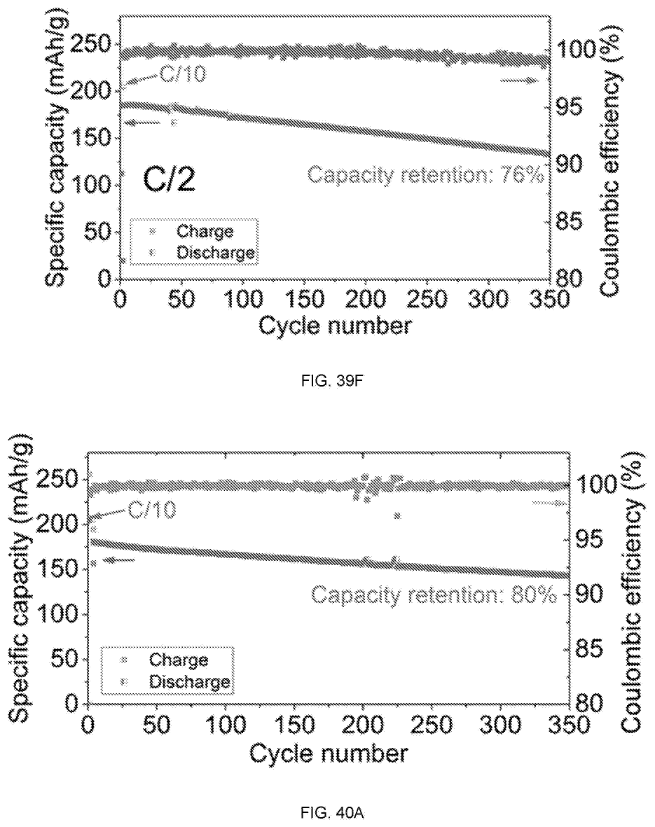

The electrochemical performance of the cells composed of the no-cobalt Mg/Mn—LiNiO₂ cathode and lithium metal anode was evaluated. The low concentrations of Mg/Mn dopants can effectively smoothen the charge/discharge profiles (FIG. 39A).¹¹ The mechanism is still unclear in regard to why most foreign elements play an effective role in destabilizing the Li⁺/vacancy ordered configuration, resulting in sloping/smooth voltage profiles.^{6, 17, 29} In addition, the starting discharge voltage of the Mg/Mn—LiNiO₂ cathode was at ˜4.36 V, which was 76 mV higher than that of the LiNiO₂, indicating that the Mg/Mn dual dopants can mitigate the high-voltage hysteresis (FIG. 39A). At a scan rate of 0.1 mV/s, there were three typical oxidation peaks upon charging and three main reduction peaks upon discharging in the cyclic voltammetry (CV) curves. The CV features were highly overlapped in the first 5 cycles (FIG. 39B). Note that the difference between the first cycle and the subsequent cycles (around 3.8 V) might be associated with the carbonate decomposition upon the initial charging (FIG. 39B).³⁰⁻³² This may also be partially responsible for the low Coulombic efficiency (86%) in the first cycle at C/10 (FIG. 39C). The initial reversible capacity reached 216 mA h/g at C/10. The discharge capacity slightly increased in the first ten cycles, followed by slow decay, resulting in a 90% capacity retention after 50 cycles (FIG. 39C). The dQ/dV versus voltage was plotted within 2.5-4.4 V at C/10 (FIG. 39D). Compared with the LiNiO₂ (in the Ref.¹¹), the intensity of the main peaks was lower, particularly within 4.1-4.3 V, because of the less Li⁺/vacancy ordering in the Mg/Mn—LiNiO₂ cathode. Furthermore, these oxidation/reduction peaks well overlapped from the first cycle to the 50^{th} cycle, demonstrating the enhanced structural reversibility of the Mg/Mn—LiNiO₂ cathode.³³⁻³⁴ The Mg/Mn—LiNiO₂ cathode also had reasonably good rate capability. The discharge capacities at C/10, C/5, C/2, 1C, 2C, and 5C were 220, 225, 190, 180, 160, and 121 mA h/g, respectively (FIG. 39E). The slightly higher capacity at C/5 than that at C/10 was likely caused by the activation during the initial C/10 cycles. At C/2, the cell provided an initial discharge capacity of 185 mAh/g, with a 76% capacity retention after 350 cycles (FIG. 39F).

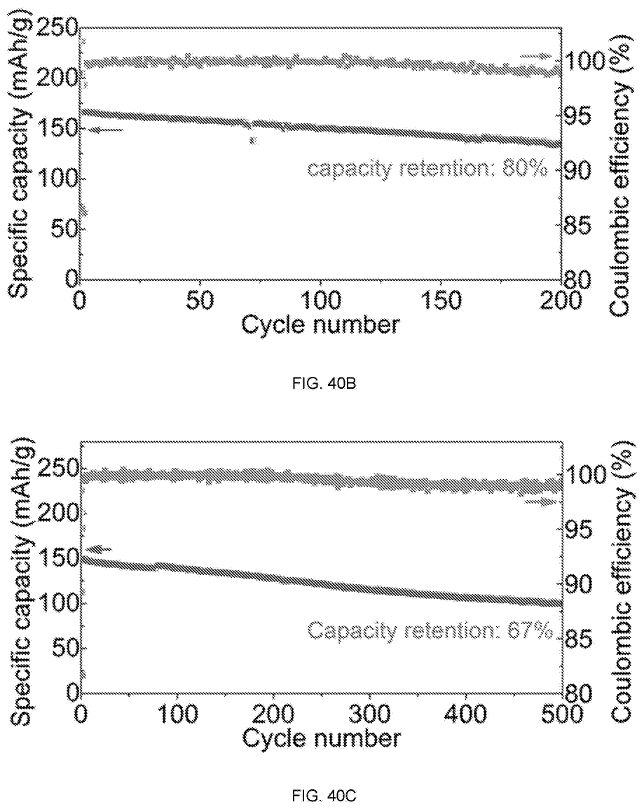

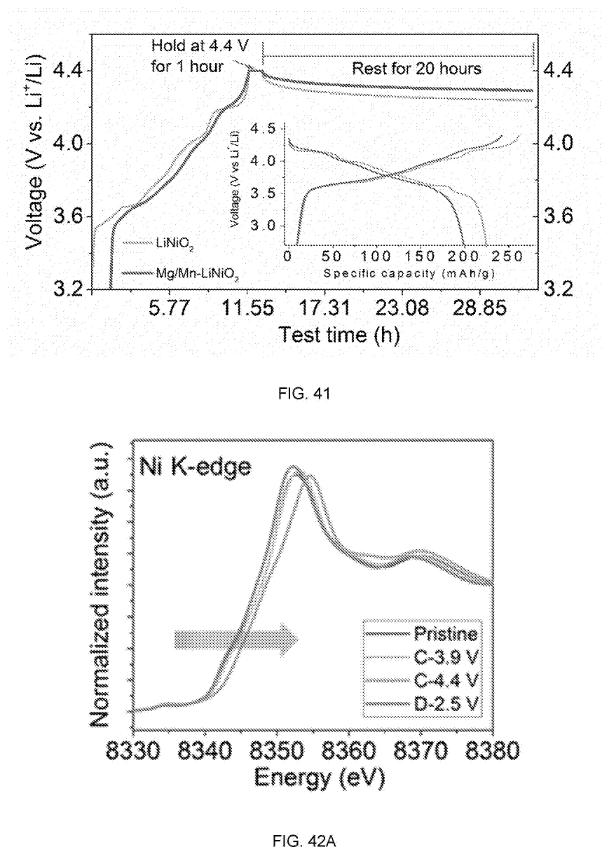

To further demonstrate the promise of the no-cobalt Mg/Mn—LiNiO₂ cathode, we manufactured cells with an elevated cathode mass loading around 9 mg/cm² (FIGS. 40A-40C). With the thicker electrode, the initial discharge capacity was 200, 180, 160, and 150 mA h/g at C/10, C/3, 1C, and 2C, respectively. These thicker electrodes also delivered good capacity retention: 80% at C/3 after 350 cycles, 80% at 1C after 200 cycles, and 67% retention at 2C after 500 cycles. Note that the capacity retentions at high C-rates (1C and 2C) are lower than that at the low C-rate. It is likely that the higher C-rates amplified the charge heterogeneity and mechanical breakdown, thus inducing larger polarization in the relatively high-mass-loading electrodes.³⁵⁻³⁸ We believe that this long-term cycling performance has been rarely reported for LiNiO₂ based cathode materials using the conventional electrolyte and lithium metal. Our data seems to tell that the Mg/Mn—LiNiO₂ cathode could be promising for further practical investigation. We also evaluated the self-discharge property of the Li metal cells containing the no-cobalt LiNiO₂ and Mg/Mn—LiNiO₂ cathodes (FIG. 41). Within the initial four hours, the potential dropped quickly for both cells and then reached a relatively steady state for 20 hours. In general, the self-discharge resistance of the cell containing the Mg/Mn—LiNiO₂ cathode was higher than that of the cell containing the LiNiO₂ cathode, indicated by the stabilized potential at 4.29 V for the former and 4.24 V for the latter. Collectively, the above results suggest that the Mg/Mn dual dopants play a positive role in stabilizing the electrochemical performance.

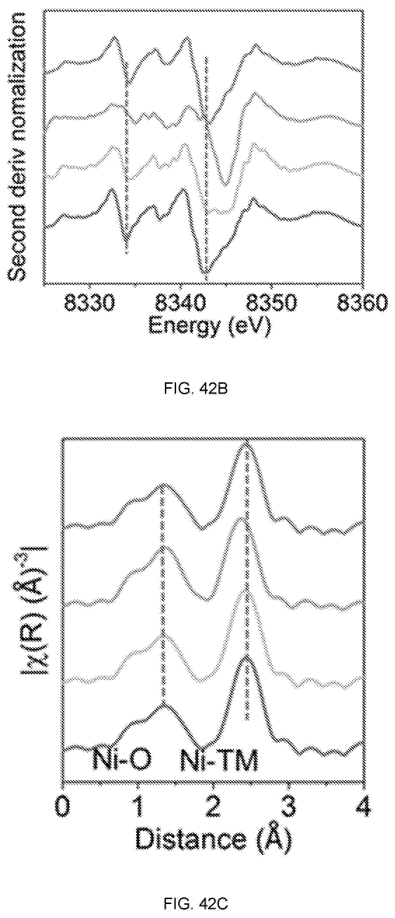

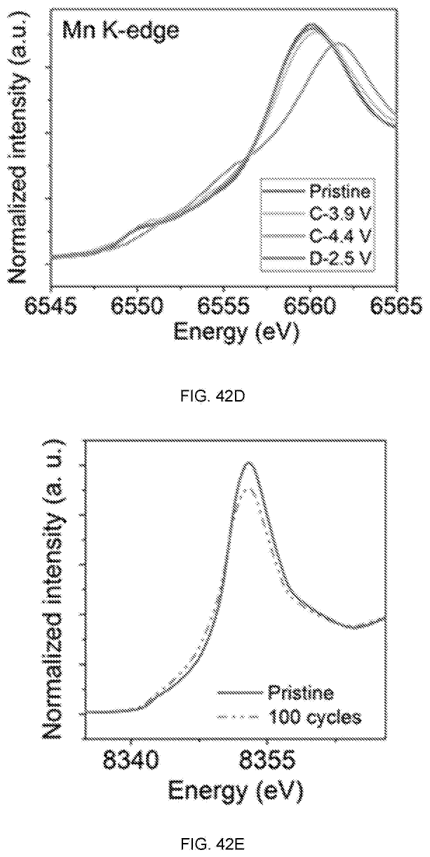

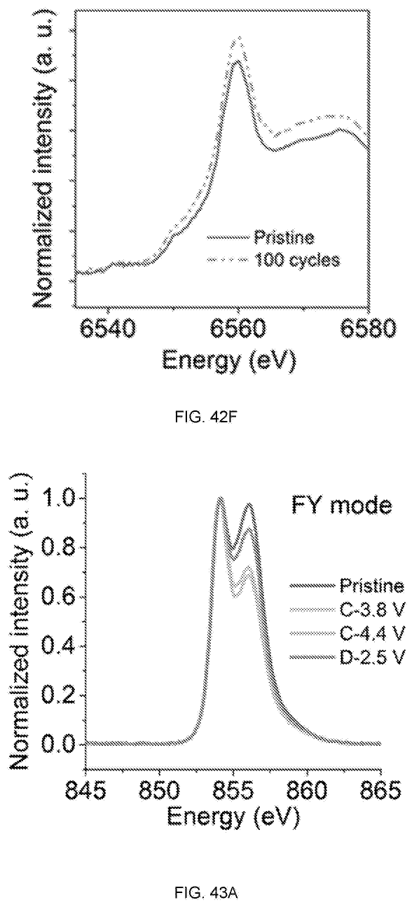

Given that the Mg/Mn—LiNiO₂ cathode can improve the performance in the lithium metal batteries, we also investigated the cationic charge compensation and degradation mechanisms using synchrotron spectroscopic (ex-situ soft and hard XAS) analysis. We also aimed to use the Mg/Mn—LiNiO₂ cathode as the platform to identify the challenges that may be widely applicable to the LiNiO₂ family. Through investigating whether the charge compensation is reversible, we will be able to identify the reversibility of the electronic structure and local chemical environment. It is reasonable to contribute the active redox couple to nickel because of its dominance in the formula (96 at. %). Similar to other studies,^{9, 11} the Ni K-edge XAS shifted to high energy upon charging and moved back upon discharging (FIG. 42A). In the second derivative analysis of the XANES spectra (FIG. 42B), two peaks associated with the pre-edge (8334 eV) and edge position (8343 eV) shift to right in the charged 4.4 V (labeled by the dash lines), which further supports the Ni redox activity. We noticed the irreversibility of the Ni electronic structure and local environment in the first cycle. The peaks in the discharged 2.5 V were slightly shifted to the right compared with the pristine one (FIG. 42B). The local environmental change of Ni (Ni—O and Ni-TM) was similar to the XANES, although not as significant (FIG. 42C). These results uncovered the oxidation state and local environment irreversibility of nickel in the first cycle, which can be associated with the irreversible cation mixing. Since the no-cobalt Mg/Mn—LiNiO₂ cathode contains 2 at. % Mn, we also studied the oxidation state and local environmental evolution of the Mn dopant upon electrochemical cycling. There was no change of the Mn XANES in the charged 3.9 V, but a significant right shift of the peak position (around 6560 eV) was observed at the charged 4.4 V (FIG. 42D), which might be associated with the oxidation process or local structural change. The XAS spectrum in the discharged 2.5 V nearly overlapped with that at the pristine state, which demonstrates the reversibility of the Mn oxidation state and local environment in the first cycle. This result is similar to our Ti doped LiNi_{0.8}Mn_{0.1}Co_{0.1}O₂ materials, where the dopant chemical environment is also reversible.¹⁸ We further observed the Ni and Mn reduction after 100 cycles in the discharged 2.5 V, as shown by the edges slightly shifting to lower energy in FIG. 42E-FIG. 42F. The Ni L-edge spectra after 60 cycles further confirmed the deeper reduction after long cycles (FIG. 45). Based on the above results, the Ni and Mn reduction are accompanied by the Ni migration (i.e., local structural change) starting from the initial cycle. These changes accumulated with cycling, resulting in performance degradation. We also noted that the changes characterized by the bulk sensitive hard XAS were minor, which led us to conjecture that the most changes could have taken place at the surface, accounting for only a small fraction of the material. Therefore, we turned to the surface and subsurface sensitive soft XAS for further investigation.

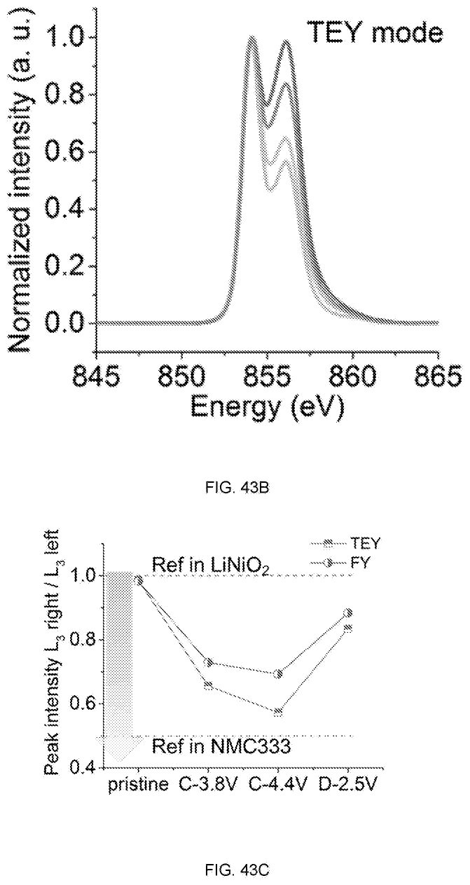

We then performed soft XAS to study the surface chemistry of the Mg/Mn—LiNiO₂ cathodes. The FY and TEY modes probe the depths of ˜50 nm (subsurface) and ˜10 nm (surface), respectively. In principle, upon charging, nickel should be oxidized to a high oxidation state that can be reflected by the significant intensity increase in the right shoulder (or dramatic intensity decrease in the left shoulder) of Ni L₃-edge.^{30, 39} However, the right shoulder in the Ni L₃-edge delivered much lower intensity at both charged and discharged states compared with the pristine state. This result suggests that Ni got reduced to lower oxidation states both at the subsurface (FIG. 43A) and surface (FIG. 43B). Then we plotted the intensity ratio between the right peak and the left peak as a function of the charged states (FIG. 43C). We observed, consistently, more Ni reduction at the surface than that in the subsurface, since the ratio in the TEY mode was systematically lower than that in the FY mode. Therefore, the result indicated that the metal reduction initiated from the surface. In other words, the Li/Ni cation mixing took place first at the surface and then propagated into the subsurface, which was consistent with the widely reported surface reconstruction phenomenon.⁴⁰ Another striking observation here is that the samples in the charged states (C-3.8 V and C-4.4 V) showed lower oxidation states than the pristine and discharged samples. This similar phenomenon of Mn was reported for some sodium layered cathodes.⁴¹⁻⁴² We conjecture that this might be related to the metal dissolution. It is likely that there was accumulation of reduced Ni at the surface in the charged state, then upon discharging, the surface reduced Ni got dissolved in the electrolyte, leaving behind Ni with high oxidation states. In our subsequent discussion, we will discuss the metal dissolution behavior.

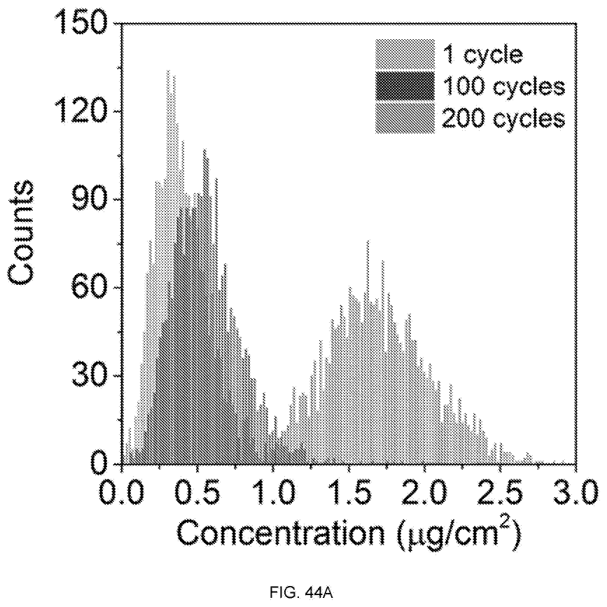

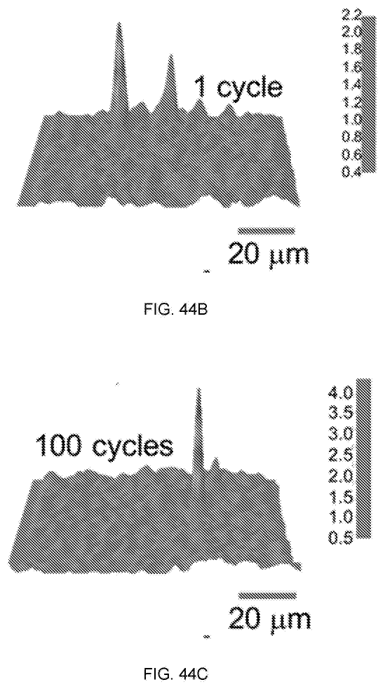

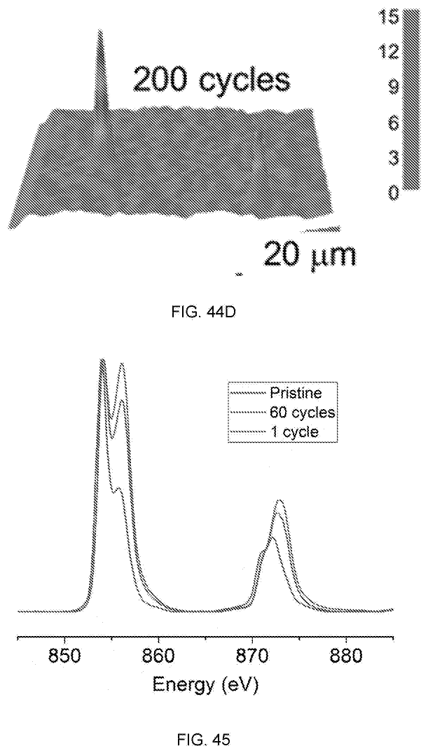

Nickel dissolution is one of the major challenges for the LiNiO₂ based materials.¹¹ Here we conducted X-ray fluorescence microscopy (XFM), a highly sensitive technique to quantitate trace elements at the sub-ppm level, on the lithium anode to analyze the Ni concentration (FIGS. 44A-44D). The range of the Ni concentration was 0-0.8, 0-1.3, and 0.8-2.6 μg/cm² for the anodes after 1 cycle, 100 cycles, and 200 cycles, respectively. Correspondingly, the mean value was 0.4, 0.56, and 1.66 μg/cm² (i.e., 6.8, 9.6, and 28.6 nmol/cm²) of the Ni element. Therefore, one can safely conclude that Ni dissolution took place at the very beginning and deposited on the anode, which is consistent with the aforementioned XAS analysis. Additionally, the Ni re-deposited concentration accumulated with electrochemical cycling, particularly with 100 to 200 cycles. It is noted that the Ni concentration after 100 cycles (9.6 nmol/cm²) in the present work was still lower than a previous study using the LiNiO₂ cathode after 50 cycles (10.45 nmol/cm²),¹¹ which suggests that the dual dopants play a positive role in suppressing nickel dissolution. We also noticed that the Ni distribution was homogenous except for several sporadic high-concentration regions (FIGS. 44B-44D). The origin of these high-concentration spots remains unclear at this point. Based on the deep metal reduction and dissolution, one can speculate that the surface oxygen release related materials instability is one of the major challenges for the LiNiO₂ based cathode materials.

### CONCLUSION

In summary, we applied Mg/Mn dual dopants in the LiNiO₂ cathode to improve the battery performance as well as to establish a platform to investigate the degradation mechanism. The unique dual dopants drive Mg and Mn to occupy the Li site and Ni site, respectively. The Mg/Mn—LiNiO₂ cathode delivered a reversible capacity of 216 mA h/g at C/10, with good rate capability and long-term cycling stability. Through electrochemical and synchrotron spectroscopic diagnostics, we found that, compared to LiNiO₂, the no-cobalt cathode showed improved structural reversibility, smoother voltage profiles, and mitigated nickel dissolution. While most doping studies avoided discussing the degradation of their doped LiNiO₂ materials, our chemical and structural analyses clearly showed that the chemical and structural irreversibility is still a significant challenge for the Mg/Mn LiNiO₂ cathode. Based on the present study and many LiNiO₂ studies in the literature, we highlight that although the doping chemistry has been found effective for low-Ni layered oxides, there is a large space to further improve the doping chemistry specifically for LiNiO₂, such as engineering the distribution of dopants in primary particles. Furthermore, the electrolyte modification is another key solution and it must be done in an inexpensive way, preferably based on the conventional carbonate electrolyte.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A cathode comprising an electrochemically active material having a crystalline structure characterized by the formula LiMO₂, wherein M represents a metal ion and wherein the electrochemically active material comprises at least one dopant;
wherein the electrochemically active material is substantially free of Co.

2. (canceled)

3. The cathode of claim 1, where M comprises NiₓMn_{y} where x+y is about 1.

4. (canceled)

5. The cathode of claim 1, wherein the at least one dopant comprises Al, Na, Mg, Ti, Zr, Si, Nb, Ca, Sr, Ba, Zn, V, Fe, Cr, Cu, Nd, La, Mn, Ga, Sb, Ce, Mo, Tc, Ru, Rh, Ag, Cd, Ge, W, Ca, B, F or a combination thereof.

6. The cathode of claim 1, wherein the at least one dopant is Mn, Mg, Ti, and combinations thereof.

7. The cathode of claim 1, wherein the at least one dopant occupies M lattice sites in the crystalline structure.

8. The cathode of claim 6, wherein the at least one dopant is present in a concentration of from about 1 mol % to about 6 mol %.

9. (canceled)

10. (canceled)

11. (canceled)

12. The cathode according to claim 1, wherein the battery is a cobalt-free battery and the electrochemically active material comprises LiNiO₂.

13. (canceled)

14. (canceled)

15. (canceled)

16. (canceled)

17. (canceled)

18. The cathode of claim 3, wherein the at least one dopant is Mg, Mn, Ti, or a combination thereof having a combined concentration of about 4 mol % or less.

19. A process for preparing the cathode of claim 1, the process comprising:
a. preparing a slurry containing a solvent, the electrochemically active material, a conductive additive, and a binder;
b. casting the slurry on a substrate; and
c. drying the cathode.

20. The process of claim 19, wherein the solvent comprises N-methyl-2-pyrrolidone or water.

21. The process of claim 19, wherein the conductive additive comprises acetylene carbon, carbon black, graphite, graphene, or a combination thereof.

22. The process of claim 19, wherein the binder comprises polyvinylidene fluoride (PVDF), polyvinylidene fluoride-co-hexafluoropropylene (PVDF-HFP), polytetrafluoroethylene, carboxymethyl cellulose, alginate, or a combination thereof.

23. (canceled)

24. (canceled)

25. (canceled)

26. (canceled)

27. (canceled)

28. (canceled)

29. (canceled)

30. An electrochemical cell comprising the cathode of claim 1, an anode, and an electrolyte.

31. The electrochemical cell of claim 30, wherein the anode comprises graphite, activated carbon, carbon nanotubes, graphene, lithium foil, or a combination thereof.

32. (canceled)

33. The electrochemical cell of claim 30, wherein mass loading of the cathode is from about 3 to about 75 mg/cm².

34. (canceled)

35. The electrochemical cell of claim 30, wherein the electrochemical cell has an initial capacity of from 150 to 200 mAh/g when discharged to the end-of-discharge voltage at a C-rate of C1.

36. The electrochemical cell of claim 35, wherein the electrochemical cell retains at least 85% capacity after 300 charge/discharge cycles at a C-rate of C1.

37. (canceled)

38. The electrochemical cell of claim 37, wherein the electrochemical cell retains at least 90% capacity after 150 charge/discharge cycles at a C-rate of C/2.

39. (canceled)

40. The electrochemical cell of claim 39, wherein the electrochemical cell retains at least 86% capacity after 150 charge/discharge cycles at a C-rate of C/5.

41. The electrochemical cell of claim 30, wherein the electrochemical cell has an initial capacity of from 180 to 230 mAh/g when discharged to the end-of-discharge voltage at a C-rate of C/10.

42. (canceled)

43. (canceled)
